(19) United States
(12) Patent Application Publication
(10) Pub. No.: US 2023/0348649 A1
(43) Pub. Date: Nov. 2, 2023

(54) ROOM TEMPERATURE THREE DIMENSIONAL PRINTING OF A SUPER-SOFT AND SOLVENT FREE ELASTOMER

(71) Applicant: The Regents of the University of California, Oakland, CA (US)

(72) Inventors: Renxuan Xie, Goleta, CA (US); Sanjoy Mukherjee, Goleta, CA (US); Adam E. Levi, Goleta, CA (US); Veronica Reynolds, Goleta, CA (US); Michael L. Chabinyc, Santa Barbara, CA (US); Christopher Bates, Santa Barbara, CA (US)

(73) Assignee: The Regents of the University of California, Oakland, CA (US)

(21) Appl. No.: 17/918,707

(22) PCT Filed: Mar. 10, 2021
(86) PCT No.: PCT/US21/21765

§ 371 Date: Oct. 13, 2022

Related U.S. Application Data
(60) Provisional application No. 63/011,454, filed on Apr. 17, 2020.

(51) Int. Cl. C08F 290/06; B33Y 70/00

(52) U.S. Cl. CPC C08F 290/068; B33Y 70/00

(57) ABSTRACT

A composition of matter including a yield stress fluid including self-assembled copolymers each including at least one first type of polymer covalently bonded to at least one second type of polymer, wherein the first type of polymer (“first block”) is microphase separated from the second type of polymer (“second block”), at least one of the first block or the second block has its glass transition temperature less than or equal to 20° C., and the yield stress fluid has a critical yield stress at room temperature or below room temperature, without addition of a solvent for the first block or the second block. Examples of the self-assembled copolymers include a diblock copolymer or bottlebrush copolymer including the first block covalently bonded to the second block.

### CROSS REFERENCE TO RELATED APPLICATIONS

This application claims the benefit under 35 U.S.C. Section 119(e) of co-pending and commonly-assigned U.S. Provisional patent application Ser. No. 63/011,454, filed on Apr. 17, 2020, by Renxuan Xie, Sanjoy Mukheijee, Adam E. Levi, Veronica G. Reynolds, Michael L. Chabinyc, and Christopher M. Bates, entitled “ROOM TEMPERATURE THREE DIMENSIONAL PRINTING OF A SUPER-SOFT AND SOLVENT FREE ELASTOMER”, (30794.764-US-P1); which application is incorporated by reference herein.

The present disclosure is related to the following co-pending provisional patent applications:

U.S. Utility patent application Ser. No. 15,931,254, entitled CAPACITIVE PRESSURE SENSOR WITH BOTTLEBRUSH ELASTOMER DIELECTRIC LAYER FOR LOW PRESSURE SENSING, by Michael Chabinyc et al., attorney's docket no. 30794.698-US-P1 (UC Ref 2019-167), which application claims the benefit under 35 U.S.C. Section 119(e) of co-pending and commonly-assigned U.S. Provisional patent application Ser. Nos. 62/846,883 entitled CAPACITIVE PRESSURE SENSOR WITH BOTTLEBRUSH ELASTOMER DIELECTRIC LAYER FOR LOW PRESSURE SENSING, by Michael Chabinyc et al., attorney's docket no. 30794.698-US-P1 (UC Ref 2019-167), and 62/913,782 filed Oct. 11, 2019, entitled “UNIVERSAL APPROACH TO PHOTO-CROSSLINK BOTTLEBRUSH POLYMERS,” by Michael Chabinyc et al., attorney's docket no. 30794.746-US-P1 (UC Ref. 2020-063);

Both of which applications are incorporated by reference herein.

### BACKGROUND OF THE INVENTION

### 1. Field of the Invention

The present invention relates to compositions of matter useful for three dimensional (3D) printing and methods of making the same.

### 2. Description of the Related Art

(Note: This application references a number of references as indicated throughout the specification by one or more reference numbers as superscripts, e.g., ^{x}. A list of these different references ordered according to these reference numbers can be found below in the section entitled “References.” Each of these references is incorporated by reference herein.)

“Super-soft elastomers” are a class of materials that are derived from highly-branched building blocks known as bottlebrush polymers^{1,2} and have shear moduli ca. 10-100 kPa that are significantly smaller than traditional elastomers (1 MPa).³⁻⁵ The super-soft mechanical properties of bottlebrush polymers have proven transformative as synthetic analogues of living tissue⁵ and to enhance the sensitivity of electronic devices⁶.

However, the use of bottlebrush elastomers as a bio-mimetic material platform⁵ in patient-specific medical devices, implants, or advanced actuator/sensor geometries⁷ is currently stymied by their poor processability. Recently, 3D printing has emerged as a promising tool to revolutionize important areas of science and engineering, from medicine^{8,9} to electronics,^{10,11} and even high-volume manufacturing¹²⁻¹⁴. But current approaches of forming the bottlebrush network from a mixture of macro-monomers, macro-crosslinkers and solvent is a slow chemical reaction process, thus hindering the 3D printability through either fused deposition modeling or stereolithography. Another variant of 3D printing, perhaps the simplest, is known as “direct ink writing” (DIW),¹⁵⁻¹⁷ which involves the extrusion of material from a nozzle that can be dynamically positioned along three coordinate axes¹⁶. Because the printed structure must hold its shape, the basis of DIW relies on low viscosity inks that quickly solidify after deposition. But traditional methods of imparting the requisite ink rheology not only involve complex engineering or formulation challenges but also ruin the final properties of the printed parts. Selected examples include the use of custom instrumentation to control nozzle temperature, adding solvent which can warp printed parts upon evaporation or leach over time¹⁸⁻²³, precisely tuning polymerization kinetics²⁴, and designing thixotropic mixtures that shear thin by adding particles.²⁵⁻³⁰ A high concentration of such particles in a polymer melt can transmit load by jamming, pushing against nearest neighbors.^{25,26} Once yielded, the particles are able to rearrange and slide past themselves to flow, thus allowing DIW under ambient condition. But addition of these particles, such as nanoclay and metallic particles,^{29,30} could compromise the biocompatibility and super-soft modulus of the printed elastomer. Such difficulty in optimizing inks translates into a limited range of printed material properties that are accessible using conventional DIW, thus posing the grand challenge to incorporate bottlebrush polymers in 3D printing process.

### SUMMARY OF THE INVENTION

The present disclosure describes a composition of matter including a yield stress fluid including self-assembled copolymers each including at least one first type of polymer covalently bonded to at least one second type of polymer, wherein the first type of polymer is microphase separated from the second type of polymer, at least one of the first type of polymer or the second type of polymer has its glass transition temperature less than or equal to 20° C., and the yield stress fluid has a critical yield stress at the temperature T, wherein 15° C.≤T≤30° C., without addition of a solvent for the first type of polymer or the second type of polymer. Examples of the self-assembled copolymers include a linear block copolymer or bottlebrush polymer including the first type of polymer covalently bonded to the second type of polymer in either statistical, random or block sequence.

The present disclosure reports on a novel method to three dimensionally print at room temperature. In one or more examples, the 3D printable material comprises a solvent-free ink at room temperature. The unique self-assembly of copolymers (e.g., a bottlebrush statistical copolymer) allows room-temperature extrusion by applying the stress above a critical value, below which the material can hold its printed shape for a long time (similar to a paste-like material). In one or more embodiments, ultraviolet (UV) curing transforms the printed structure to an uncommon super-soft elastomer that displays a sharp and reversible strain-softening behavior right above the critical stress.

In one example, the new ink design based on copolymer self-assembly that can be used for 3D printing at room temperature without the use of solvent or other shear-thinning additives comprises statistical bottlebrush polymers comprising poly(dimethylsiloxane) (PDMS) and poly(ethylene oxide) (PEO) side-chains. The side-chains self-assemble into body-centered cubic spheres that undergo sharp and reversible yielding corresponding with the lattice disordering of PEO micelles. The yield stress and structural modulus of these soft solids can be tuned across a wide range by manipulating the length scale of microphase separation. The addition of a soluble photo-crosslinker containing benzophenone end-groups enables complete UV curing after extrusion to form super-soft elastomers (shear moduli≈1-100 kPa) with unprecedented mechanical properties, namely perfect recoverable elasticity well beyond the yield strain. This novel application of statistical copolymer self-assembly and super-soft elastomers highlights the advantages of developing new materials for 3D printing and injectable biomaterials.

Illustrative, non-exclusive examples of inventive subject matter according to the present disclosure are described in the following examples.
1. A composition of matter, comprising:
   a yield stress fluid including self-assembled copolymers each including at least one first type of polymer covalently bonded to at least one second type of polymer, wherein:
   the first type of polymer is microphase separated from the second type of polymer,
   at least one of the first type of polymer or the second type of polymer has a glass transition temperature less than or equal to 20° C., and
   the yield stress fluid has a yield stress behavior at room temperature or below room temperature without addition of a solvent for the first type of polymer or the second type of polymer.
2. The composition of matter of example 1, wherein the self-assembled copolymers comprise:
   one or more bottlebrush polymers each including a plurality of the first type of polymers covalently bonded via a backbone to the plurality of the second type of polymers, or
   two or more linear blocks comprising at least one of the first type of polymers connected to at least one of the second type of polymers.
3. A composition of matter, comprising:
   a yield stress fluid including self-assembled bottlebrush copolymers each including a plurality of first side-chains and a plurality of second side-chains, wherein the first side chains are microphase separated from the second side chains and the yield stress fluid has a yield stress behavior at room temperature or below room temperature without addition of a solvent for the first type of polymer or the second type of polymer.
4. A composition of matter, comprising:
   one or more statistical bottlebrush copolymers each including a plurality of first side-chains and a plurality of second side-chains, wherein at least one of the first side-chains or the second side-chains has their glass transition temperature less than or equal to 20° C.
5. The composition of matter of example 4, wherein the bottlebrush copolymers comprise self-assembled copolymers and the first side chains and the second side chains are microphase separated.
6. The composition of matter of any of the examples 1-3 or 5, comprising a plurality of nanostructures each including one or more of the self-assembled copolymers.
7. The composition of matter of any of the examples 1-3 or 5-6, comprising the yield stress fluid having a yield stress behavior wherein the self-assembled copolymers are arranged in a more liquid-like configuration with less order when the yield stress fluid experiences a stress at or above the critical yield stress at room temperature or at a temperature below room temperature, as compared to an arrangement of the self-assembled copolymers below the critical yield stress.
8. The composition of matter of any of the examples 1-3 or 6-7, comprising a yield stress fluid having a yield stress behavior, wherein the nanostructures are arranged on a lattice when the yield stress fluid experiences a stress below the critical yield stress.
9. The composition of matter of example 7, wherein the nanostructures are arranged on the lattice having a unit cell selected from a body-centered cubic spheres, face-centered cubic spheres, or any unit cell associated with a Frank-Kasper phase (e.g., a sigma phase, an A15 phase, a C14 phase, a C15 phase, or a Z phase).
10. The composition of matter of example 7, wherein the nanostructures are arranged on the lattice having a unit cell comprising a hexagonal structure or a close packed structure.
11. The composition of matter of any of the examples 6-10, wherein the nanostructures each comprise a core, the core including an aggregation of the second blocks or the second side chains.
12. The composition of matter of any of the examples 1-11, wherein an interface between the first type of polymers and the second type of polymers, or the interface between the first side-chains and the second side-chains, defines a boundary having a convex side and a concave side.
13. The composition of matter of example 12, wherein the self-assembled copolymers comprise the bottlebrush copolymers each having a backbone and the interface comprises the backbone.
14. The composition of matter of examples 12 or 13, wherein:
   the first type of polymers extend outwards from the convex side and the second type of polymers extend inwards from the concave side as to form a cluster, or
   the first side-chains extend outwards from the convex side and the second side-chains extend inwards from the concave side.
15. The composition of matter of example 14, wherein the first type of polymers (or first side-chains) are longer and/or comprise a larger fraction of the self-assembled copolymers as compared to the second type of polymers (or second side-chains).
16. The composition of matter of examples 14 or 15, wherein the first type of polymers (or first side-chains) have a glass transition temperature below 20° C.
17. The composition of matter of any of the examples 1-16, wherein the first type of polymers (or first side-chains) and the second type of polymers (or second side-chains) have different compositions and/or dielectric constants such that the first type of polymers (or first side-chains) and the second type of polymers (or second side-chains) are microphase separated.
18. The composition of matter of example 17, wherein the different compositions are such that the composition of matter has a Young's modulus in a range of 1-100 kPa.
19. The composition of matter of any of the preceding examples 1-18, wherein the first type of polymers (or first side-chains) each comprise poly(dimethylsiloxane) and the second type of polymers (or second side-chains) each comprise poly(ethylene oxide), also known as poly(ethylene glycol).
20. The composition of matter of any of the examples 1-19, wherein the self-assembled copolymers comprise a backbone having at least one structure selected from:

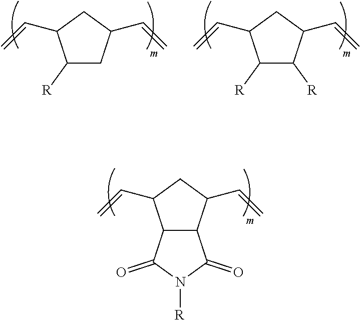

wherein m is an integer and R comprises at least one of the first type of polymers (first side-chain) or the second type of polymers (second side-chain).
21. The composition of matter of any of the examples 1-20, wherein the first type of polymers (or first side-chains) and the second type of polymers (or second side-chains) each independently comprise at least one polymer selected from a polyester, poly(ether), a poly(siloxane), a polyacrylate, a polymethacrylate, polyamide, polyacrylamide, polyurea, polycarbonate, polyalkane, polyethylene, polypropylene, polyisobutylene, polyalkene, polybutadiene, polyisoprene, a polystyrene, or derivatives thereof, or wherein the first type of polymers (first side-chains) and the second type of polymers (second side-chains) comprise the same type of polymer but with different functionality.
22. The composition of matter of any of the examples 1-21, wherein each of the first type of polymers (first side-chains) have a degree of polymerization of at least 5 and each of the second type of polymers (second side-chains) have a degree of polymerization of at least 5.
23. The composition of matter of any of the examples 3-20 wherein the bottlebrush copolymers each have the structure:

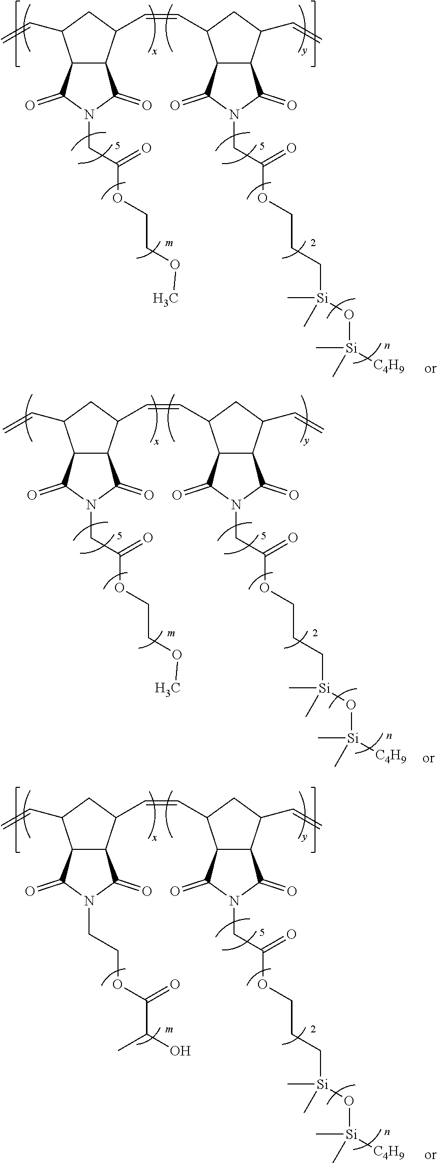

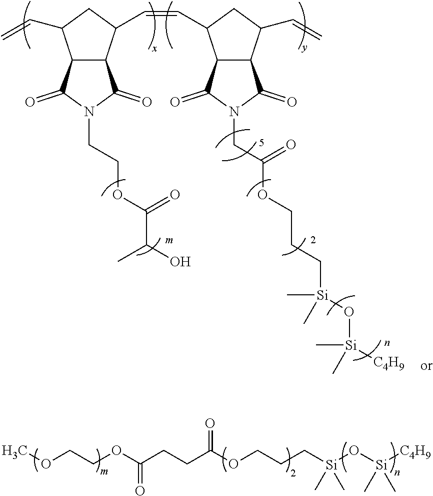

wherein x, y, m and n are in a range of 5-1000 (5≤m, n≤1000), or x+y is in a range of 5-1000 (5≤x+y≤1000).
24. The composition of matter of any of the examples 3-21, wherein the first sidechains have a length shorter than the second sidechains.
25. The composition of matter of any of the examples 1-22, further comprising a minor phase comprising the first type of polymers, the second type of polymers, the first side chains, or the second side chains; wherein a volume percent content of the minor phase in the composition of matter is in a range of 0.1% to 33%.
26. The composition of matter of any of the examples 2-25 wherein the one or more bottlebrush copolymers each comprise a statistical sequence of the side-chains.
27. The composition of matter of any of the examples 1-26, further comprising photocrosslinker molecules.
28. The composition of matter of any of the examples 6-27, wherein the self-assembled nanostructures each have a unit cell having a dimension less than 18 nm.
29. The composition of matter of any of the examples 6-14, wherein the self-assembled nanostructures each have a largest diameter less than 18 nm.
30. The composition of matter of example 28 or 29, wherein a spacing between the nanostructures is less than 18 nm and depends most strongly on the length of the first side-chain.
31. The composition of matter of any of the examples 1-30, wherein the composition of matter is three dimensionally printable at room temperature, the composition of matter transforming from a more solid state into a more fluidic state in response to a pressure applied during three-dimensional printing and the composition of matter transforming from the more fluidic state to the more solid state after the pressure is released.
32. The composition of matter of any of the examples 2-31, wherein the self-assembled copolymers comprise a general structure of:

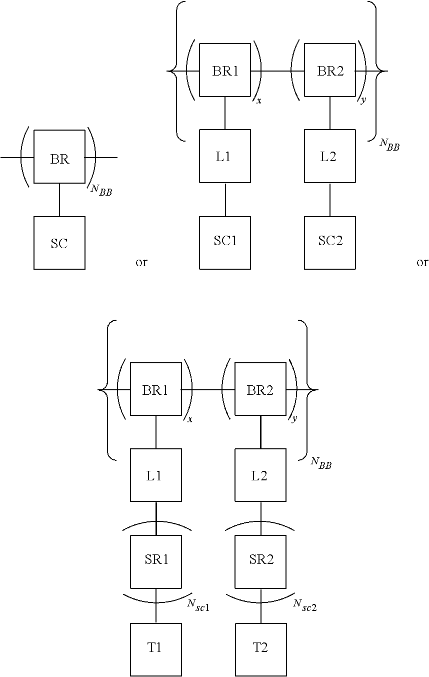

the backbone comprises at least one of BR, BR1, or BR2
the first side-chains, the second side-chains, the first type of polymer, and the second type of polymer each comprise:
(1) SC,
(2) L1 and SC1,
(3) L2 and SC2,
(4) L1 and SR1 and T1, or
(5) L2 and SR2 and T2.
33. A three dimensionally printed part comprising or consisting essentially of the composition of matter of any of the examples 1-32.
34. A three dimensionally printed part comprising or consisting essentially of a bottlebrush copolymer.
35. An ink or material useful for additive manufacturing or 3D printing comprising the composition of matter of any of the examples 1-33.
36. The composition of matter of any of the examples 1-34, wherein the composition of matter does not include a solvent for the first type of polymers, the first side-chains, the second type of polymers, or the second side-chains.
37. A method of three dimensionally printing or additive manufacturing, comprising:
three dimensionally printing a material at room temperature, wherein the material comprises or consists essentially of a self-assembled copolymer or the composition of matter of any of the examples 1-36 and the printing is without addition of a solvent for the self-assembled copolymer.
38. The method of example 37, further comprising crosslinking the self-assembled copolymers after the printing.
39. The method of any of the examples 37-38, wherein the printing comprises applying a pressure to the material so that the material becomes a fluid during the printing and solidifies after the printing and after removal of the pressure.
40. The method of example 41, wherein applying the pressure comprises extruding the material through a nozzle.
41. The method of any of the examples 37-40, wherein the self-assembled copolymers form a yield stress fluid at or near room temperature and the pressure is equal to or above a yield stress for the yield stress copolymer.
42. A method of three dimensionally printing or additive manufacturing, comprising:
three dimensionally printing a material comprising or consisting essentially of a bottlebrush polymer.
43. The method or composition of matter of any of the examples 43-44, wherein the nanostructures or self-assembled copolymers each have a spherical or spheroidal shape.

### BRIEF DESCRIPTION OF THE DRAWINGS

Referring now to the drawings in which like reference numbers represent corresponding parts throughout:

FIG. 1. Ink material design for the direct ink writing at 20° C. a, Chemical structure and self-assembly of PDMS-stat-PEO statistical bottlebrush polymers into BCC spheres at minority PEO volume fractions (f_{PEO}≈0.04-0.06). b, These soft materials undergo sharp yielding at room temperature in response to shear, which corresponds with the lattice disordering of PEO micelles, enabling facile extrusion-based 3D printing without solvent or other thixotropy-inducing additives.

FIG. 2 Morphology and yield-stress behavior of PDMS-stat-PEO bottlebrush polymers at 20° C. a, SAXS patterns of samples with N_{SC}=68 and 136 indicate well-ordered BCC unit cells with domain spacing controlled by N_{SC}. b, Dynamic frequency sweeps in the linear viscoelastic regime indicate robust, soft solids (G⁰≈G′>>G″) across 5 decades in frequency. G⁰ can be modulated according to the scaling relationship with d. c, Dynamic stress sweeps (1.0 rad/s) reveal a sharp yielding transition at a critical stress (τ_{y}) defined as the crossover point of G′ and G″. The value of τ_{y} is tunable with N_{SC} and is correlated with d and G⁰. d, Cyclic dynamic time sweeps between two stresses, 1.4 kPa (τ<τ_{y}) and 8.2 kPa (τ>τ_{y}), demonstrate excellent mechanical stability and fast reordering after yielding; data collected at 1.0 rad/s for sample with N_{SC}=68.

FIG. 3 Photo-crosslinking of 3D-printable PDMS-stat-PEO bottlebrush copolymers formulated with bis-benzophenone-functionalized PDMS results in super-soft elastomers at room temperature. a, Chemical structure of the photo-crosslinker, PDMSbisBP. b, UV curing kinetics of PDMS-stat-PEO bottlebrush copolymers self-assembled into BCC spheres. c, Illustration of the crosslinked PDMS matrix (blue) separating un-crosslinked PEO micelles (red).

FIG. 4 Mechanical properties of super-soft bottlebrush elastomers resulting from the photo-crosslinking of self-assembled PDMS-stat-PEO. a, Uniaxial cyclic tensile experiments (i.e., engineering stress σ_{E} vs. extension ratio λ) demonstrate a small shear modulus (Gₓ=7.7 kPa) above yield stress (σ_{y}=10 kPa), near-perfect recovery after yielding, and an ultimate elongation-at-break in excess of 4. Main figure: data were collected with 10 min in between cycles. Inset: no rest period between cycles. b, SAXS patterns demonstrating the reversible lattice disordering of BCC micelles in the crosslinked elastomeric state upon deformation to stresses σ>σ_{y} as depicted below. c, Photographs of a 3D-printed and UV-cured “bowl” at rest and under tension. Scale bars represent 1.0 mm.

FIG. 5(a). Schematic of diblock copolymers.

FIG. 5(b). Schematic of self-assembled copolymers arranged on a lattice.

FIG. 6(a). Overview of the architectures, chemistry, and morphologies studied in section 4. (Including self-assembled morphologies from linear and bottlebrush architectures with either statistical or diblock sequences of poly(dimethylsiloxane) (PDMS), poly(ethylene glycol) (PEG), poly(lactic acid) (PLA), poly(dodecyl acrylate) (PDDA), and poly(trifluoroethyl acrylate) (PTFEA))

FIG. 6(b). Second heating scans of the ordered statistical or diblock copolymers with either bottlebrush or linear architectures and different chemistries. Molecular details for these polymers are summarized in Table 2. Heating rate at 20° C./min.

FIG. 7. Small-angle X-ray scattering (SAXS) patterns of (a) BCC and (b) HEX-forming polymers at room temperature. Triangles mark the expected Bragg reflections for a cubic lattice (q/q*=1:\sqrt{2}: \sqrt{3}: \sqrt{4}: \sqrt{5}: \sqrt{6}: \sqrt{7}) and hexagonal net (q/q*=1:\sqrt{3}:\sqrt{3}: \sqrt{7}).

FIG. 8. Dynamic frequency sweeps in the linear viscoelastic regime for (a) BCC and (b) HEX-forming polymers. Solid lines are fast-Fourier transforms of stress relaxation data. Data were collected with an oscillatory strain amplitude of 0.01 at 25° C. for (OSₘ)ₛₜₐₜ, (OSₗ)ₛₜₐₜ, (OSₛ)ₛₜₐₜ, and at −30° C. for OSₘ and (LSₘ)ₛₜₐₜ. The master curve for (OSₘ)_{b}lock in (b) was generated using a reference temperature of 25° C. by applying a horizontal shift factor a_{T}. (c, d) Temperature ramp for BCC- and HEX-forming polymers at 1.0 rad/s and a heating rate of 5° C./min. The order-to-disorder transition temperature (T_{ODT}) is defined as the G and G″ crossover point except for (OSₘ)_{block}, where no clear T_{ODT} is detected. The determined T_{ODTS} are summarized in Table 2. (e). Master curves for bottlebrush diblock copolymers of PEO and PDMS with different N_{BB} and PEO volume fraction, f_{PEO}=0.046, 0.053, and 0.039, at the same reference temperature of 25° C. Data vertically shifted by a factor of 1, 0.1 and 0.01 for (OSₘ)_{block}, (OSₘ)_{block,1} and (OSₘ)_{block,2}, respectively. Molecular details for these bottlebrush diblock copolymers are summarized in Table 2 and Table 3.

FIG. 9. (a) Time-lapse images captured while extending (OSₘ)ₛₜₐₜ between two parallel plates. (b) Dynamic stress sweep at an oscillatory frequency of 1.0 rad/s. The yield stress (τ_{y}) is defined as the crossover of G′ and G″ at 6.6 kPa. (c) Transient start-up shear from 0 to 1.0 s⁻¹ determines the static yield stress (τ_{y,s}), represented by the peak of the stress overshoot at 6.2 kPa. (d) Steady-rate sweep from 1.0 to 0.003 s⁻¹ provides a measurement of the dynamic yield stress (τ_{y,d}) by fitting the data with the Herschel-Bulkley model³⁵ (red line): τ=τ_{y,d}+K\dot{γ}ⁿ; τ_{y,d}=3.1 kPa, K=4.4 Pa s^{0.2}, and n=0.2. All data were collected at 25° C.

FIG. 10. Impact of frequency and temperature on the yielding performance of BCC-forming (OSₗ)ₛₜₐₜ. (a) Dynamic stress sweeps at different frequencies and constant temperature (25° C., T_{ODT}−T=40° C.). (b) Dynamic stress sweeps at different quench depths (T_{ODT}−T=10, 20, 30, 40° C.) with a constant frequency (1.0 rad/s).

FIG. 11. Dynamic stress sweeps (oscillatory frequency=1.0 rad/s, strain amplitude increases from 0.01 to 1.0) for (a) HEX- and (b) BCC-forming polymers. Sharp yielding is observed at a yield stress (τ_{y}) defined as the crossover point of G′ and G″. (c) The yielding transition in BCC phases is much sharper than HEX as evaluated by the slope d log G′/d log τ. All samples were tested at temperatures well-below T_{ODT}: T=−30° C. for (LSₘ)ₛₜₐₜ and OSₘ, T=25° C. for (OSₘ)ₛₜₐₜ, (OSₗ)ₛₜₐₜ, and (OSₛ)ₛₜₐₜ, T=85° C. for (OSₘ)_{block}.

FIG. 12. Cyclic dynamic time sweeps for (a) BCC and (b) HEX-forming polymers between two oscillatory strain amplitudes (i.e., 0.01 and 1) across the yielding transition. Data were collected at 1.0 rad/s for all samples. The test temperatures as listed were far below T_{ODT}. Lissajous curves for (c) (OSₗ)ₛₜₐₜ, (d) (OSₘ)_{block}, (e) (OSₛ)ₛₜₐₜ from the strain amplitude of 1.0 to 100% at 1.0 rad/s. Similar shape in (c) and (d) implies a similar underlying mechanism (displacing the ordered micelles), but the drastically different cyclic shape with strain amplitude of 100% in (e) possibly suggests a very different mechanism (i.e., perhaps shear aligning the ordered cylinders).

FIG. 13. The (a) HEX and (b) BCC morphologies exhibit notable differences in the critical strain irrespective of architecture and chemistry. Dynamic strain sweeps were collected with an oscillatory frequency=1.0 rad/s while increasing the strain amplitude from 0.01 to 1.0. The critical strain (γ_{c}) is defined by extrapolation (solid lines), and the yield strain (γ_{y}) is calculated based on the previously determined yield stress (FIG. 11) and structural modulus (FIG. 8). (c) Comparison of γ_{c} and γ_{y} across different architectures, chemistries, and morphologies. All samples were tested at temperatures below T_{ODT}: T=85° C. for (OSₘ)_{block}, T=25° C. for (OSₛ)ₛₜₐₜ, (OSₘ)ₛₜₐₜ, and (OSₗ)ₛₜₐₜ, and T=−30° C. for (LSₘ)ₛₜₐₜ and OSₘ

FIG. 14. (a) Correlation between the normalized structural modulus (G⁰/RT) and inter-micelle distance (d) for HEX- and BCC-forming copolymers, including linear diblock and statistical/blocky bottlebrushes. Square and down triangle symbols represent bottlebrushes and linear blocks, respectively. Solid and open symbols represent HEX- and BCC-forming polymers, respectively. The dashed line highlights the known scaling for BCC forming linear diblock copolymers with a slope of −3. The solid line is the best-fit line through only our data in this work. The linear block copolymer data by Buitenhuis et al. ⁴, Register et al. ¹, Kossuth et al. ³⁶, and Watanabe et al. ⁴⁰ are also plotted for comparison. The shaded area represents the 95% confidence band generated by including all the data in the fit. (b) Reduced structural modulus (G⁰ d³/k_{B}T) versus reduced temperature (T/T_{ODT}) for both HEX- and BCC-forming copolymers in this work. The data of Register et. al.⁴ and Kossuth et. al.⁵ are plotted for comparison. The solid line is the best-fit exponential expression (G⁰ d³/k_{B}T=c₁ exp[−c₂ (T/T_{ODT}−1)], c₁ and C₂ are fitting parameters) through only the data collected by Register and coworkers⁴. (c) Reduced structural modulus (G⁰/(k_{B}T pₘ N_{c}^{3/2})) versus inter-micelle distance (d) for the BCC-forming copolymers in this work. The data and the best-fit line by Buitenhuis et. al.⁶ are plotted for comparison to highlight the importance of number of corona chains per micelles on the inter-micelle interaction potential. Our data are not included in the fit.

FIG. 15. Correlation between the structural modulus (G⁰) and yield stress (τ_{y}) for HEX- and BCC-forming copolymers, including linear blocks and statistical/blocky bottlebrushes. Square and down triangle symbols represent bottlebrushes and linear blocks, respectively. Solid and open symbols represent HEX- and BCC-forming polymers, respectively. The two solid lines are the best-fit lines through BCC and HEX samples in this work, respectively, with a constant slope of 1.0 and different yield strains (γ_{y}). Data of Register et al.¹ are also plotted for comparison, despite the difference in determining τ_{y}.

FIG. 16. (a) Dynamic frequency sweeps in the linear viscoelastic regime and (b) dynamic stress sweeps at 25° C. for the PEO-stat-PDMS bottlebrush with broad dispersity (Ð=2.47).

FIG. 17. Printed line patterns with different print speeds and layer heights at 25° C. using PEO-stat-PDMS bottlebrush with broad dispersity (Ð=2.47), showing increased print Speed for the PEO-stat-PDMS Bottlebrush.

FIG. 18. A series of PDMS-PEO copolymers with relatively high PDI synthesized from 5 kDa PDMS macromonomer (a) and 10 kDa PDMS macromonomer (b). The image shows that the materials hold their shape when the container is kept inverted. A representative SEC (c) shows the high PDI (Mₙ=725 kDa, Ð=2.5) of a sample prepared from 10 kDa PDMS macromonomer and a short 750 Da PEO macromonomer.

FIG. 19. (a) 3D printed ear using a broad dispersity PEO-stat-PDMS polymer (“bad” sample, Ð=2.5) at a speed of 500 mm/min and a layer thickness of 0.322 mm. The 3D design is shown for comparison. (b) Oscillatory stress sweeps and T_{ODT} scans for a series of PEO-stat-PDMS polymers with well-controlled high dispersity (FIG. 4). These results are compared with narrowly dispersed PEO-stat-PDMS bottlebrush polymers (Ð=1.1) using either 5 kDa or 10 kDa PDMS side-chain.

FIG. 20. SEC-MALS traces for PEO-stat-PDMS bottlebrushes, linear PEO-block-PDMS, PEO-block-PDMS bottlebrush, and PLA-stat-PDMS bottlebrush in THE

FIG. 21 is a flowchart illustrating a method of making a composition of matter.

FIG. 22 is a flowchart illustrating a method of printing or additive manufacturing.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

### 1. First Example: Bottlebrush Polymer

We address the challenges described above by demonstrating a general strategy to 3D print super-soft elastomers by DIW under ambient conditions in the absence of solvent or thixotropy-inducing additives. Our approach leverages the bottlebrush architecture in conjunction with unique self-assembly to mediate a fast and reversible solid-liquid phase transition at room temperature in response to shear. We elucidate a set of structure-property relationships that reveal the important molecular design parameters impacting facile printability. Formulation with a soluble photo-crosslinker enables complete UV curing after DIW to form a robust, super-soft elastomer. The mechanical performance of these 3D-printed bottlebrush elastomers exhibits two distinctive regions of response with unprecedented cyclability (i.e., complete recovery) even after being stretched well beyond the yield strain. These conclusions highlight the advantages of exploiting tailored molecular design and self-assembly in contemporary applications to produce properties that are otherwise unachievable with traditional materials.

a. Molecular Design and Synthesis

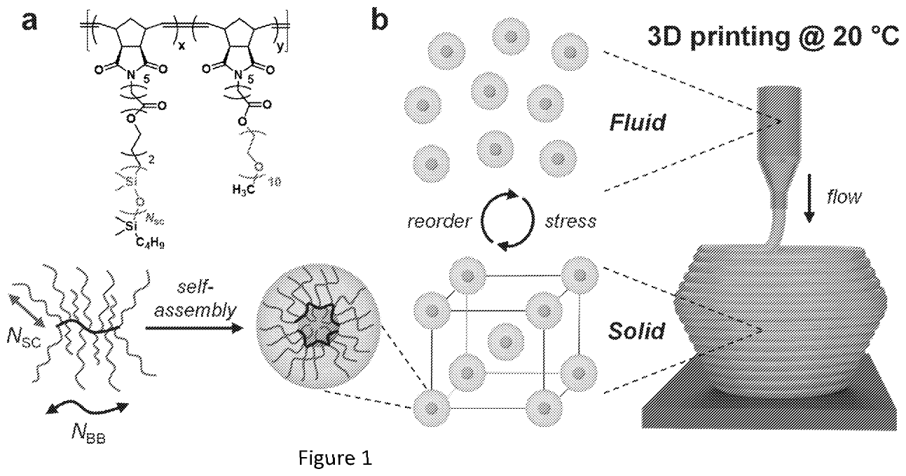

With a goal of 3D printed super-soft solvent-free elastomer at room temperature, the molecular design of our DIW ink material is motivated by four criteria (FIG. 1). (1) Super-soft mechanical properties derived from the bottlebrush polymer architecture. The super-soft network moduli is determined only by the huge volume of each entanglement-free bottlebrush network strand³¹ with no thixotropy-inducing additives. (2) Sharp yield-stress behavior. We hypothesized that block copolymer (BCP) self-assembly could be used to generate thixotropic materials by traversing the order-disorder (solid-liquid) transition 3 in response to shear³⁴⁻³⁶. This type of shear disordering has been reported for the body-centered cubic phase of polystyrene-polyisoprene (PS-PI) di- and triblock copolymer melts, albeit at high temperatures T>100° C. with slow reversibility which is inconvenient for DIW. In addition, we are not aware of any copolymer solvent-free self-assembly which has been used for DIW at room temperature. Note that we specifically seek to avoid using solvent (e.g., water^{22,23,37} or oil¹⁹) that would complicate the printing process and create long-term stability issues. (3) Fast and reversible yielding at room temperature. Under the assumption that shear disordering and fast reversibility (<100 s) can only occur in BCP melts well above the glass transition (T_{g}) and melting (Tₘ) temperatures of all components, we selected poly(dimethylsiloxane) (PDMS. T_{g}=−125° C., Tₘ=−50° C.) and short poly(ethylene oxide) (PEO; T_{g}=−60° C., no Tₘ) as the A and B components. Both of these materials are bio-compatible. In addition, the large Flory-Huggins interaction parameter between PDMS and PEO (χ≈0.224 at 20° C. and reference volume of 118 Å³)³⁸ should produce a strongly microphase-separated morphology at low degrees of polymerization (N) to improve ordering kinetics. Furthermore, it is conceivable to synthesize a bottlebrush block copolymer, but previous reports suggest no apparent ordering when targeting the sphere-forming morphology.^{39,40} So, this initial report focuses on copolymerizing PEO and PDMS as statistical bottlebrush polymers, a sequence that is easy to synthesize. (4) Crosslinkable formulations to create elastomers after printing. We leverage benzophenone-based di-telechelic polymers as efficient photo-crosslinkers.^{6,41} Incorporating small quantities of PDMS bis-benzophenone-based photo-crosslinkers in the bottlebrush formulation leaves the shear-thinning behavior essentially unchanged but enables fast curing under UV light (about 10 mins to fully cure a 0.4-mm thick sample using 150 mW/cm²) to produce super-soft elastomers.

A synthetic procedure was developed to create bottlebrush polymers from a variety of different constituent chemistries using grafting-through ring-opening metathesis polymerization (ROMP). This approach guarantees 100% grafting density and is general to virtually any class of bottlebrush polymers by functionalizing linear chains with a norbornene terminus and subsequently performing ROMP.

Using commercially available functionalized PDMS of different molecular weights, we synthesized a series of PDMS-stat-PEO bottlebrush polymers via the grafting-through copolymerization of norbornene-terminated PEO and PDMS macromonomers using ring-opening metathesis polymerization (ROMP) on multi-gram scale (e.g., 3 grams) with good control over molar mass dispersity (Ð<1.2). For all materials reported herein, the PEO side-chain degree of polymerization (N_{SC,PEO}=10) was held constant while the PDMS length was selected from N_{SC}=68 (5 kDa) and 136 (10 kDa). As depicted in FIG. 1, the number of PEO (x) and PDMS (y) macromonomer repeat units was varied to produce a total backbone degree of polymerization N_{BB}=x+y with minority volume fraction of PEO f_{PEO}<<0.1. In order to prepare the statistical copolymers using ROMP (ring-opening metathesis polymerization), the two different macromonomers (PEG and PDMS) were dissolved together in dichloromethane followed by addition of G3 catalyst (Grubbs' 3^{rd} generation catalyst). When complete, the reactions were terminated using EVA (ethyl vinyl ether) and the final polymer was precipitated in methanol. To form the block copolymers, one macromonomer was polymerized using G3 catalyst to complete conversion followed by addition of the second macromonomer. The reactions were terminated using EVA and the block copolymers were precipitated in methanol. The resulting reaction mixtures were concentrated using vacuum evaporation and the polymers were precipitated in methanol. After two more consecutive precipitation of the polymers in methanol, the bottlebrush polymers were collected and dried under vacuum (FIG. 1, appendix C). Statistical copolymers of PEO and PDMS bottlebrushes in this work are represented by “x_{PDMS}S_{N}_{_{SC,PDMS}}^{N}^{_{BB}}” (where x is the mole ratio of PDMS side chains, N_{SC} is the side chain degree of polymerization, N_{BB} is the backbone degree of polymerization), which can be followed by “−n_{cl}” indicating the number of PDMSbisBP crosslinkers added per bottlebrush polymer. Full characterization details can be found in reference 52.

TABLE 1
Molecular characterization for the synthesized bottlebrush statistical copolymers
and one linear diblock copolymer of PEO and PDMS in this work.

| | | | | | Mₙ | | dn/dc |
|---|---|---|---|---|---|---|---|
| Sample | x_{PDMS} | f_{PEO} | N_{SC, PDMS} | N_{BB} | (kDa) | Ð | (ml/g) |
| 0.74S₆₈¹⁵² * | 0.74 | 0.044 | 68 | 152 | 626 | 1.08 | 0.0159 |
| 0.71S₆₈¹⁸¹ | 0.71 | 0.052 | 68 | 181 | 717 | 1.18 | 0.0163 |
| 0.67S₆₈¹⁵⁷ | 0.67 | 0.062 | 68 | 157 | 594 | 1.11 | 0.0174 |
| 0.61S₁₃₆¹¹¹ * | 0.61 | 0.042 | 136 | 111 | 723 | 1.07 | 0.0104 |
| 0.63S₁₃₆⁸⁹ \hat{ } | 0.63 | 0.038 | 136 | 89 | 606 | 1.04 | 0.0107 |
| linear diblock | 0.5 | 0.087 | 68 | — | 5.8 | — | — |

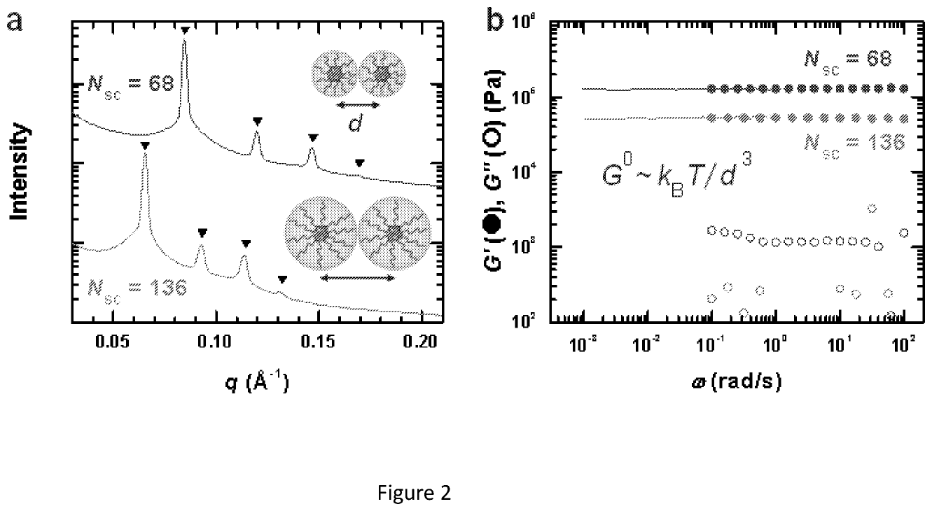

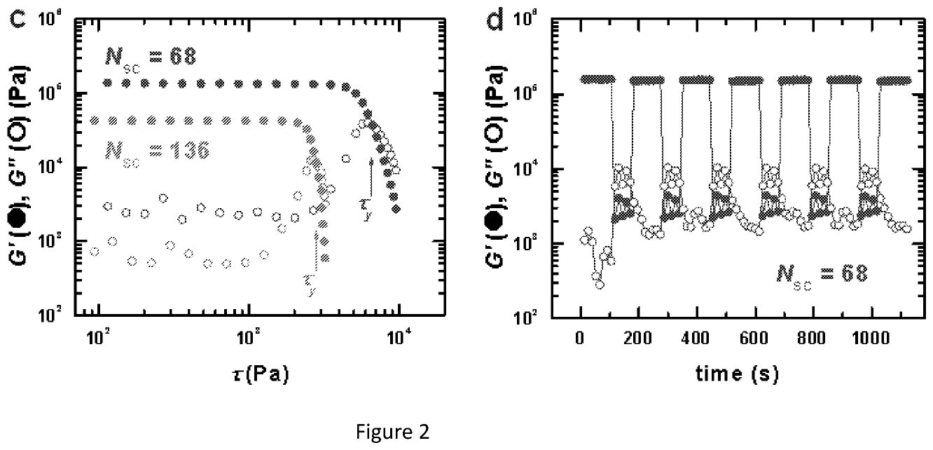

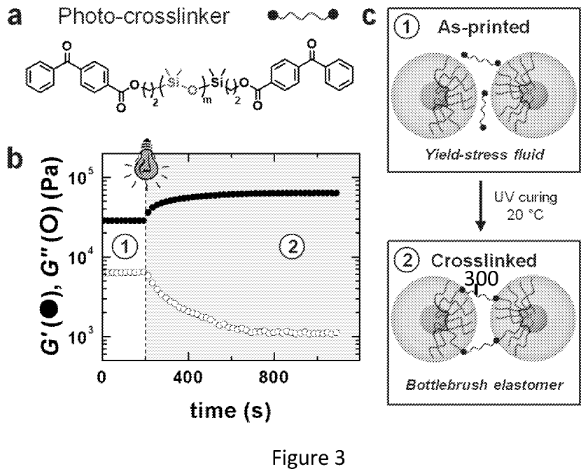

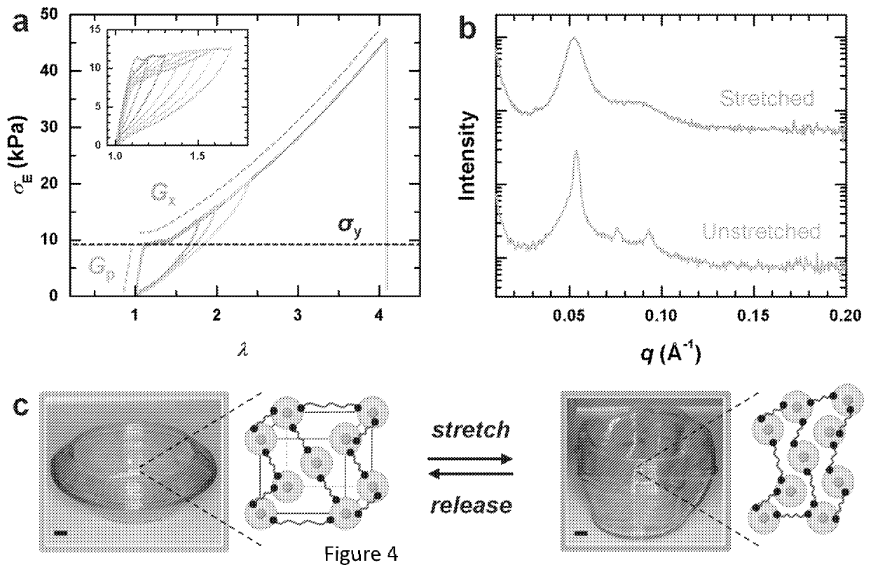

* Examples of bottlebrush copolymers in FIG. 2 and FIG. 3.
\hat{ }: The bottlebrush copolymer used in FIG. 4.

The linear model block copolymer was synthesized using a two-step process. First, with commercially available PEG derivative (PEG-methyl ether) and succinic anhydride, a carboxylic acid functionalized PEG derivative was synthesized. In the following step, the carboxylic acid functionalized PEG and a hydroxyl functionalized PDMS were coupled using 1-ethyl-3-(3-dimethylaminopropyl) carbodiimide (EDC) to form the final linear block copolymer (FIG. 2, appendix C). More examples of the synthesis, and a library of macromonomers, bottlebrush polymers and crosslinkers can be found in US utility patent application Ser. No. 15,931,254 (entitled CAPACITIVE PRESSURE SENSOR WITH BOTTLEBRUSH ELASTOMER DIELECTRIC LAYER FOR LOW PRESSURE SENSING). The availability of these library of macromonomer materials can be used to form either homopolymers, random copolymers, statistical copolymers, or block copolymers as desired for the targeted applications.

Bottlebrush block copolymers (diblock, triblock, tetrablock etc.) and statistical (or random) copolymers can be formed by copolymerizing two or more macromonomers sequentially or simultaneously.

Bottlebrush block copolymers have two or more distinct “blocks” along the backbone. In each block, all side-chains are the same chemistry.

Bottlebrush statistical copolymers have two or more types of side-chains that are statistically distributed along the backbone as determined by the kinetics of grafting-through copolymerization.

Bottlebrush random copolymers have two or more types of side-chains randomly distributed along the backbone.

Graft density of the bottlebrush polymers may be adjusted by sequentially or simultaneously copolymerizing one or more of the macromonomers with one or more of the small molecule monomers (backbone spacer) in a certain ratio, to form comb polymers with smaller grafting density (side chains) than bottlebrush polymers.

Characterization of the example poly(ethylene glycol)-poly(dimethylsiloxane) (PEG-PDMS) bottlebrush polymer is discussed below.

b. Mesostructure and Yield-Stress Behavior

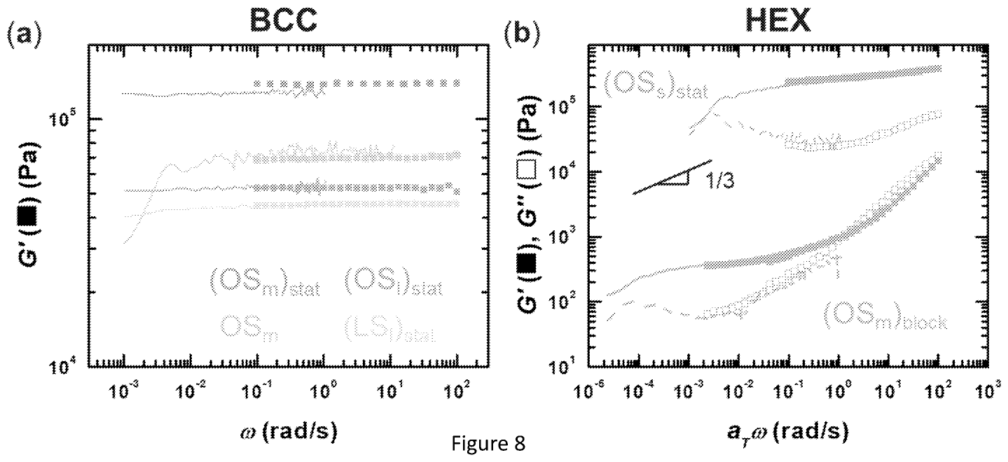

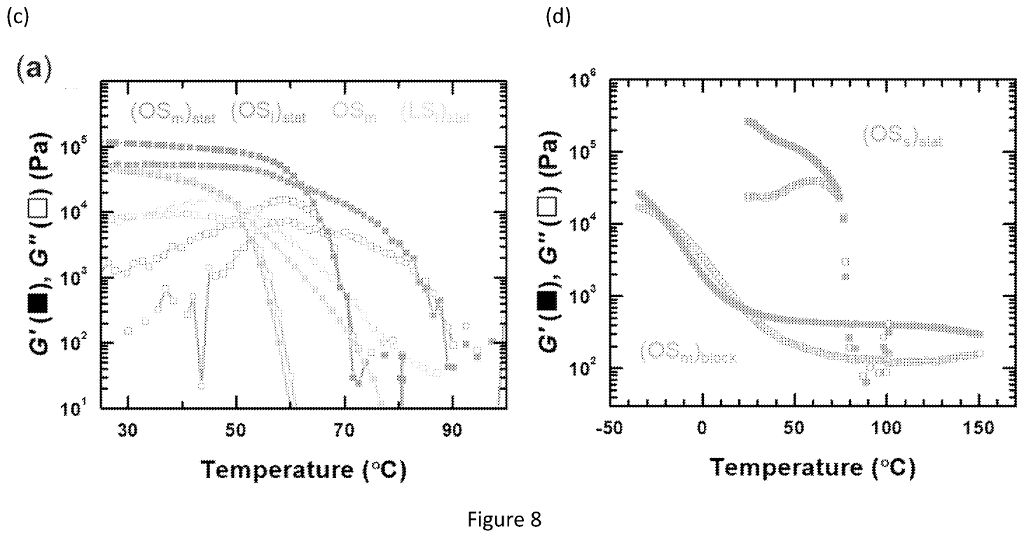

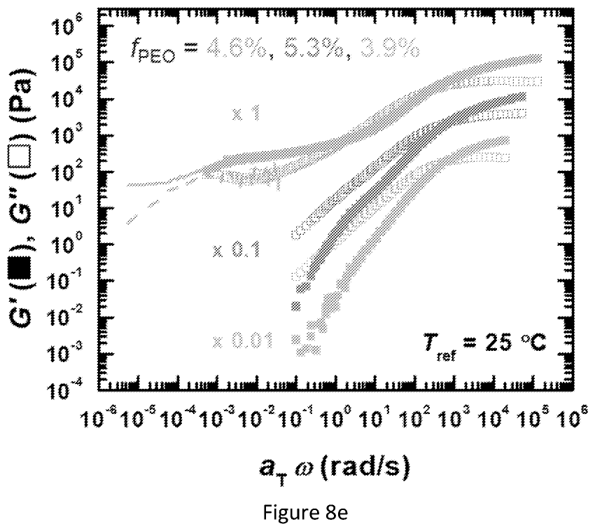

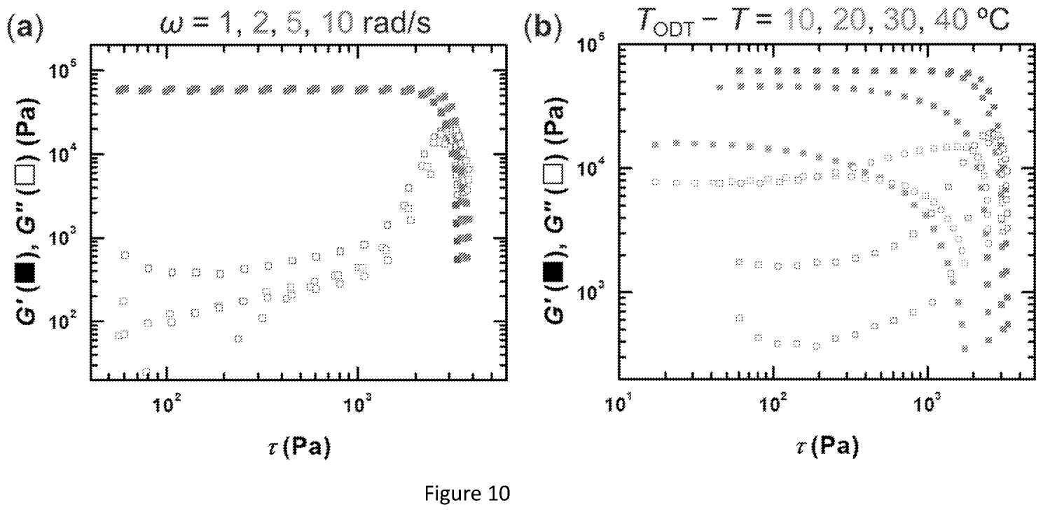

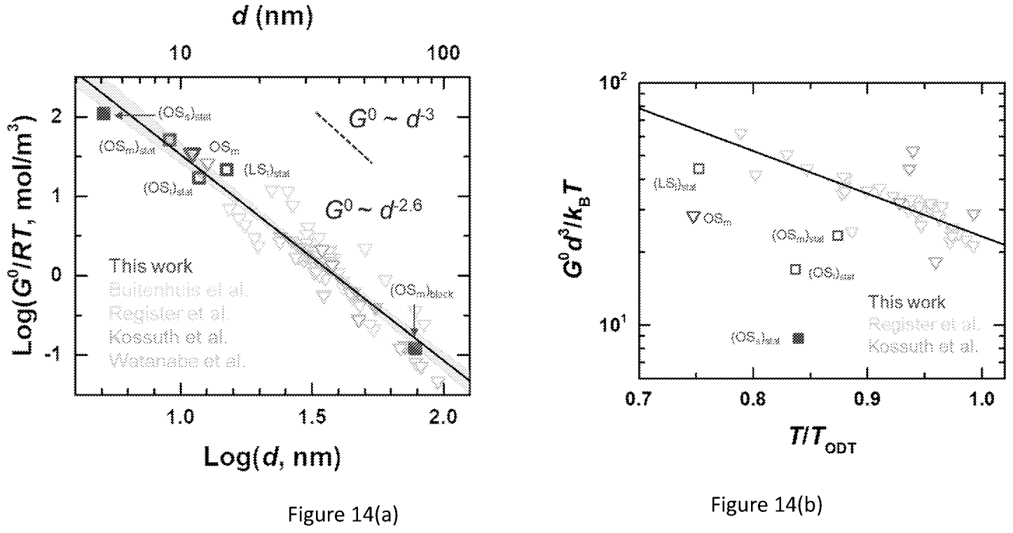

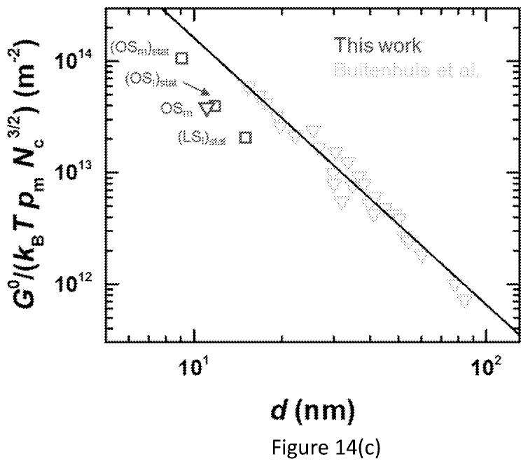

The proposed yield-stress behavior of PDMS-stat-PEO bottlebrush polymers is predicated on their ability to microphase separate into well-ordered spherical morphology at room temperature. We therefore first examined the quiescent morphology under ambient conditions. FIG. 2a shows synchrotron small-angle X-ray scattering (SAXS) data for two samples with different PDMS side-chain lengths, N_{SC}=68 and 136. In each case, the sharp Bragg reflections at q/q*=1:\sqrt{2}:\sqrt{3}:\sqrt{4} are consistent with a well-ordered BCC phase, surprisingly at extremely asymmetric PEO compositions (f_{PEO}=0.04) that would normally be disordered for a conventional linear block copolymer. In addition, to the best of our knowledge, this is also the first report on the sphere-forming morphology from a statistical bottlebrush copolymer. We can infer the putative structure of the phase by comparing changes in the domain spacing (d*=2π/q*) with changes in the length of the backbone and pendant polymer chains. The domain spacing (d*) strongly depends on the PDMS side-chain degree of polymerization N_{SC}, with larger N_{SC} increasing d*. In contrast, d* remains insensitive to the backbone length (N_{BB}) and f_{PEO}. But the order-to-disorder transition temperature (T_{ODT}) above which Supplementary FIG. 14c in ref. 53 shows the sharp decrease in storage modulus and Supplementary FIG. 14b, d in ref. 53, and FIG. 8, 10 shows the broadening of the primary scattering peak and disappearance of other reflection peaks, is highly sensitive to f_{PEO} (also shown in FIGS. 8, 10). These results are consistent with localization of the flexible backbone at the interface between PEO spheres embedded within a PDMS matrix (FIG. 1)⁴² as further supported by the close agreement of d* with a linear analogue synthesized using equivalent PEO and PDMS block lengths. The order-to-disorder transition temperature (T_{ODT}) can be easily tuned by changing the volume ratio of PEG and PDMS components.

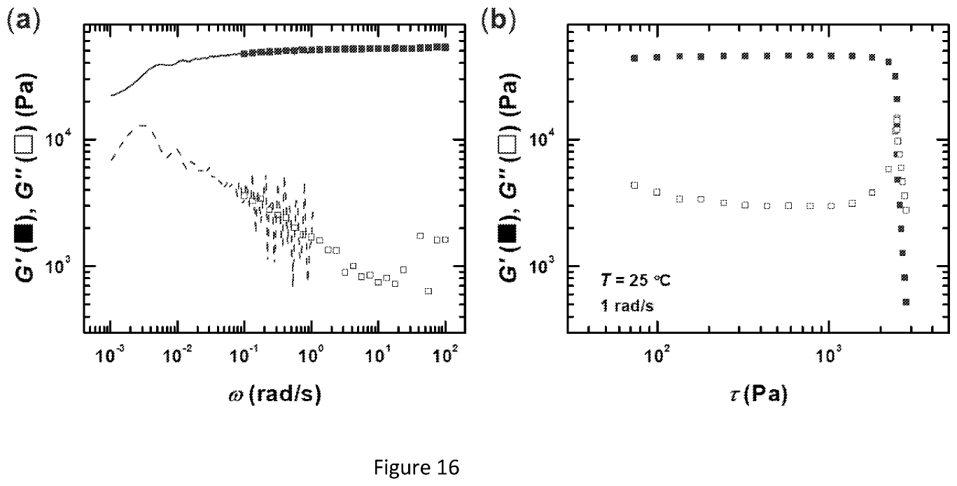

The linear viscoelastic response (oscillatory strain amplitude=0.01) (FIG. 2b) of PDMS-stat-PEO bottlebrush polymers as measured by oscillatory rheology indeed reflects a well-ordered BCC phase at room temperature, where a frequency-independent modulus (G⁰) extends across more than 5 decades in frequency thus ensuring excellent shape-retainability over long times. The dependence of G⁰ on d-spacing should also follow the general scaling relationship for a sphere-forming morphology, G⁰˜k_{B}T/d³, where k_{B} is Boltzmann's constant and T is absolute temperature, and d is the nearest-neighbor spacing between micelles.³⁴ Indeed, by comparing G⁰ in FIGS. 2b and d in FIG. 2a for the statistical copolymers with different PDMS side chain lengths (N_{SC}=68 and 136), the scaling relationship does hold, i.e., G_{N}_{_{SC}}₌₆₈⁰/G_{N}_{_{SC}}₌₁₃₆⁰=105 kPa/51 kPa=2.1 is similar to (d_{N}_{_{SC}}₌₁₃₆/d_{N}_{_{SC}}₌₆₈)³=(11.7 nm/9.44 nm)³=1.9. (Note that the proportionality constant between d and d* (hkl=110) cancels when taking the ratio.) Additionally, in accordance with the SAXS data, no significant changes in linear viscoelastic response were observed for samples with identical N_{SC} but different f_{PEO} and N_{BB} in Supplementary FIG. 16a of ref. 53. These results conclusively connect the molecular architecture, self-assembled BCC structure, and robust soft-solid characteristics of PDMS-stat-PEO statistical bottlebrushes at room temperature.

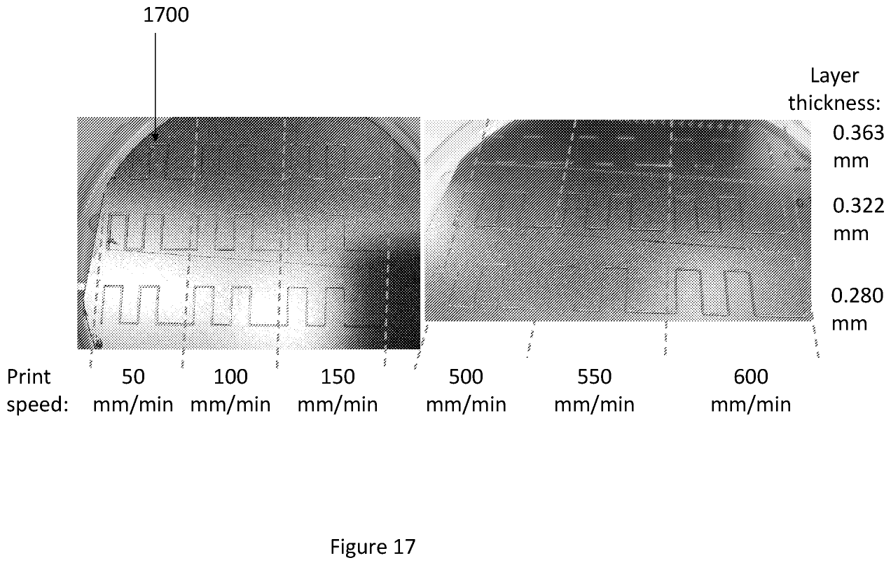

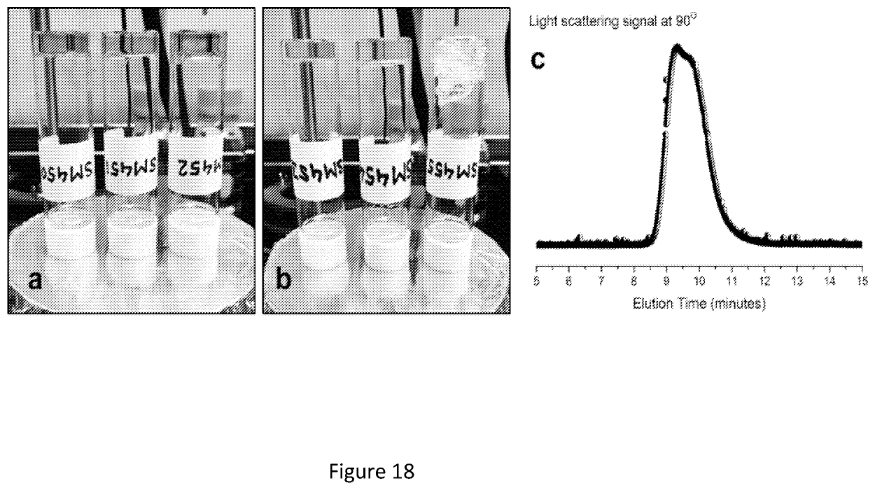

Sphere-forming PDMS-stat-PEO statistical copolymers exhibit sharp yielding at room temperature (FIG. 2c) beyond a critical stress τ_{y} defined as the crossover point of G′ and G″. The precise value of τ_{y} is tunable through the degree of polymerization N_{SC} of the PDMS side-chains, which is desirable for 3D printing because of the balance between the ease of extrusion and the mechanical stability of the extruded part. FIG. 2c shows that τ_{y} is lowered from 6.3 kPa to 2.9 kPa (nearly the same percentage decrease as that of G⁰) by doubling the PDMS side chain length from N_{SC}=68 to 136. Additionally, in accordance with the SAXS data and linear viscoelastic response, no significant changes in τ_{y} were observed for samples with identical N_{SC} but different f_{PEO} and N_{BB} in Supplementary FIG. 16b of ref. 53. This implies that the critical yield strain (γ_{y}) remains constant for statistical bottlebrush copolymers with different side chain lengths because τ_{y}=G⁰γ_{y}. Indeed, the oscillatory strain sweep in Supplementary FIG. 17a in ref. 53 reveals a constant γ_{y} of 0.11 for N_{SC}=68 and 136. As a result, the yield stress of a statistical bottlebrush copolymer can be manipulated by changing the domain spacing, which also controls the structural modulus as shown in Supplementary FIG. 17b of ref. 53. Other work on a series of sphere-forming linear diblock copolymers with different molecular weights and compositions also demonstrates the same scaling relation between d and τ_{y} but with a different γ_{y} of 0.038.³⁴ Although the reason for this difference in γ_{y} between brush statistical copolymer and linear block copolymer is unclear, larger γ_{y} may imply less defects in a BCC lattice⁴³ and thus better shape-retainability during 3D printing. Furthermore, γ_{y} of 0.11 agrees well with Frenkel's prediction (0.10) by considering a periodic potential energy between the BCC spheres^{34,43} and other types of structured fluids, such as saponite gels.^{44,45} Moreover, the solid-liquid phase transition is highly reversible on a fast time scale (within the step time of 12 s) at room temperature as evidenced by time sweep experiments that oscillate between two applied stresses smaller and larger than τ_{y} (FIG. 2d). Additional tests are fully consistent with this behavior, including axial extension (Supplementary FIG. 18a in ref. 53), repeated shear creep-recovery (Supplementary FIG. 18b of ref. 53), and cyclic steady shear (i.e., thixotropy loop) (Supplementary FIG. 18c of ref. 53). All of these results validate the thixotropic nature of our PDMS-stat-PEO bottlebrush copolymers and demonstrate fast recovery with excellent mechanical cyclability.

c. Photo-Crosslinking

In order to decouple the polymerization and the crosslinking process, we developed a generalizable photo-crosslinking system where miscible small molecules or polymers are terminally functionalized with two benzophenone moieties. Using an external material to facilitate cross-linking also facilitates fine-tuning the concentration of crosslinking units, which impacts the mechanical properties of the bottlebrush network and applications of the materials. The crosslinker structure can be easily tuned to maximize the miscibility with different classes of bottlebrush polymers by manipulating the linker connecting the two benzophenone units. Good miscibility is beneficial for material processing, e.g., solvent free and additive-free polymer crosslinking and device fabrication which is a big advantage for commercial production and long-term material and device stability. More examples of the crosslinkers and crosslinking chemistry can be found in U.S. provisional patent application Ser. Nos. 62/846,883 and 62/913,782, which applications are incorporated by reference herein.

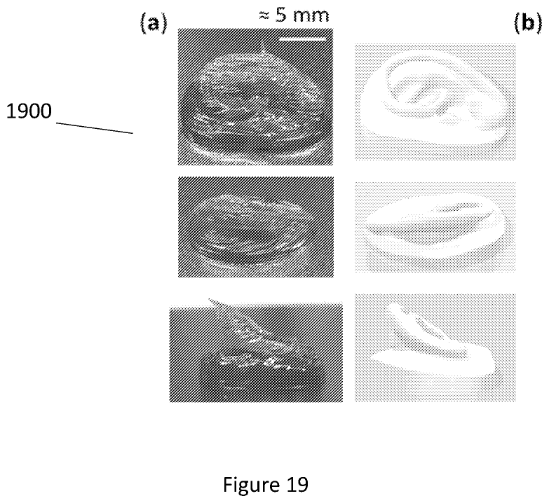

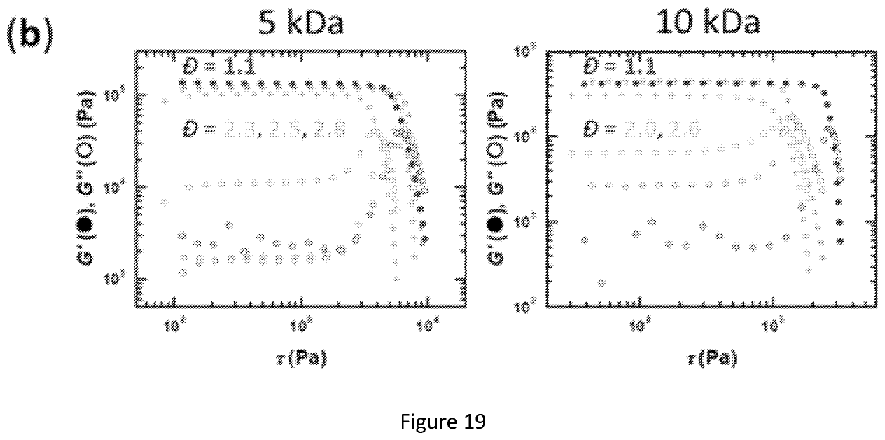

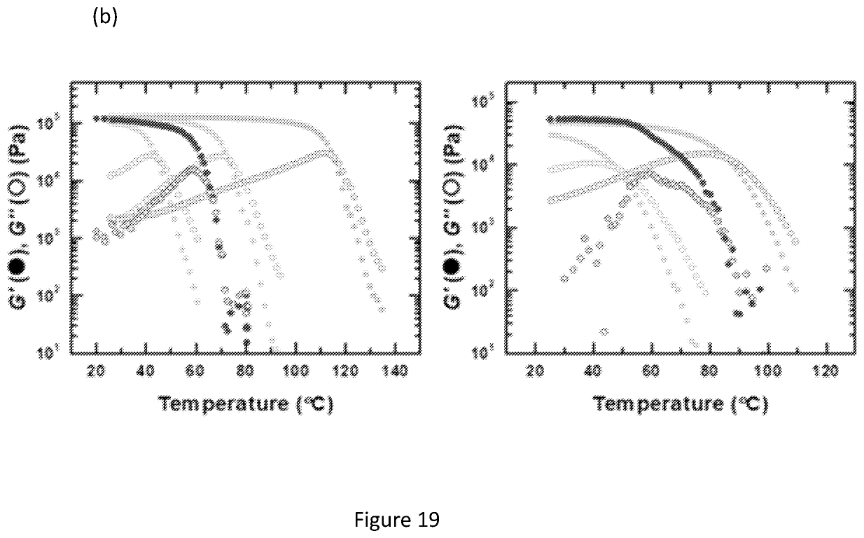

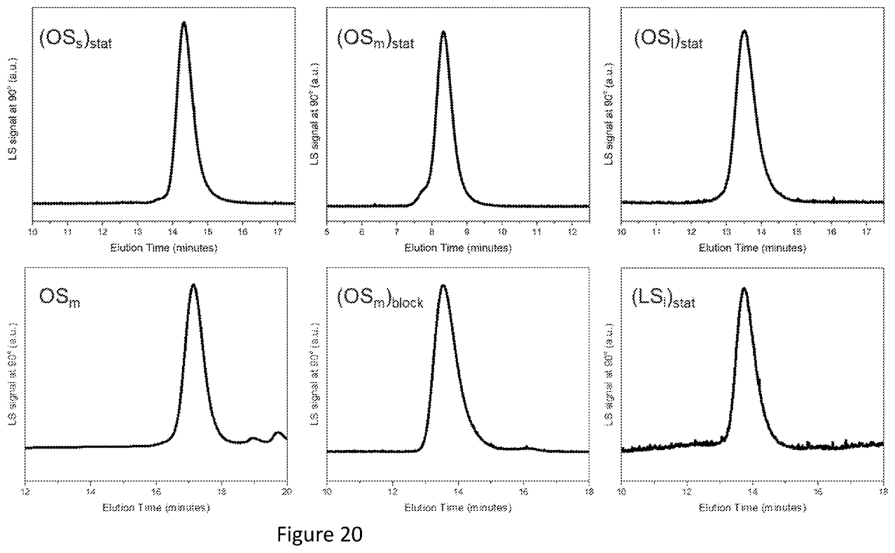

To photo-crosslink PDMS-stat-PEO bottlebrush copolymers, we leveraged a telechelic PDMS additive (“PDMSbisBP”) that includes benzophenone end-groups (FIG. 3a), which should segregate into the matrix (PDMS-rich) domain of the BCC structure due to the high χ between PEO and PDMS. Exposure to UV light generates radicals that react with bottlebrush molecules⁴¹ to form a robust network under ambient conditions (FIG. 3b). Mixing PDMSbisBP and PDMS-stat-PEO (with a molar ratio n_{cl}) causes little change in the structure (BCC spheres) and rheological response (G⁰, σ_{y}) at loadings that are sufficient to form a well-crosslinked elastomer (Supplementary FIG. 19a, b of ref. 53). For example, n_{cl}=8 produces a gel fraction≥90% with 0.63S₁₃₆⁸⁹-8. The modulus that results after the completion of UV curing (Supplementary FIG. 19c of ref. 53) is controlled by both the number density of chemical crosslinks (Gₓ˜n_{cl}) and the length scale of microphase separation (G⁰˜d⁻³) (Supplementary FIG. 20a, b of ref. 53). All shear moduli of crosslinked PDMS-stat-PEO bottlebrush polymers (<10⁵ Pa) are significantly softer than typical, fully-crosslinked linear networks (≈10⁶ Pa).

d. 3D Printing Bottlebrush Elastomers

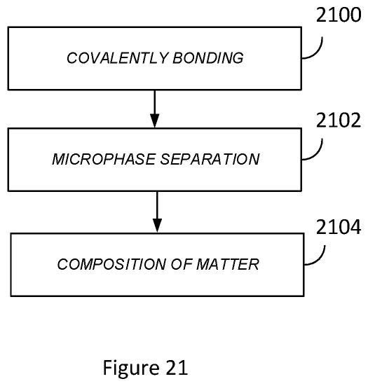

To demonstrate the 3D printability of PDMS-stat-PEO bottlebrush elastomers, we selected a formulation (0.63S₁₃₆⁸⁹-8) with ideal rheological properties (fast, reversible shear thinning) and curing kinetics. The simple direct ink writing process is illustrated in FIG. 1. Using a syringe-based 3D printer, we are able to print a proof-of-principle bowl-shaped structure with 450 overhang angle and no support. When squeezed in the print head at room temperature, the self-assembled spheres of PEO mechanically disorder and extrude from the nozzle at high applied pressures. Due to the fast reordering of these spheres onto a BCC lattice, the extrudate can be 3D printed at room temperature in a layer-by-layer fashion. Depending on the choice of nozzle diameter (ID=0.41 mm, 0.152 mm), the layer thickness can vary between 0.28 mm and 0.10 mm in Supplementary FIG. 21 of ref. 53, and the print time can change substantially between 40 mins and 4 hrs, respectively, for a bowl with an outer diameter of 20 mm and a height of 4 mm. No sag is observed during such a long printing process, due to the well-ordered morphology of our bottlebrush statistical copolymer of PEO and PDMS that exhibits the negligible amount of structural relaxation in FIG. 2b. After printing, the UV light can easily penetrate through the hollow bowl-shaped structure, thus allowing the completion of UV curing with a 365 nm UV light-emitting diode under the irradiance of 150 mW/cm² within 20 mins. The development and gradual decrease of phosphorescence intensity originating from benzophenone triplet states serves as a convenient indicator of the transformation process from the yield-stress fluid to a super-soft elastomer. The 3D-printed, UV-cured bowl is mechanically robust as evidenced by complete shape recovery after being stretched well beyond the yield stress multiple times (FIG. 4c). Therefore, the ability to decrease the yield stress by increasing the side chain length of PDMS-stat-PEO bottlebrush polymer allows a finer resolution of 3D printing without sacrificing either the shape-retainability during DIW or the super-soft elastomeric property after UV curing. Such controllability is clearly not achievable using the traditional ink material which requires addition of either solvent or particles.

e. Mechanical Properties

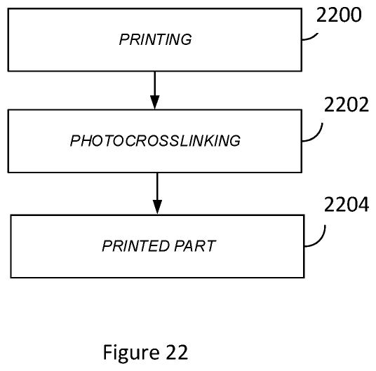

Cured PDMS-stat-PEO bottlebrush elastomers exhibit super-soft mechanical properties with unprecedented performance related to yielding. Uniaxial tensile experiments on a cured sample (FIG. 4a) with N_{SC}=136 at 25° C. shows two distinctive regions of mechanical response—a linear regime at low strains (shear modulus Gₚ) followed by yielding and strain softening (with shear modulus Gₓ<Gₚ). In the linear regime, each PEO domain acts as a physical crosslink in addition to the covalent crosslinks formed by UV curing. Then, as the tensile stress increases beyond the yield stress, unlike the classic yielding in a semicrystalline polymer or metal, the PEO domains are temporarily disordered (i.e., mechanically induced phase transition), effectively reducing the number of crosslinks and leading to an abrupt transition of strain softening. With continuous stretching, the bottlebrush network strand starts to align and extend along the tensile direction, resulting in the apparent strain hardening behavior before rupture. The transition across the yield stress is related to a structural transformation between BCC and disordered micelles as evidenced by in situ SAXS experiments in the unstretched and stretched states (FIG. 4b). Yielding in the solid state based on a BCC-disordered-micelle transformation is also consistent with the rheology of uncured PDMS-stat-PEO bottlebrushes that yield by an identical mechanism; the tensile yield stress of a cured elastomer (σ_{y}=10 kPa) is roughly 3× higher than the shear yield stress measured for uncured PDMS-stat-PEO inks (τ_{y}=2.9 kPa, FIG. 2c) as expected for an incompressible material with Poisson's ratio=0.5. This behavior is closely related to the structural rearrangements that occur at the order-disorder transition temperature (T_{ODT}) of BCC-forming block copolymers, which formally represents a first order phase transition corresponding to the lattice disordering of soft micelles. Indeed, the shear moduli extracted from tensile test at 25° C. (Supplementary FIG. 22a, b of ref. 53) in the microphase-separated (Gₚ=32 kPa) and disordered (Gₓ=7.7 kPa) states agree with the moduli we measure in the linear region at 25° C. (Gₚ=50 kPa, T<T_{ODT} in Supplementary FIG. 20a of ref. 53) and 100° C. (Gₓ=10 kPa, T>T_{ODT} in Supplementary FIG. 20b of ref. 53).

Additionally, the mechanical properties of the dog bone samples formed by UV curing either the 3D printed or molded structures are compared. Specifically, the 3D printed dog bone with the layer thickness of 0.10 mm still shows a lower tensile strength and shorter elongation-at-break (Amax) than that of molded one as expected in Supplementary FIG. 23 of ref. 53, but the 3D printed part still possesses excellent elastomeric property with the ma of about 3.

UV-cured PDMS-stat-PEO bottlebrush elastomers exhibit essentially perfect recoverability even after being stretched well beyond the yield stress (FIG. 4a, c). To the best of our knowledge, this elastomeric performance is unprecedented. For example, particle-filled rubbers cannot completely recover either their shape or mechanical behavior after yielding due to the Mullins effect caused by internal sliding.⁴⁶ Similarly, double network gels and elastomers show fully recoverable shape but not elasticity beyond the strain-softening point because of permanent bond degradation in the first network upon large deformation.⁴⁷ The additional inclusion of ionic crosslinks improves recoverable elasticity but still results in significant permanent deformation after unloading due to ionic cluster rearrangement.⁴⁸ Therefore, we speculate that the extent of ordering for the PEO domains is related to the macroscopic recoverability of the PDMS-stat-PEO bottlebrush elastomer. Due to the well-ordered BCC spheres and uniform d-spacing, there could be much less tolerance on the possible rearrangements of the bottlebrush polymers in PEO domains upon release. Nonetheless, a comprehensive future study using in situ tensile SAXS experiment is needed to reveal the underlying mechanism for this near perfect recoverability.

### 2. Second Example: Linear Block Copolymers

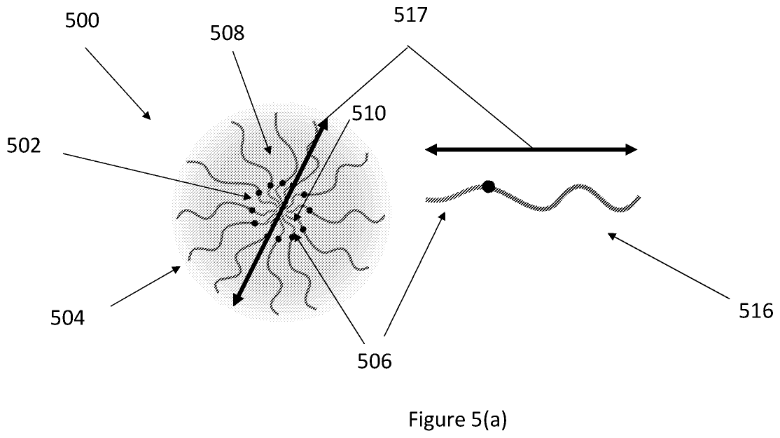

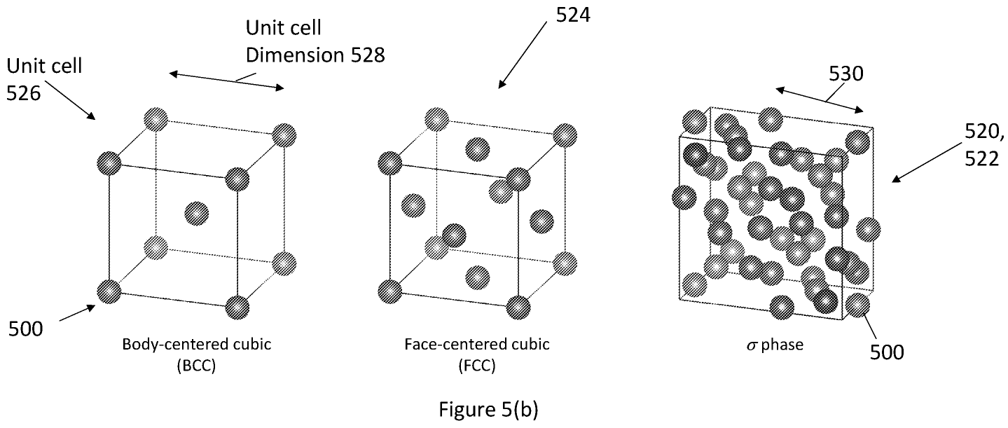

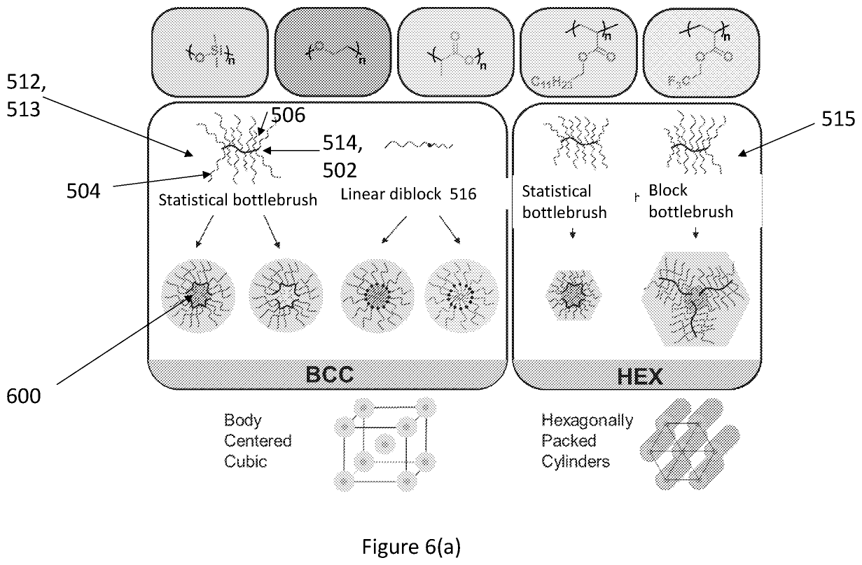

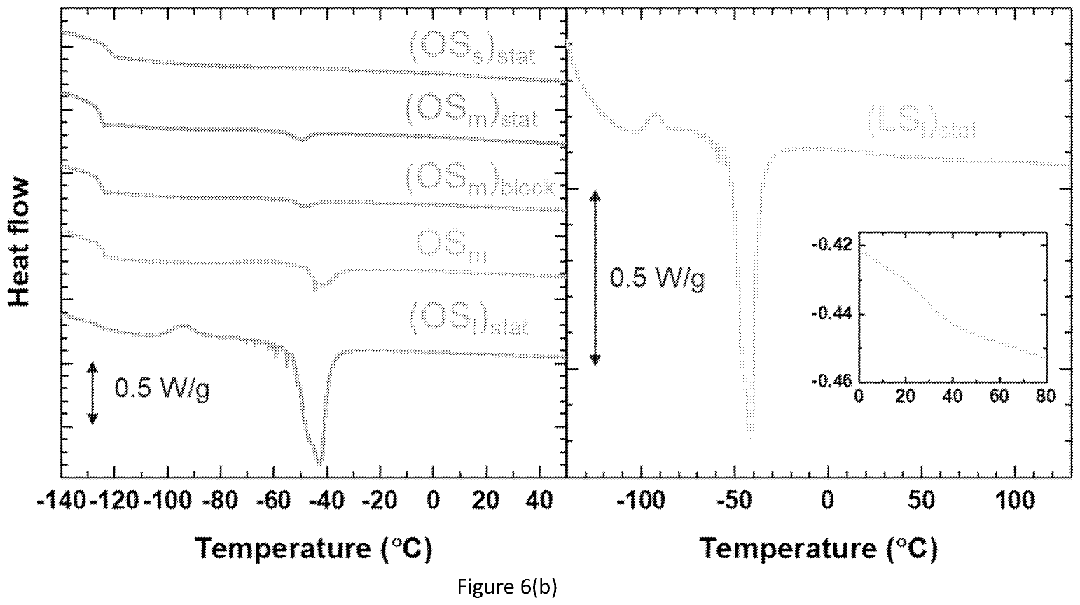

FIG. 5(a) illustrates a plurality of self-assembled copolymers 500, wherein the self-assembled copolymers comprise a plurality of linear block copolymers each comprising two or more polymers (blocks) including a first polymer (block) 504 covalently bonded to a second polymer (block) 506. At least one of the first polymers (blocks) or the second polymers (blocks) have their glass transition temperature less than or equal to 20 degrees Celsius. An interface 502 between the first type of polymers 504 (or first side-chains 504) and the second type of polymers 506 (or second side-chains 506) defines a boundary having a convex side 508 and a concave side 510. In some examples (see FIG. 6(a)), the self-assembled copolymers comprise the bottlebrush copolymers 512 each having a backbone 514 and the interface 502 comprises the backbone 514. In other examples, the copolymers 500 comprise a linear diblock 516.

FIG. 6(a) illustrates examples of bottlebrush polymers 512 include statistical bottlebrush polymers 513 and block bottlebrush polymers 515.

The block copolymers may comprise any number of blocks each comprising two or more polymers, e.g., diblock copolymers, triblock copolymers, tetrablock copolymers, pentablock copolymers etc.

In one or more examples, each of the self-assembled copolymers 500 comprise nanostructures having a largest dimension 517 (e.g., length, diameter, outer diameter)) in a range of 1-1000 nm (e.g., in a range of 5 nm-200 nm or less than 18 nm).

### 3. Impact of Microphase Separated Morphology on Yield Stress Fluid Behavior

In various examples illustrated herein, the copolymers are arranged to form a plurality of nanostructures (e.g. a star shaped polymer bundle) each including one or more of the self-assembled copolymers. The first polymers (blocks) form the core and the second polymers (blocks) form the corona or shell of a the nanostructures. A composition of matter 520 comprising a group of the nanostructures can be characterized as a yield stress fluid 522 having a yield stress, wherein the nanostructures are arranged on a lattice 524 (e.g., as illustrated in FIG. 5(b)) when the yield stress fluid experiences a stress below the yield stress. In one or more examples, the nanostructures are arranged on the lattice having a unit cell selected from a body center cubic spheres, face cubic center spheres, or any unit cell associated with a Frank-Kasper phase (e.g., a sigma phase, an A15 phase, a C14 phase, a C15 phase, or a Z phase).

In one or more examples, the self-assembled nanostructures 500 are disposed in a unit cell 526 having a dimension 528 in a range of 1-1000 nm (e.g., in a range of 5-200 or less than 18 nm). In one or more examples, the self-assembled nanostructures 500 are separated by a spacing 530 in a range of 1-1000 nm (e.g., less than 18 nm).

Each block of the copolymer can be a linear polymer block, a bottlebrush polymer block, a comb polymer block, a star polymer block, a dendritic polymer block etc.

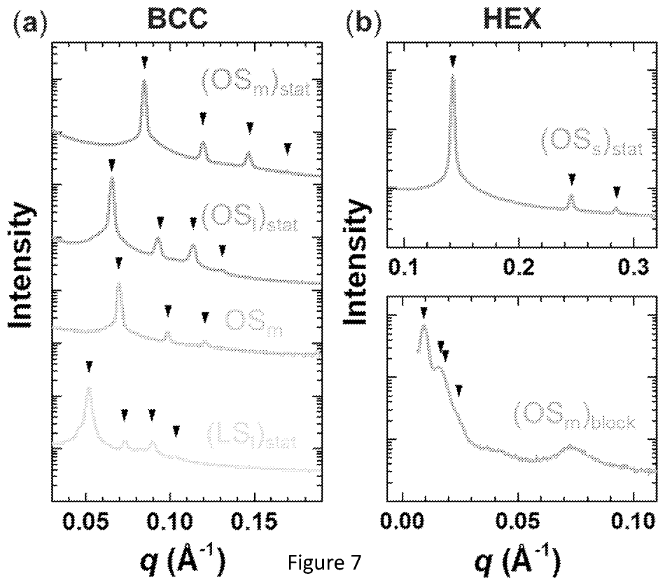

The yield stress fluid behavior is dictated by the microphase separated morphology of the copolymers. 1D SAXS of the bottlebrush PEG-PDMS diblock copolymer suggested a system of self-assembled soft colloidal nanostructures (core=PEG and corona=PDMS) with a d-spacing of 66 nm. This is further confirmed by constructing the master curve between 25 and 85° C. at a reference temperature of 25° C. The low plateau modulus of around 400 Pa is a clear signature of colloidal jamming, caused by the topological constraint on the length scale of a colloid. The size of the colloidal nanostructures is easily tunable by changing the backbone degree of polymerization (N_{BB}) of the brush diblock copolymers (FIGS. 6a, 7b). Low plateau modulus for the brush diblock copolymer led to low yield stress (i.e., 70 Pa). The polymer backbone length (degree of polymerization, N_{BB}) can be easily tuned through the living ROMP polymerization chemistry, so as the yield stress of bottlebrush block copolymers by varying the N_{BB} of the block copolymer. (FIGS. 7 and 8).

### 4. Role of Architecture, Chemistry, and Morphology in the Yield-Stress Behavior of Blocky/Statistical Bottlebrush and Linear Diblock Copolymers

Ordered mesophases that emerge from the self-assembly of various copolymers exhibit unique rheology which dictates the processability and physical properties of materials derived therefrom.¹ One example is linear block copolymers (AB and ABA sequences) with asymmetric compositions (volume fractions f_{A}<<0.5) that adopt a shear-thinning body-centered cubic (BCC) phase at elevated temperatures.¹⁻⁴ Such behavior is characteristic of yield-stress fluids,^{5,6} which undergo a reversible solid-liquid phase transition at a critical applied stress. Yield-stress fluids are not just a scientific curiosity; they are common in daily life and advanced materials alike, with examples ranging from whipped cream to rocket fuel,^{7,8} jammed particle dispersions,⁹ and moldable hydrogels.¹⁰

A quantitative understanding of the yielding transition in self-assembled copolymers is intimately tied to a number of (often interrelated) physical properties, including the chemistry of each component (glass transition temperatures (T_{g}), entanglement molecular weights) and their degrees of polymerization in addition to the mesoscale morphology and order-disorder transition temperature (T_{ODT}). This already staggering number of design parameters is further compounded by the ability of synthetic chemists to create new polymer architectures with enormous complexity yet excellent control. How does the yielding transition depend on the confluence of these molecular design variables? While this question remains of considerable importance in contemporary applications e.g., to identify optimal inks for extrusion-based 3D printing we are unaware of any studies that have systematically probed the coupling between yielding, architecture, chemistry, and morphology.

As described above, highly-branched bottlebrush polymers with two types of statistically-distributed side chains (polydimethylsiloxane (“S”) and poly(ethylene oxide) (“O”)) exhibit a sharp and highly reversible yielding transition at room temperature when self-assembled into a spherical BCC phase. These materials exhibit an unusually flat dynamic response across more than five decades in frequency, which is a surprising contrast to the long-time relaxation reported for other BCC-forming linear diblock and triblock copolymers (at elevated temperatures, at least 20° C. below T_{ODT} and 30° C. above T_{g} of each block)² involving different chemical building blocks. These unusual characteristics of statistical bottlebrush copolymers have prompted us to examine in detail the nature of yielding as a function of molecular design. Here, we systematically analyze the impact of architecture (bottlebrush vs. linear), side-chain sequence (statistical vs. block), and morphology (BCC vs. HEX) on the linear viscoelasticity and non-linear yielding behavior of self-assembled copolymers using several types of chemical building blocks, including S, O, and poly(lactide) (“L”) that span a range of physical properties. Distinct differences between these materials manifest as quantitative discrepancies in the yield stress, critical/yield strain, transition sharpness, and reversibility. Beyond providing fresh insights into the unique properties of designer soft materials, we anticipate these results may prove useful in applications that leverage bottlebrush polymers and which involve significant shear during processing, for example, photonics crystals,^{12,13} surface coating,^{14,15} and nanopatterning.^{16,17}

a. Molecular Design and Synthesis

To probe the nature of yielding in self-assembled copolymers, we designed materials for three types of comparisons (FIG. 6a). (1) Architecture. Statistical bottlebrush, diblock bottlebrush, and linear diblock copolymers were prepared, each comprising two types of chemical building blocks (denoted A and B) in a number of different combinations (see below). (2) Morphology. Our primary focus here is contrasting the yielding transition with two morphologies: body-centered cubic (BCC) spheres and hexagonally close-packed cylinders (HEX). Both arise at asymmetric copolymer compositions, i.e., A-component volume fractions f_{A}<0.1. (3) Building block chemistry. The BCC and HEX phases produce discrete domains (“cores”) of the A block surrounded by a corona of B chains. One of our goals is to understand how the stiffness of the core influences yielding, if at all. We therefore opted to compare two different A-block chemistries with complementary physical properties at room temperature: short poly(ethylene oxide) (0, soft: T_{g}=−60° C., no Tₘ), and poly(lactide) (L, hard; T_{g}=30° C., no Tₘ). Each of these was paired with a soft B block that fills the interstitial space between micelles and promotes yielding under ambient conditions poly(dimethyl siloxane) (S: Tₘ=−50° C., T_{g}=−125° C.). FIG. 6b summarizes the thermal characterization of these materials.

FIG. 6a and Table 2 summarize the chemistry and molecular characterization of materials studied herein: (1) statistical bottlebrush copolymers (OSₛ)ₛₜₐₜ, (OSₘ)ₛₜₐₜ, (OSₗ)ₛₜₐₜ and (LSₗ)ₛₜₐₜ, (2) block bottlebrushes (OSₘ)_{block}, and (3) linear diblock copolymers OSₘ.²⁴ Note that in our sample nomenclature, the letters denote the types of chemistry as defined above, parentheses imply the bottlebrush architecture, the subscript “s”, “m”, “1” represents short (N_{B}=14), medium (N_{B}=68) and long (N_{B}=136) poly(dimethylsiloxane) chain segment, respectively, the subscript “stat”, “block” indicates sequence (statistical or blocky), and linear diblock materials are written without parentheses. All bottlebrush copolymers were synthesized via grafting-through copolymerization of norbornene-terminated macromonomers using ring-opening metathesis polymerization (ROMP)²⁵ on multi-gram scale with good control over molar mass dispersity (Ð<1.3). Full synthetic details are listed in the Materials and Methods section.

TABLE 2
Molecular characterization of the copolymers studied herein.

| ID^{a} | Architecture | Sequence | A^{b} | B | N_{A} | N_{B} | f_{A}^{c} | N_{BB}^{d} | Mₙ^{e} | Ð | Phase | T_{ODT}^{f} |
|---|---|---|---|---|---|---|---|---|---|---|---|---|
| (OSₘ)_{block} | Bottlebrush | Diblock | O | S | 10 | 68 | 0.05 | 130 | 560 | 1.17 | HEX | — |
| (OS_{λ})ₛₜₐₜ | Bottlebrush | Statistical | O | S | 10 | 136 | 0.04 | 110 | 720 | 1.07 | BCC | 83 |
| (OSₘ)ₛₜₐₜ | Bottlebrush | Statistical | O | S | 10 | 68 | 0.04 | 150 | 630 | 1.08 | BCC | 68 |
| (OSₛ)ₛₜₐₜ | Bottlebrush | Statistical | O | S | 10 | 14 | 0.06 | 160 | 190 | 1.05 | HEX | 74 |
| (LSⱼ)ₛₜₐₜ | Bottlebrush | Statistical | L | S | 17 | 136 | 0.04 | 50 | 380 | 1.24 | BCC | 50 |
| OSₘ | Linear | Diblock | O | S | 10 | 68 | 0.09 | — | 5.8 | 1.1 | BCC | 52 |

^{P}arentheses imply the bottlebrush architecture. O = poly(ethylene oxide), S = poly(dimethylsiloxane), L = poly(lactide). Subscript, s, m, l, represent short, medium and long poly(dimethylsiloxane) chain segment, respectively.
^{b}A block defined as the core of spheres or cylinders.
^{c}Volume fraction of the A component.
^{d}Backbone degree of polymerization; only applicable to bottlebrush samples.
^{e}Measured by MALS-SEC; in kg/mol.
^{f}Order-disorder transition temperature in ° C. as determined by linear viscoelastic rheology.

b. Morphology and Linear Viscoelastic Rheology

The ability of self-assembled copolymers to yield relies on the formation of morphologies such as BCC and HEX that have an elastic response at low strains. We therefore first examined the quiescent morphology of various samples at room temperature by small-angle X-ray scattering (SAXS) (FIG. 7a-7b). Notably, statistical bottlebrush polymers with extremely asymmetric compositions (f_{A}˜ 0.05) form high-quality BCC phases (FIG. 7a) for multiple choices of side-chain chemistry and length, including (LSₘ)ₛₜₐₜ, (OSₘ)ₛₜₐₜ and (OSₗ)ₛₜₐₜ. In contrast, clear morphological SAXS signatures with curved interfaces are rarely obtained using the diblock bottlebrush sequence²⁶⁻²⁸ as evidenced by an (OSₘ)_{block} sample of comparable f_{A}˜ 0.05, which exhibits substantially broader SAXS peaks than (OS)ₛₜₐₜ. These results highlight the importance of side-chain sequence in self-assembly and confirm the generality of our previous finding that statistical bottlebrush copolymers more easily accommodate interfacial curvature than diblock analogues. FIG. 7a-7b also shows SAXS patterns for one BCC-forming linear diblock copolymer, OSₘ, and one HEX-forming statistical bottlebrush, (OSₛ)ₛₜₐₜ, all of which are well-ordered.

The local packing of bottlebrush copolymers is known to depend on side-chain sequence, which manifests as differences in the principle scattering wave vector |q*|−q*=2π/d*. This difference is evident in FIG. 7: the q* value of (OSₘ)ₛₜₐₜ (0.085 Å⁻¹) is significantly larger than (OSₘ)_{block} (0.0093 Å⁻¹) because the inter-micelle distance (d) is controlled by the side-chain degree of polymerization (NA and N_{B}) for a statistical bottlebrush, but controlled by the backbone degree of polymerization (N_{BB}) with blocky sequences. Interestingly, a broad, high-q (small-d) peak appears in one example (OSₘ)_{block} around 0.075 Å⁻¹, which is insensitive to N_{BB} but changes position with N_{B} (0.12 Å⁻¹ for (OSₛ)_{block} in Table 3). We attribute this to the average spacing between block bottlebrush backbones, which pack together in the vicinity of each other within micelles and are separated to a first approximation by the side chain length.

The linear viscoelastic response measured by oscillatory shear rheology shows distinct differences related to architecture and morphology. Among the BCC-forming polymers in FIG. 8a, a frequency-independent structural modulus (G⁰≡G′(10⁻³ rad/s)>>G″) extends across more than five decades in frequency for the statistical bottlebrush copolymers with both soft ((OSₘ)ₛₜₐₜ) and hard ((LSₘ)ₛₜₐₜ) cores. In contrast, the linear diblock copolymer OSₘ display significant relaxation at long times (below 0.004 rad/s), even at temperatures much lower than T_{ODT}. See Table 1 and FIG. 8c-8d for the determination of T_{ODT} values.) In fact, the extent of supercooling below T_{ODT} is greater for the linear diblock (i.e., T_{ODT}−T=82° C. for OSₘ) than the statistical bottlebrush copolymers (i.e., T_{ODT}−T=43° C. for (OSₘ)ₛₜₐₜ, 58° C. for (OSₗ)ₛₜₐₜ and 80° C. for (LSₘ)ₛₜₐₜ). Taken together, these observations strongly suggest that chain architecture plays a key role in defect-mediated flow or lack thereof. The motion of defects ultimately requires microdomain rearrangement through the diffusion of individual molecules across domain boundaries.³ The diffusivity of a bottlebrush that consists of many covalently-linked macromonomers should be much slower than a diblock of comparable domain spacing. The HEX-forming bottlebrush polymers in FIG. 8b—(OSₛ)ₛₜₐₜ and (OSₘ)_{block}—still exhibit a clear plateau region with a minimum in G″ followed by a faster relaxation in the low-frequency region. We argue that this wide plateau (across more than three decades in frequency) does not originate from chain entanglements due to extremely high entanglement molecular weight for bottlebrushes but results from a delay in defect relaxation caused by a large bottlebrush size. To the best of our knowledge, this linear viscoelastic behavior of HEX-forming bottlebrushes is in stark contrast to all the HEX-forming linear blocks, whose frequency response is dominated by the defect-mediated flow on a hexagonal lattice with a constant characteristic slope of ⅓^{29,30}. As a result, we can determine the structural modulus for HEX polymers (G⁰) as G′ at the local minimum of G″. Due to the large difference in domain spacing between HEX-forming (OSₛ)ₛₜₐₜ and (OSₘ)_{block} (FIG. 7b), G⁰ differs by nearly three orders of magnitude (FIG. 8b: 2.7×10⁵ Pa and 360 Pa, respectively). Furthermore, despite the rather ill-defined SAXS data for (OSₘ)_{block}, we believe that the characteristic slope of ⅓ observed at low frequencies below 0.0001 rad/s is indeed consistent with randomly oriented cylinders and further supports our assignment of a HEX morphology³⁰. Additionally, the G′ and G″ crossover at high frequency (circa 100 rad/s) for (OSₘ)_{block} represents the inverse of Rouse time of PDMS side-chain, supported by comparing other less ordered bottlebrush diblock copolymers with different f_{PEO} and N_{BB} ((OSₘ)_{block,1} and (OSₘ)_{block,2} in FIG. 8e (master curves)). This similar crossover frequency and high-frequency plateau modulus around 10⁵ Pa implies the same molecular origin that PDMS side chains jam on the length scale of inter-backbone spacing for bottlebrush diblock copolymers regardless of the extent of ordering. FIG. 8e also reveals another G′ plateau at the lowest frequencies (10⁻⁵-10⁻⁶ rad/s) and highest temperatures (130° C.), possibly corresponding to the colloidal jamming of cylindrical micelles.³¹⁻³³

c. Characterization of the Yield-Stress

Before investigating the role of structural ordering and chain architecture on yielding, we need to first clarify other factors that may influence the characterization results, including deformation type, applied frequency, and extent of supercooling below T_{ODT}. We have opted to use BCC-forming statistical bottlebrush copolymers for these studies since they exhibit unique rheology in comparison to the blocky sequence and linear analogues (vide supra).

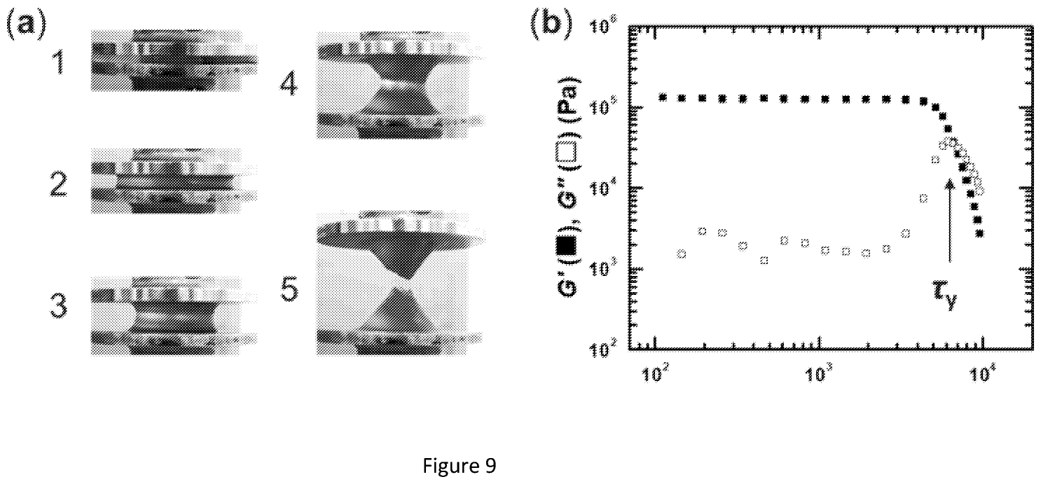

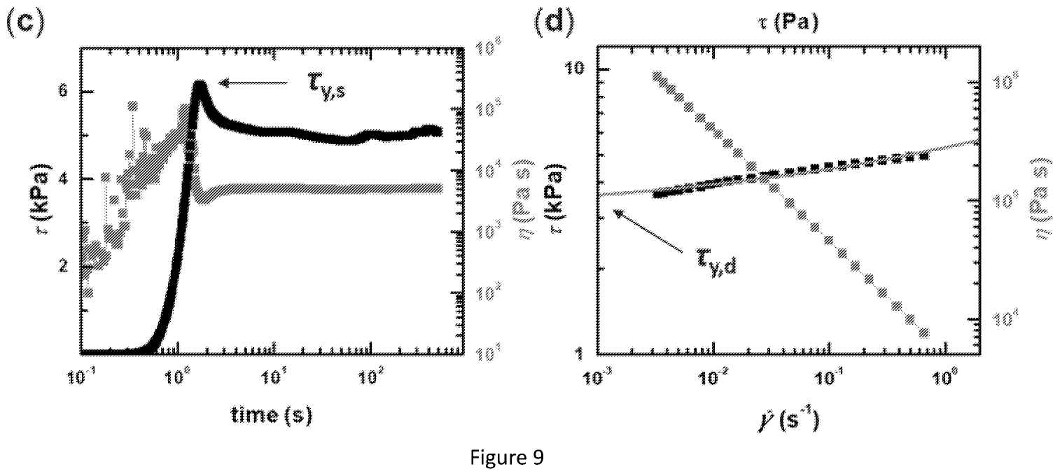

First, the yield-stress fluid behavior of (OSₘ)ₛₜₐₜ is clearly visualized in FIG. 9a, where a series of time-lapse images were captured while extending the sample between two parallel plates. Images 1-3 capture liquid-like behavior with a meniscus that contracts from the edge to the center. Its ability to retain its shape (solid-like response) is better observed in images 4-5. To quantitatively characterize this type of solid-liquid transition, three tests were performed, namely an oscillatory amplitude sweep, transient start-up shear, and steady-rate sweep from high to low shear rate. Specifically, as the oscillatory stress amplitude increases in FIG. 9b, G″ goes through an overshoot, which is caused by the transition from solid-like, viscoelastic dissipation (G′>G″) in the linear regime to fluid-like, plastic flow (G′<G″) at larger amplitudes.³⁴ The G′ and G″ crossover point corresponds to the yield stress (τ_{y}). Similarly, transient start-up also captures the solid-to-liquid transition via a step increase in shear rate from 0 to 1.0 s⁻¹ (FIG. 9c), where the peak overshoot represents the minimum stress required to drive the flow from at rest (also known as the static yield stress, τ_{y,s}). Quantitatively, τ_{y,s}=6.2 kPa agrees well with the oscillatory yield stress (τ_{y}=6.6 kPa). The reverse transition from liquid to solid and corresponding dynamic yield stress (τ_{y,d}: the minimum stress required to maintain flow) was also determined by fitting steady-rate sweep data collected from high to low shear rate to the Herschel-Bulkley model (FIG. 9d).³⁵ As expected, the static yield stress is greater than the dynamic yield stress,^{5,7} τ_{y,s}=6.2 kPa>τ_{y,d}=3.1 kPa. Because our primary goal in this work is to understand the role of structural ordering in yielding, the static yield stress, which is associated with the energy required to disorder a lattice, seems more relevant than the dynamic yield stress. Additionally, given the close agreement between oscillatory and static yield stresses, the oscillatory amplitude sweep test was chosen for characterizing other materials in this work due to its simplicity in sample loading (parallel plates vs. cone-plate) and good reproducibility.

The effect of applied frequency and supercooling below T_{ODT} on the yielding transition were also studied with (OSₗ)ₛₜₐₜ in FIG. 10. The yielding transition shows minimal variation across 1.0-10 rad/s (FIG. 10a), which corroborates the observed frequency-independent behavior of the BCC-forming statistical bottlebrush copolymers in FIG. 8a. The yield stress does, however, depend on temperature, particularly when approaching T_{ODT}. Near T_{ODT} compositional fluctuations strengthen creating more diffuse interfaces³⁶ that require less stress to mechanically disorder the lattice (FIG. 10b). As the extent of supercooling below T_{ODT} becomes larger than ˜30° C., the yield stress essentially asymptotes. Because of these considerations we used a frequency of 1 rad/s and a temperature at least 30° C. below T_{ODT} for consistency in the following analysis.

d. Effect of Morphology on the Yielding Transition

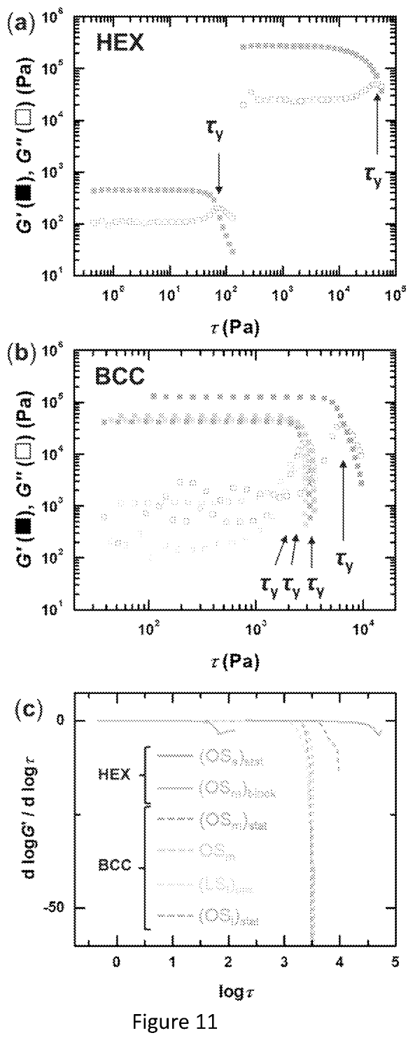

In FIGS. 11a and 11b, the yield stress (τ_{y}) is compared for BCC- and HEX-forming polymers with different architectures and chemistry. Oscillatory amplitude sweeps at a constant frequency (1.0 rad/s) and temperatures far below T_{ODT} indicate the yield stress varies widely depending on molecular design: 2.8-9 kPa for the BCC morphology and, notably, between 0.067 kPa and 49 kPa for HEX. Additionally, there are distinct differences in the sharpness of the yielding transition as is evident when the slope is plotted as d log G′/d log r (FIG. 11c). A much weaker yielding transition is observed for the HEX phase, suggesting a broad spectrum of relaxation times that possibly originate from the gradual shear alignment of randomly oriented cylinders.

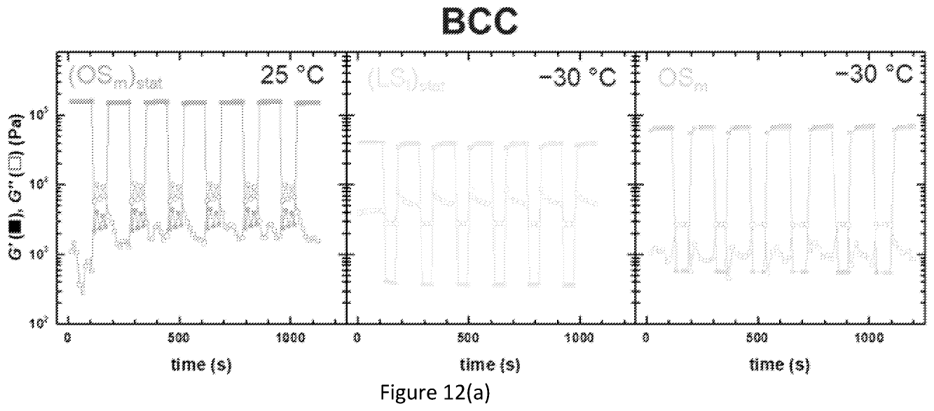

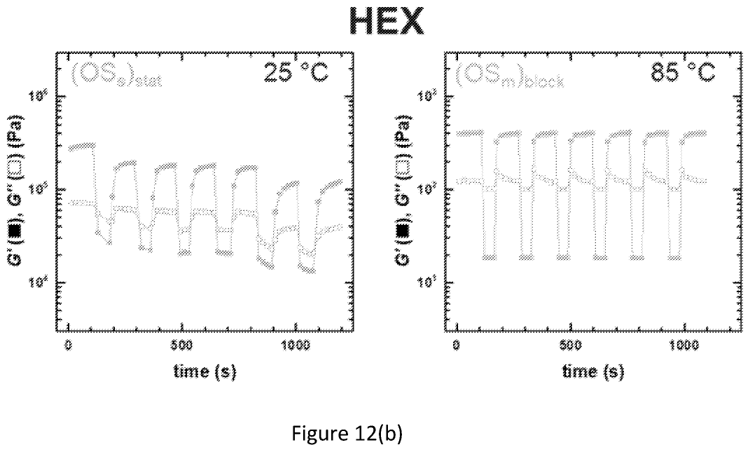

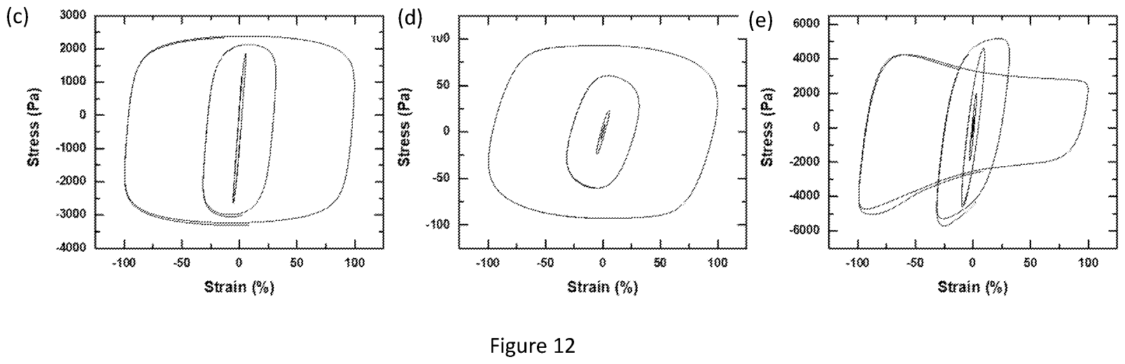

The reversibility of yielding is another important material property that was probed by cyclic dynamic time sweeps. In FIG. 12a, all sphere-forming BCC polymers (statistical bottlebrush and linear diblock) show highly reversible and fast solid-liquid phase transitions, which complete within the 12 s data collection step time of our rheometer. Notably, this highly reversible yielding occurs regardless of whether the core is glassy core ((LSₘ)ₛₜₐₜ) or soft (OSₘ and (OSₘ)ₛₜₐₜ). Such facile reversibility that is independent of these chain architectures implies the yielding process only temporarily disorders the BCC lattice by displacing, rather than disassembling spherical micelles.² In contrast, the (OSₛ)ₛₜₐₜ bottlebrush that forms HEX shows a continuous decrease in G′ and G″ during multiple cycles of shearing across the yield stress, suggesting a gradual alignment of cylinders. This behavior is evidently not universal to the HEX morphology, as the (OSₘ)_{block} bottlebrush shows complete recovery after prolonged exposure to large amplitude oscillatory shear (FIG. 12b). We rationalize this difference between HEX-forming (OSₛ)ₛₜₐₜ and (OSₘ)_{block} by the dimensions of cylindrical micelles. The core radius of (OSₛ)ₛₜₐₜ is controlled only by the side-chain degree of polymerization (N_{A}), while both N_{A} and the backbone length (N_{BB}) contribute in the case of (OSₘ)_{block}. The diblock bottlebrush architecture studied here therefore produces self-assembled cylinders with a larger core (smaller aspect ratio) than the statistical bottlebrushes, thus reducing the extent of shear alignment. This is further supported by the shape difference of Lissajous curves in FIG. 12c.

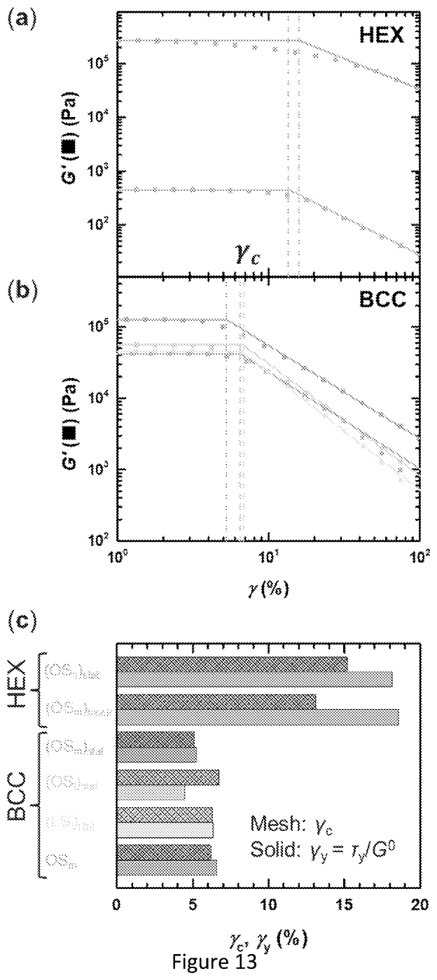

Another key difference in the yielding behavior of BCC and HEX morphologies lies in either the critical or yield strain. The critical strain (γ_{c}) is defined as the onset strain where the lattice becomes temporarily displaced by oscillatory shear, whereas the yield strain (γ_{y}) is simply determined as the ratio of yield stress over structural modulus (i.e., γ_{y}=τ_{y}/G⁰). Specifically, ye can be estimated by extrapolating the strain-amplitude-dependence of G′ in the linear and nonlinear regions; the intersection of these lines is defined as the ye and represents the onset of mechanical disordering as shown in FIGS. 13a and 13b. Much larger critical and yield strains are observed with HEX (>10%) compared to BCC (<10%), both of which are rather insensitive to the chain architectures and domain spacings as shown in FIG. 13c. This apparent difference in ye depending on morphology irrespective of architecture and chemistry is consistent with theoretical predictions of single crystals. According to Frenkel's model³⁷ of the stress required for a layer of particles to hop, the yield/critical strain should only depend on the lattice structure—γ_{y,theo}=τ_{y}/G=b/(2πa), where b is magnitude of the Burgers vector and a is the lattice constant. For a BCC lattice, the Burgers vector lies on the closest-packed crystallographic planes {110} along the (111) family of directions with a magnitude b=\sqrt{3}/2a.³⁸ For hexagonally close-packed cylinders (HEX) which tile a two-dimensional p6 mm net the Burgers vector is coincident with the a basis vector, i.e., b=a. Furthermore, we expect a cylindrical morphology to have more complex behavior at the domain boundaries, which may involve orientational rearrangement of the cylinders prior to the macroscopic yielding. These theoretical arguments suggest the yield strain should be larger for HEX (γ_{y,theo,HEX}=0.16) than BCC (γ_{y,theo,BCC}=0.13), in qualitative agreement with our experimental finding (γ_{y,HEX}=0.18-0.19 and γ_{y,BCC}=0.05-0.07). Note that Frenkel model³⁷ assumes that atoms slip along the Burgers vector b within a crystal domain not at domain boundaries, so the critical/yield strain can be very different depending on where yielding occurs in the multidomain HEX.

e. Correlations Among Structural Modulus, Yield Stress and Inter-Micelle Distance

The use of these BCC- or HEX-forming polymers in practical applications necessitates understanding the connection between structural modulus (G⁰), yield stress (τ_{y}), and morphology (inter-micelle distance, d). All the structural and yielding parameters are summarized in Table 4. For linear block copolymers, the structural modulus for BCC spheres typically scales as G⁰˜d⁻³ with the exponent varying between −2.7 and −3.5.^{1,4,36,39,40} Theoretically, a weaker dependence is expected for HEX cylinders due to a smaller degree of confinement than cubic.^{41,42} Indeed, our linear and bottlebrush samples with both BCC and HEX morphology follows a slightly weaker power-law dependence (G⁰/RT=1.31×10⁴ d^{-2.6} mol/m³) (FIG. 14A). This best-fit line, which covers a wide range of inter-micelle distance, also appears to describe previously reported literature data quite well, implying a universal scaling between structural modulus and inter-micelle distance irrespective of morphology, chemistry, and architecture. A 95% confidence band is also plotted by including all the data in FIG. 14A in the fit. But keep in mind that only HEX-forming bottlebrushes (no linear block copolymers) show a well-defined structural modulus in the plateau region (FIG. 8b). So, we speculate that diffusion of bottlebrush polymer is inherently restricted due to the unique architecture in the microphase separated state (see FIG. 6), thus delaying the defect-mediated flow and superseding the additional geometry confinement imposed by either BCC or HEX lattices.

Furthermore, because structural modulus depends on inter-micelle potential,^{1,2} which is related to the segregation strength, further refinement of the model that accounts for the extent of supercooling below T_{ODT}¹ and aggregation number per micelle³⁹ may be possible. FIG. 14B shows that our data, including the linear PEO-block-PDMS polymer, do not follow the T_{ODT}—dimensionless structural modulus dependence proposed by Register and coworkers¹ for various BCC-forming linear block copolymers. FIG. 14C examines the potential role of aggregation number (Z) on the inter-micelle potential by comparing our data with the work done by Buitenhuis et al. 4, Witten, and Pincus³⁹. A prefactor of Z^{3/2} is proposed to improve the G⁰−d correlation for the BCC-forming linear block copolymers. But for the case of statistical bottlebrushes, the number of corona chains per micelle (N_{C}) differs from Z by factors of N_{BB} and molar fraction of corona (m_{B}). (See details in the Supporting Information and Table 5). In FIG. 14C, our BCC-forming polymers appear to follow a similar scaling as other linear blocks, suggesting self-assembled micelles can be treated as colloid particles grafted with polymers irrespective of architecture and core softness.

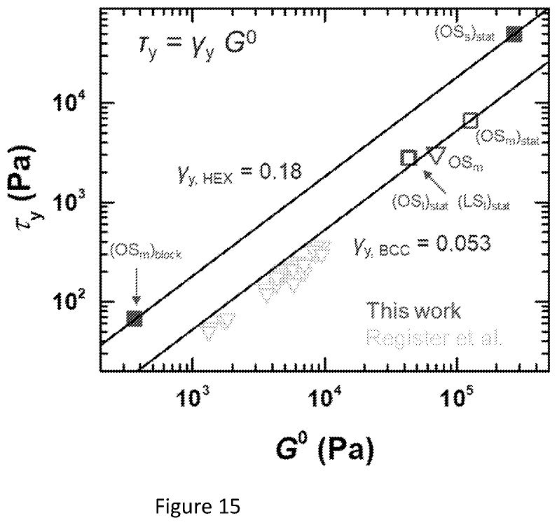

FIG. 15 shows the correlation between structural modulus (G⁰) and yield stress (τ_{y}) for our polymers with different morphology, architecture, and side-chain chemistry. By restricting the exponent to one, the yield strain (γ_{y}) can be extracted as the prefactor of the fit line (i.e., τ_{y}=γ_{y} G⁰), which differs between BCC- and HEX-forming polymers with different architectures and side-chain chemistries. Our value of γ_{y,BCC} (0.052) agrees reasonably well with those of linear diblock copolymers on cubic lattices (0.02-0.06⁴³ and 0.0381), despite different methods determining the yield stress and yield strain. In comparison, a much larger but nearly identical γ_{y,HEX} (0.18) for both (OSₘ)_{block} and (OSₛ)ₛₜₐₜ confirms the nature of HEX-forming bottlebrushes and the role of morphology on yielding. Additionally, among the BCC-forming polymers, linear diblock, OSₘ, follows the same τ_{y}−G⁰ correlation as bottlebrushes ((OSₘ)ₛₜₐₜ, (LSₗ)ₛₜₐₜ, and (OSₗ)ₛₜₐₜ), despite their difference in defect-mediated flow (FIG. 8). This implies that stress can activate dormant defects in bottlebrushes to facilitate plastic deformation by slipping along the Burgers vector b, resulting in a similar yielding transition as that of a linear diblock. As a result, coherent slipping of entire planes of micelles is also extremely unlikely for soft ordered solid,³⁸ due to the suppressed defect movements in bottlebrush polymers. In addition to τ_{y} and G°, other design criteria such as solid-liquid reversibility, rate dependence, and long-term shape retainability could further distinguish the different samples studied herein, as discussed before.

In this comparative study, we have systematically studied the influence of chain architecture, building block chemistry, and self-assembled morphology on the rheology of linear and bottlebrush copolymers. The linear viscoelastic response of statistical bottlebrush copolymers that self-assemble into BCC spheres displays no signs of defect-mediated flow even at low frequencies. In contrast, both statistical and blocky bottlebrush copolymers that adopt the HEX phase exhibit a stronger frequency-dependent linear response with a slanted plateau region followed by the characteristic slope of ⅓ at low frequency. All BCC-forming polymers undergo a yielding transition that is significantly sharper and more reversible than found with HEX, perhaps resulting from a certain extent of cylinder alignment along the flow direction. BCC samples also exhibit a smaller critical strain to disorder the lattice for all linear and bottlebrush samples studied. The normalized structural modulus (G⁰/RT) is mainly controlled by the inter-micelle distance (d) irrespective of molecular architecture and morphology, possibly due to the equally confined bottlebrush architecture in both BCC and HEX lattices. The number of corona chains per micelle rather than the core softness also plays a similar role in determining the inter-micelle potential for both BCC-forming linear diblocks and bottlebrushes. Additionally, the correlation between yield stress (τ_{y}) and structural modulus (G⁰) remains insensitive to architecture but exhibits a smaller yield strain (γ_{y}=τ_{y}/G⁰) for BCC than HEX. The γ_{y,BCC} in this work also agrees well with other reports of BCC-forming linear blocks. This similarity in yielding for all BCC-forming polymers suggests a similar stress-activated defect movement, despite the differences in architecture and defect-mediated linear response. Overall, this work provides a guideline to control the yield stress over a broad range of values (as demonstrated: 0.067-49 kPa) using molecular architecture and morphology to manipulate the lattice parameter and corresponding micelle spacing. Collectively, these findings reveal the quantitative impact of molecular design on the macroscopic yielding transition under processing conditions that are relevant in contemporary applications.

### 5. Example: Yield-Stress Fluid and Printing Behaviors of Bottlebrush Statistical Copolymers with Broad Dispersity Arising from Either the Sidechain or the Backbone

In order to ascertain the role PDI in controlling the yield-stress fluid like properties of PEO-PDMS statistical copolymers, we synthesized a series of materials of relatively higher PDI. Using either 10 kDa, 5 kDa or 1 kDa PDMS macromonomer and a short PEG macromonomer (750 Da); we performed ROMP at higher concentrations (200 mg mL⁻¹) than usual (50 mg mL⁻¹). With the target to produce statistical copolymers with variable volume-fraction of PEO; we did three set of reactions for each separate PDMS macromonomer. Although the higher concentration of the reactions was effective in producing higher PDI (Ð>2.0) samples when using 10 kDa or 5 kDa PDMS macromonomers, it produced narrowly dispersed samples while using 1 kDa PDMS macromonomer. This is probably due to the relatively lower viscosity of bottlebrush solutions with short PDMS side-chains. To resolve this issue, a method of ‘slow-addition’ of G3 catalyst to increase the PDI of short PDMS based bottlebrush polymers can be used. Nonetheless, it is demonstrated that the reactions at higher concentrations can be very effective in synthesizing certain PDMS-PEO statistical copolymers (e.g. 5 kDa or 10 kDa PDMS side-chains) having higher PDI. Visual inspection suggests that these materials, although having higher PDI, retain their yield-stress fluid like behavior (FIG. 18). Parameters of some of the high PDI statistical bottlebrush copolymers are summarized in Table 6 (Same N_{SC,PEO}=10)

TABLE 6

| Sample | M_{SC, PDMS} | | | Mₙ | | T_{ODT} |
|---|---|---|---|---|---|---|
| Code | (kDa) | f_{PEO} | N_{BB} | (kDa) | Ð | (° C.) |
| 5-1.1 | 5 | 0.044 | 152 | 626 | 1.08 | 68 |
| 5-2.3 | 5 | 0.035 | 116 | 497 | 2.25 | 44 |
| 5-2.5 | 5 | 0.052 | 99 | 391 | 2.54 | 73 |
| 5-2.8 | 5 | 0.086 | 82 | 281 | 2.76 | 85 |
| 10-1.1 | 10 | 0.042 | 111 | 723 | 1.07 | 83 |
| 10-2.0 | 10 | 0.035 | 73 | 508 | 1.99 | 48 |
| 10-2.6 | 10 | 0.052 | 68 | 413 | 2.58 | 85 |

FIG. 19b shows the yield-stress fluid behavior and the order-to-disorder transition for the series of high-dispersity bottlebrush statistical polymers (FIG. 18). For the statistical bottlebrushes prepared from 5 kDa PDMS macromonomers, the yielding transition is nearly identical between a narrowly dispersed sample (Ð=1.1) and a broadly dispersed sample (Ð=2.5 or 2.8), as long as the extent of supercooling below T_{ODT} is above 30° C. On the other hand, a statistical bottlebrush prepared from 10 kDa PDMS macromonomers (Ð=2.6) interestingly shows a significantly smaller yield stress than that of a narrowly dispersed sample (Ð=1.1), despite its higher T_{ODT} due to a higher PEO volume fraction. This nontrivial role of side-chain length (N_{SC}) in determining the effect of N_{BB} dispersity on the yielding transition implies a complicated picture for the self-assembly and mechanical disordering process of a statistical bottlebrush.

We demonstrated the excellent printability of a sample with broad molar mass dispersity (i.e., PEO-stat-PDMS bottlebrush with N_{SC,PEO}=10, N_{SC,PDMS}=136, and Ð=2.5), as evidenced by 3D printing an ear at high speed (i.e., 500 mm/min, FIG. 19a). The ear's overall shape is well captured, but future improvements may be possible by printing a thinner layer (i.e., 0.120 mm instead of 0.322 mm). The polymer showed similar yield-stress performance as that of low-dispersity bottlebrush statistical copolymers (FIG. 16). Although substantial relaxation below 1.0 rad/s is observed due to the presence of a broad spectrum of relaxation times for different N_{BB}, the yielding transition (yield stress=2.3 kPa) still remains quite sharp.

### 6. Example Optimization of Print Parameters (Print Speed and Layer Height)

By printing a set of line patterns with different speeds and layer heights, we can identify optimal print conditions. FIG. 17 shows overall good print quality (continuous line segments without breaking) for all tested speeds (50-600 mm/min) and layer heights (0.280-0.363 mm using a 22 G nozzle with inner diameter of 0.410 mm). Note that in this example, rounded corners start to appear at print speed of 150 mm/min and layer height of 0.363 mm, so the layer height should be set at 0.321 mm or lower when using a nozzle (e.g., 22 G nozzle).

### 7. Materials and Methods Used for the Examples Described Herein

a. Materials

Norbornene-terminated macromonomers of poly(ethylene oxide) (PEO) and poly(dimethyl siloxane) (PDMS) were synthesized as previously described^{18,19}. Subsequent grafting-through copolymerization was performed from either a mixture of PEO and PDMS macromonomers or sequentially using ring-opening metathesis polymerization (ROMP) to form statistical and diblock bottlebrush polymers, respectively. For all samples, good control over molar mass dispersity (Ð<1.2) was achieved (see Table 1 and Supporting Information). All PEO-PDMS bottlebrush polymers studied herein have a constant PEO side-chain degree of polymerization (N_{SC,PEO}=10); in contrast, the PDMS side-chain length was selected from N_{SC}=14, 68, or 136. The total number of PEO and PDMS repeat units was varied to control the backbone degree of polymerization (N_{BB}), in all cases maintaining a minority volume fraction of PEO (f_{PEO}=0.04-0.12). Similarly, a statistical bottlebrush copolymer with poly(lactide) (PLA) and PDMS side chains was synthesized by ROMP from a mixture of norbornene-terminated PLA and PDMS macromonomers. The synthesis of PLA macromonomer was reported elsewhere.²⁰ One linear diblock copolymer, namely poly(ethylene oxide)-block-poly(dimethylsiloxane) (PEO-b-PDMS), was also synthesized using literature procedures.^{11,21}

N-(hexanoic acid)-cis-5-norbornene-exo-dicarboximide was prepared according to literature.¹ Grubbs' second-generation metathesis catalyst [(H₂IMes)(PCy₃)(Cl)₂Ru═CHPh] was generously provided by Materia. Grubbs' third-generation metathesis catalyst [(H₂IMes)(pyr)₂(Cl)₂Ru═CHPh] (G3) was prepared according to literature.² Methanol (Fisher Scientific—A412; purity >99.8%), dichloromethane (Fisher Scientific—D37, purity >99.5%), toluene (Fisher Scientific—T324-500, purity >99.5%) triethylamine (Fisher Scientific, ACROS Organics, AC15791, purity >99%), and ethyl vinyl ether (Fisher Scientific, ACROS Organics, AC119082500, purity >99%) were used as received. CDCl₃ (99.8%) was purchased from Cambridge Isotope Laboratories (DLM7) and used as received. Bis(hydroxyalkyl)-terminated PDMS (Sigma—481246), hydroxyalkyl-terminated PDMS (Gelest—MCR C12, MCR C18 and MCR C22), polyethylene glycol monomethyl ether 550 (TCI—P2184), succinic anhydride (Sigma—239690, purity >99%) 4-benzoylbenzoic acid (Sigma—B12407, purity 99%), N,N-dimethylamino pyridine (Alfa Aesar, H51715, purity 99%) and EDC (Oakwood chemical-024810, purity 99%) were used as received.

### Synthesis of PEO Macromonomer

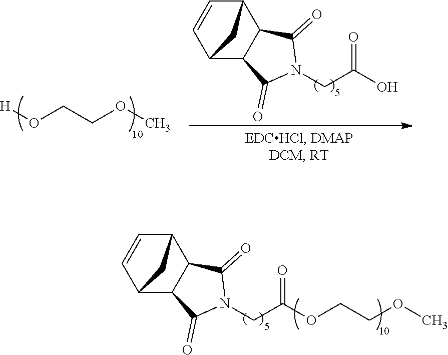

In a round-bottom flask, a mixture of ‘poly(ethylene oxide) mono methyl ether’ (550 Da, 2.75 g, 5 mmol), N-(hexanoic acid)-cis-5-norbornene-exo-dicarboximide (1.525 g, 5.5 mmol), DMAP (152 mg, 1.25 mmol), and EDC·HCl (1.44 g, 7.5 mmol) in DCM (100 mL) was stirred for 48 hours. The reaction mixture was washed with dilute HCl (1 M) and repeatedly washed with water, followed by drying over anhydrous MgSO₄. The solution was passed through a plug of activated basic alumina and evaporated to dryness to obtain the desired compound as a colorless liquid. Yield: 3.0 g (74%). ¹H NMR (600 MHz, Chloroform-d) δ 6.12 (s, 2H), 4.07-3.98 (m, 2H), 3.61-3.39 (m, 50H), 3.39-3.32 (m, 2H), 3.27 (t, J=7.3 Hz, 2H), 3.19 (d, J=2.0 Hz, 3H), 3.08 (s, 2H), 2.50 (s, 2H), 2.14 (t, J=7.4 Hz, 2H), 1.46 (p, J=7.4 Hz, 2H), 1.39 (p, J=7.5 Hz, 2H), 1.33 (d, J=9.8 Hz, 1H), 1.15 (p, J=7.7 Hz, 2H), 1.04 (d, J=9.8 Hz, 1H). HRMS: m/z calculated for n=9, i.e. C₃₄H₅₇N₁O₁₃Na: 710.3727 [M+Na]⁺; found: 710.3736.

Synthesis of PDMS Macromonomers

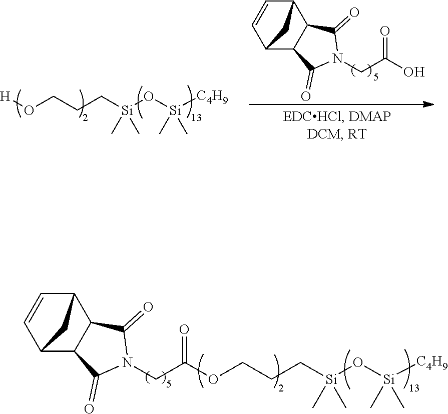

N_{SC}=14; Mₙ=1.25 kDa—In a round-bottom flask, a mixture of mono-hydroxy 1 kDa PDMS (10.9 g, 10.9 mmol), N-(hexanoic acid)-cis-5-norbornene-exo-dicarboximide (7.53 g, 27.2 mmol), DMAP (663 mg, 5.43 mmol), and EDC·HCl (7.3 g, 38.0 mmol) in DCM (250 mL) was stirred for 48 hours. The reaction mixture was washed with dilute HCl (1 M) and repeatedly washed with water, followed by drying over anhydrous MgSO₄. The solution was passed through a plug of activated basic alumina and evaporated to dryness to obtain the desired macromonomer as a transparent colorless liquid. Yield: 10.0 g (75%). ¹H NMR (600 MHz, Chloroform-d) δ 6.26 (t, J=1.9 Hz, 2H), 4.21-4.17 (m, 2H), 3.61-3.57 (m, 2H), 3.46-3.42 (m, 2H), 3.40 (t, J=7.0 Hz, 2H), 3.25 (p, J=1.7 Hz, 2H), 2.65 (d, J=1.3 Hz, 2H), 2.31 (t, J=7.5 Hz, 2H), 1.66-1.52 (m, 6H), 1.51-1.47 (m, 1H), 1.34-1.25 (m, 6H), 0.87 (d, J=7.0 Hz, 2H), 0.54-0.49 (m, 4H), 0.12-−0.00 (m, 80H).

N_{SC}=68; Mₙ=5.25 kDa—In a round-bottom flask, a mixture of mono-hydroxy 5 kDa PDMS (54.5 g, 10.9 mmol), N-(hexanoic acid)-cis-5-norbornene-exo-dicarboximide (7.53 g, 27.2 mmol), DMAP (663 mg, 5.43 mmol), and EDC·HCl (7.3 g, 38.0 mmol) in DCM (250 mL) was stirred for 48 hours. The reaction mixture was washed with dilute HCl (1 M) and repeatedly washed with water, followed by drying over anhydrous MgSO₄. The solution was passed through a plug of activated basic alumina and evaporated to dryness to obtain the desired macromonomer as a transparent colorless liquid. Yield: 50.1 g (88%). ¹H NMR (600 MHz, Chloroform-d) δ 6.28 (t, J=1.8 Hz, 2H), 4.22-4.19 (m, 2H), 3.48-3.44 (m, 2H), 3.42 (t, J=7.1 Hz, 2H), 3.27 (s, 2H), 2.67 (s, 2H), 2.33 (t, J=7.5 Hz, 2H), 1.62 (ddt, J=34.6, 15.2, 7.6 Hz, 8H), 1.51 (d, J=9.8 Hz, 2H), 1.36-1.26 (m, 6H), 1.21 (d, J=9.9 Hz, 2H), 0.88 (t, J=7.0 Hz, 4H), 0.57-0.49 (m, 4H), 0.07 (s, 400H).

N_{SC}=136; Mₙ=10.25 kDa—In a round-bottom flask, a mixture of mono-hydroxy 10 kDa PDMS (50.0 g, 5 mmol), N-(hexanoic acid)-cis-5-norbornene-exo-dicarboximide (3.75 g, 13.6 mmol), DMAP (330 mg, 2.7 mmol), and EDC·HCl (3.7 g, 19.3 mmol) in DCM (250 mL) was stirred for 48 hours. The reaction mixture was washed with dilute HCl (1 M) and repeatedly washed with water, followed by drying over anhydrous MgSO₄. The solution was passed through a thin plug of activated basic alumina and evaporated to dryness to obtain the desired macromonomer as a transparent colorless liquid. Yield: 40.0 g (78%). ¹H NMR (600 MHz, Chloroform-d) δ 6.28 (t, J=1.8 Hz, 2H), 4.22-4.19 (m, 2H), 3.48-3.44 (m, 2H), 3.42 (t, J=7.1 Hz, 2H), 3.27 (s, 2H), 2.67 (s, 2H), 2.33 (t, J=7.5 Hz, 2H), 1.62 (ddt, J=34.6, 15.2, 7.6 Hz, 8H), 1.51 (d, J=9.8 Hz, 2H), 1.36-1.26 (m, 6H), 1.21 (d, J=9.9 Hz, 2H), 0.88 (t, J=7.0 Hz, 4H), 0.57-0.49 (m, 4H), 0.07 (s, 810H).

Synthesis of PDMS-PEO statistical bottlebrushes—(OSₛ)ₛₜₐₜ, (OSₘ)ₛₜₐₜ, (OSₗ)ₛₜₐₜ (statistical PDMS-PEO bottlebrush copolymers listed in table 1, 2, 4, 5 and 6).

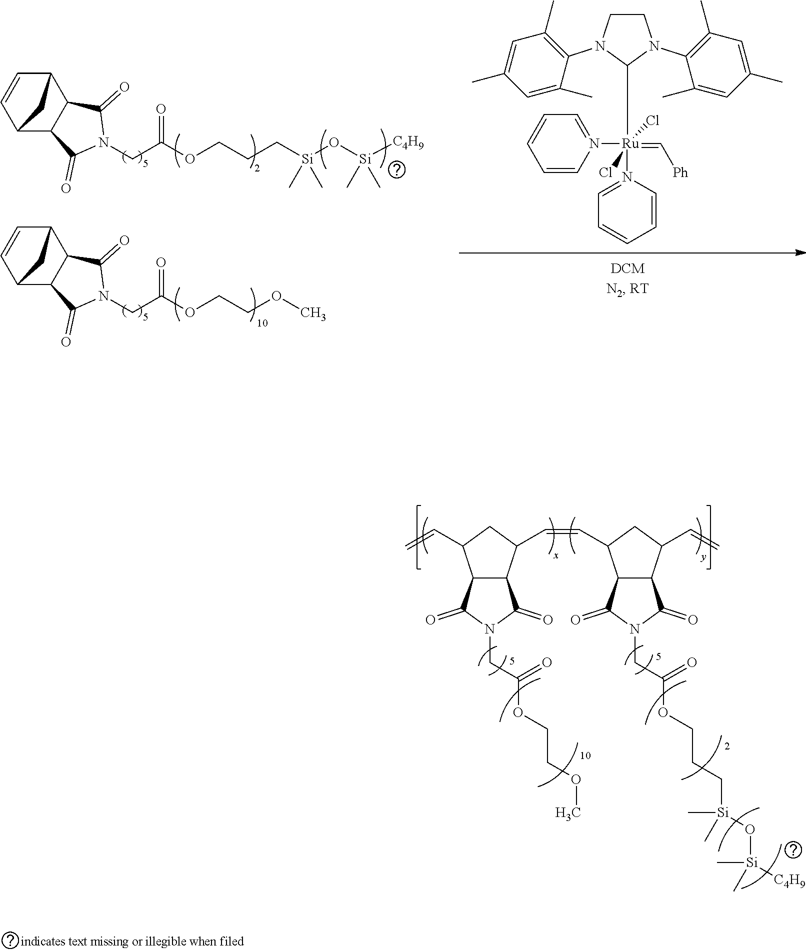

(N_{bb} is omitted in the copolymer structure)

Polymerizations of the macromonomer mixtures using G3 catalyst were performed in dilute solutions of the macromonomer (0.02 g mL⁻¹) in dry DCM. Catalyst was injected as a dilute solution in dry DCM (e.g., 500 μL of 8 mg mL⁻¹) and the equivalents relative to macromonomer varied depending on the target backbone degree of polymerization (N_{BB}). Polymerizations were terminated using ethyl vinyl ether after 12 hours. The resulting reaction mixtures were concentrated using vacuum evaporation and the polymers were precipitated in methanol. After two more consecutive precipitation of the polymers in methanol, the bottlebrush polymers were collected and dried under vacuum.

Synthesis of PDMS-PEO Block Bottlebrush—(OSₘ)_{block}

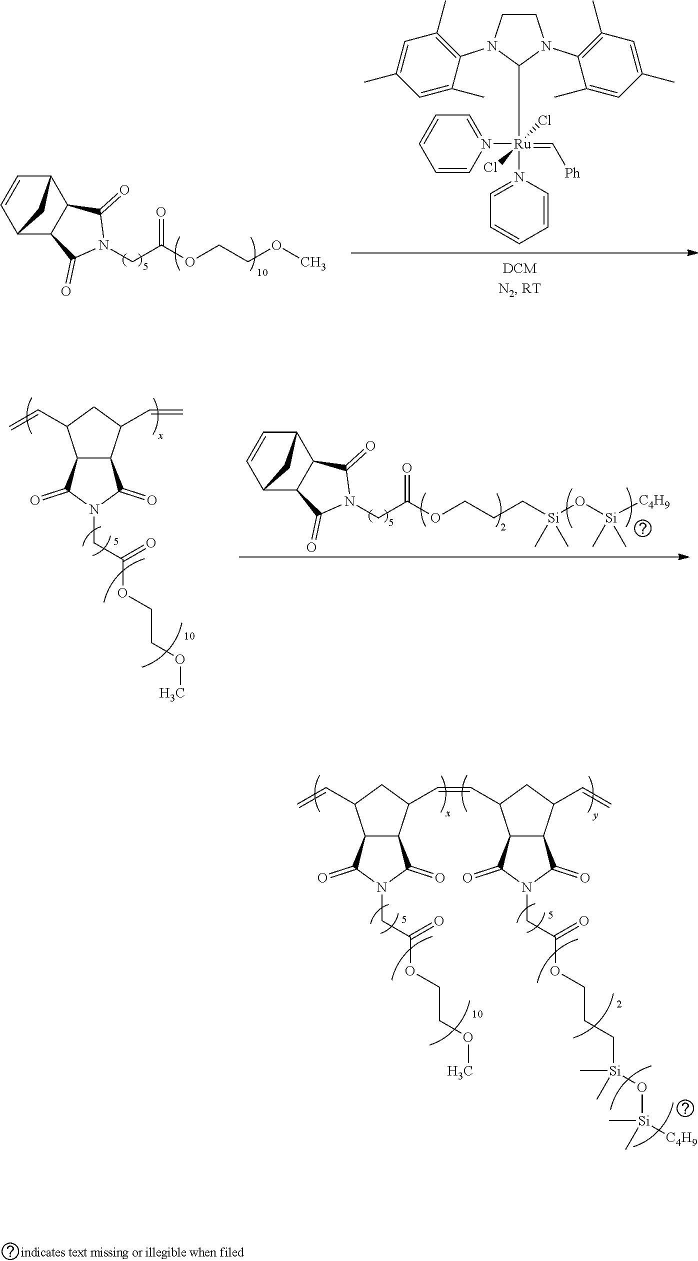

In a nitrogen glovebox, a reaction flask charged with a stir bar, 550 PEO Macromonomer (46 mg, 0.061 mmol, 48.7 eq) was dissolved in 1.2 ml of dry DCM. Then 0.18 ml of Grubbs third generation catalyst stock solution in DCM was added (5 mg/ml, 1.26 μmol, 1.0 eq). The reaction was allowed to stir for 15 minutes. Then 22.8 ml of a stock solution of PDMS 5 kDa Macromonomer in DCM (42 mg/ml, 954 mg, 0.191 mmol, 151.3 eq) was added. The reaction was allowed to stir overnight and then quenched with several drops of ethyl vinyl ether. The reaction volume was reduced by half and precipitated into cold methanol and dried in vacuo.

¹H NMR (600 MHz, Chloroform-d) δ 5.64 (d, J=150.2 Hz, 2H), 4.20 (d, J=6.1 Hz, 3H), 3.72-3.50 (m, 16H), 3.50-3.36 (m, 4H), 2.32 (s, 3H), 1.79-1.44 (m, 19H), 1.30 (tdd, J=9.2, 7.8, 6.3, 4.5 Hz, 7H), 0.88 (t, J=6.8 Hz, 3H), 0.52 (q, J=8.6 Hz, 4H), 0.07 (s, 410H).

Synthesis of PEO-COOH

To a round bottom flask charged with a star bar was added poly(ethylene oxide) mono methyl ether (550 Da, 2.0 g, 3.63 mmol, 1.0 eq) succinic anhydride (0.44 gr, 4.36 mmol, 1.2 eq), and triethylamine (0.44 gr, 0.61 ml, 4.36 mmol, 1.2 eq). 25 ml of toluene was added and the solution was refluxed overnight. The toluene was removed in vacuo and then redissolved in DCM. It was then washed with 1N HCl, twice with water, and once with brine. After drying over MgSO₄ the solvent was removed in vacuo.

¹H NMR (600 MHz, Methylene Chloride-d₂) δ 4.27-4.17 (m, 2H), 3.79-3.45 (m, 50H), 3.35 (s, 3H), 2.68-2.54 (m, 4H).

Synthesis of PDMS-PEO Linear Diblock—OSₘ

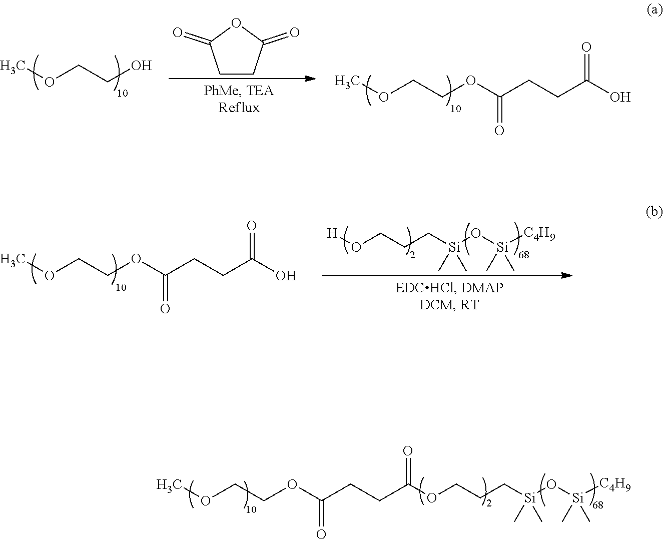

To a round bottom flask charged with a star bar was added poly(ethylene oxide) mono methyl ether (550 Da, 2.0 g, 3.63 mmol, 1.0 eq) succinic anhydride (0.44 gr, 4.36 mmol, 1.2 eq), and triethylamine (0.44 gr, 0.61 ml, 4.36 mmol, 1.2 eq). 25 ml of toluene was added and the solution was refluxed overnight. The toluene was removed in vacuo and then redissolved in DCM. It was then washed with 1N HCl, twice with water, and once with brine. After drying over MgSO₄ the solvent was removed in vacuo, and the PEO-COOH was obtained as a colorless liquid. Yield 2.1 g (90%). ¹H NMR (600 MHz, Methylene Chloride-d₂) δ 4.27-4.17 (m, 2H), 3.79-3.45 (m, 50H), 3.35 (s, 3H), 2.68-2.54 (m, 4H).

To a solution of monocarbinol terminated polydimethylsiloxane (PDMS) (5 kDa, 4.76 g, 0.95 mmol, 1.0 eq) in DCM (50 mL) was added PEO—COOH (550 Da, 0.55 g, 1 mmol, 1.05 eq), 1-ethyl-3-(3-dimethylaminopropyl)carbodiimide (EDC) (0.37 g, 2.38 mmol, 2.5 eq), and 4-dimethylaminopyridine (DMAP) (116 mg, 0.95 mmol, 1.0 eq) at room temperature. After 48 hours, the reaction was washed with 3×75 ml 1 M HCl, brine, dried over MgSO₄, and then filtered through a plug of basic alumina.

¹H NMR (600 MHz, Chloroform-d) δ 4.30-4.15 (m, 4H), 3.82-3.40 (m, 53H), 3.38 (s, 3H), 2.69-2.62 (m, 4H), 1.67 (s, 3H), 1.64-1.57 (m, 3H), 1.38-1.23 (m, 6H), 0.88 (t, J=7.0 Hz, 4H), 0.62-0.44 (m, 6H), 0.07 (s, 559H).

Synthesis of PDMS-PLA Statistical Bottlebrush—(LSₗ)ₛₜₐₜ

In a nitrogen glovebox, a reaction flask charged with a stir bar, PDMS 10 kDa macromonomer (952 mg, 0.095 mmol, 70.4 eq) and 1.2 kDa PLA macromonomer³ (48 mg, 0.040 mmol, 29.6 eq) were dissolved in 25 ml of dry DCM. Then 0.20 ml of Grubbs third generation catalyst stock solution in DCM was added (5 mg/ml, 1.35 μmol, 1.0 eq. The reaction was allowed to stir overnight and then quenched with several drops of ethyl vinyl ether. The reaction volume was reduced by half and precipitated into cold methanol and dried in vacuo.

¹H NMR (600 MHz, Chloroform-d) δ 5.77 (s, 3H), 5.18 (d, J=35.4 Hz, 8H), 4.35 (s, 1H), 4.20 (s, 3H), 3.61 (s, 3H), 3.42 (s, 5H), 2.86 (d, J=190.5 Hz, 5H), 2.33 (s, 1H), 1.56 (s, 70H), 1.26 (d, J=64.5 Hz, 12H), 0.88 (s, 8H), 0.53 (s, 5H), 0.07 (s, 1299H).

In some embodiments, Statistical copolymers of PEO and PDMS bottlebrushes in this work are represented by “x_{PDMS}S_{N}_{_{SC,PDMS}}^{N}^{_{BB}}”, which can be followed by “−n_{cl}” indicating the number of PDMSbisBP crosslinkers added per bottlebrush polymer. The absolute number-average molecular weights (Ma), dispersity (D) and the refractive index increment (dn/dc) of all bottlebrush copolymers are determined by SEC-MALS assuming 100% mass recovery in Figure S12 and S13 of Appendix B in ref. 53. The mole fraction of PDMS macromonomer (x_{PDMS}) and the volume fraction of PEO macromonomer (f_{PEO}) for each copolymer is calculated by comparing the integrated ¹H NMR peaks. Then, the degree of polymerization of the backbone (N_{BB}) can be calculated based on the side chain lengths; the PDMS side chain (N_{SC,PDMS}) is 14 (or 1 kDa) or 68 (or 5 kDa) or 136 (or 10 kDa), while that of the PEO side chain (N_{SC,PEO}=10) is held constant.

TABLE 3
Molecular characterizations for the poorly-ordered
bottlebrush diblock copolymers of PEO and PDMS.

| | | | | | Mₙ | |
|---|---|---|---|---|---|---|
| ID | N_{A} | N_{B} | f_{PEO} | N_{BB} | (kDa) | Ð |
| (OSₘ)_{block, 1} | 10 | 68 | 0.053 | 182 | 714 | 1.06 |
| (OSₘ)_{block, 2} | 10 | 68 | 0.039 | 193 | 813 | 1.09 |
| (OSₛ)_{block, 1} | 10 | 14 | 0.12 | 168 | 197 | 1.06 |
| (OSₛ)_{block, 2} | 10 | 14 | 0.068 | 134 | 161 | 1.07 |

TABLE 4
Structural and rheological parameters of the copolymers studied herein.

| | | d* | d | a | b | G⁰ | τ_{y} | γ_{y} | γ_{c} |
|---|---|---|---|---|---|---|---|---|---|
| ID^{a} | Phase | (nm) | (nm) | (nm) | (nm) | (Pa) | (Pa) | (%) | (%) |
| (OSₘ)_{block} | HEX | 67.6 | 78.1 | 78.1 | 78.1 | 363 | 67 | 18.6 | 13.1 |
| (OSₗ)ₛₜₐₜ | BCC | 9.6 | 11.8 | 13.6 | 11.8 | 42600 | 2800 | 6.6 | 6.2 |
| (OSₘ)ₛₜₐₜ | BCC | 7.4 | 9.1 | 10.5 | 9.1 | 127000 | 6600 | 5.2 | 5.1 |
| (OSₛ)ₛₜₐₜ | HEX | 4.4 | 5.1 | 5.1 | 5.1 | 272000 | 49300 | 18.1 | 15.2 |
| (LSₗ)ₛₜₐₜ | BCC | 12.2 | 15.0 | 17.3 | 15.0 | 44000 | 2800 | 6.4 | 6.7 |
| OSₘ | BCC | 9.0 | 11.1 | 12.8 | 11.1 | 69800 | 3100 | 4.5 | 6.3 |

d*: characteristic domain spacing (d* = 2π/q*)
d: inter-micelle distance (d = 2/\sqrt{3} d* for HEX, d = \sqrt{2} d* for BCC)
a: lattice constant (a = d for HEX, a = \sqrt{6}/2 d* for BCC)
b: magnitude of Burgers vector (b = a for HEX, b = \sqrt{3}/2 a for BCC)
G⁰: structural modulus (G⁰ = G′ at the minimum of G″)
τ_{y}: yield stress (G′ and G″ crossover point located from the stress amplitude sweep data)
γ_{c}: critical strain (critical onset strain by extrapolating from the strain amplitude sweep data)
γ_{y}: yield strain (γ_{y} = τ_{y}/G⁰)

TABLE 5
Number of aggregated polymers per micelle and its potential
effect on the inter-micelle interaction potential
for the BCC forming polymers studied herein.

| | | Z, aggregation | N_{c}, number of | |
|---|---|---|---|---|
| | | number | corona chains | |
| ID | Phase | per micelle | per micelle | G⁰/(k_{B}T pₘ N_{c}^{3/2}) |
| (OSₘ)ₛₜₐₜ | BCC | 0.55 | 62 | 1.1 × 10¹⁴ |
| (OSₗ)ₛₜₐₜ | BCC | 1.0 | 69 | 4.0 × 10¹³ |
| (LSₗ)ₛₜₐₜ | BCC | 4.0 | 150 | 2.2 × 10¹³ |
| OSₘ | BCC | 110 | 110 | 3.9 × 10¹³ |

Methods

(i) Size Exclusion Chromatography

Size exclusion chromatography (SEC) was performed on a Waters Alliance HPLC System 2695 Separation Module equipped with two Agilent PLgel MiniMixed-D bed columns and multiangle light scattering (Wyatt DAWN HELEOS-II, 663 nm laser light) and differential refractive index (Wyatt Optilab rEX) detectors. The absolute molar mass and molar mass distribution of PEO-stat-PDMS, PEO-block-PDMS, and PLA-stat-PDMS bottlebrush copolymers and linear PEO-block-PDMS were measured in tetrahydrofuran (THF) at 30° C. Polymers were first dissolved in THF overnight with known and dilute concentrations (≤4.0 mg/mL) and then filtered through a 0.45 μm PTFE filter. The differential refractive index increment (dn/dc) was calculated by integrating the differential refractive index signal assuming 100% mass recovery. The number average molar mass (Mₙ) and molar mass dispersity (Ð) were determined by constructing a partial Zimm plot for each slice of the elution profile. The SEC elution traces for some polymers studied herein are shown in FIG. 20.

(ii) Differential Scanning Calorimetry

Differential scanning calorimetry (DSC) data were collected on a liquid-nitrogen-cooled TA Instruments Q2000 Differential Scanning Calorimeter with an indium standard calibration. The samples were measured under a nitrogen environment and in a temperature range from −150 to 150° C. at a ramp rate of 20° C. per minute with a sensitivity <0.2 μW and a baseline drift <10 μW. Each sample was run for three consecutive cycles to ensure reproducibility while erasing the thermal history prior to loading.

(iii) Small-Angle X-Ray Scattering

Room temperature small-angle X-ray scattering (SAXS) data were collected at the X-ray diffraction facility in the Materials Research Laboratory (MRL) at the University of California, Santa Barbara (UCSB) using a custom SAXS instrument. All bottlebrush polymers were sealed between Kapton tape inside a metal washer and annealed at 20 K below T_{ODT} in a vacuum oven overnight before 30 min of X-ray exposure. The instrument used a 50 micron microfocus, Cu target X-ray source (1.54 Å) with a parallel beam multilayer optics and monochromator (Genix from XENOCS SA, France), a high efficiency scatterless hybrid slits collimator developed in house,¹² and Pilatus100 k and Eiger 1M CCD (Dectris, Switzerland). The sample-to-detector distance was 1.7 m. SAXS measurements were also performed at the National Synchrotron Light Source II (NSLS-II, beamline 11-BM, Brookhaven National Laboratory) with an X-ray energy of 13.5 keV. For all SAXS experiments, a silver behenate standard was used to calibrate the scattering angles.

(iv) Linear Viscoelastic Characterization

Rheological characterization was performed on a TA instruments ARES-G2 rheometer in a nitrogen-purged oven. The sample was first preheated above its order-disorder transition temperature (T_{ODT}) to adhere to the 25-mm-diameter stainless steel parallel plates before cooling down to 25° C. for yield stress characterization. Below the yield stress, the viscoelastic response was measured from 100 to 0.1 rad/s with an oscillatory strain amplitude of 0.01, which is well within the linear region. To more quickly probe the long-time (or low frequency) behavior, stress relaxation experiments were performed with a step strain of 0.01, which should be equivalent to that of oscillatory shear in the linear viscoelastic regime. Fast Fourier transforming the stress relaxation response from the time to the frequency domain resulted in a frequency range that extended from 0.1 to 0.001 rad/s.²³ Master curves at a reference temperature of 25° C. were also constructed for the PEO-b-PDMS bottlebrush polymers between −30 and 130° C. based on time-temperature supposition. A horizontal shift factor was introduced to achieve the best overlap in tan δ. T_{ODT} values were also probed by linear viscoelastic measurements at constant frequency (1.0 rad/s) and strain amplitude (0.01) with a heating rate of 5° C./min.

(v) Yield Stress Characterization

To probe the yielding transition, multiple types of nonlinear experiments were performed, including an oscillatory shear amplitude ramp, oscillatory shear time sweeps with cyclic stresses, a steady shear rate sweep, and transient startup shear. In the oscillatory shear amplitude test, frequency was held constant at 1.0 rad/s or another specified value while the strain amplitude increased from 0.001 to 1. In the oscillatory cyclic test, the strain amplitude changed between 0.01 and 1 for 6 consecutive cycles to test the reversibility of the yielding transition. For continuous shearing mode, a 25 mm-diameter cone with a cone angle of 0.04 rad was used instead of the parallel plate geometry in order to ensure a uniform shear rate across the sample. In the transient startup shear test, stress growth was captured during the sudden increase in shear rate from 0 to 1.0 s⁻¹; the peak value of the stress overshoot can be related to the static yield stress. In steady shear, the dynamic yield stress was probed by decreasing the steady shear rate from 1.0 s⁻¹ to 0.003 s⁻¹, below which the data collection was forced to stop because of the extremely high viscosity.

Process Steps

Method of Making a Composition of Matter

FIG. 21 is a flowchart illustrating a method of making a composition of matter.

Block 2100 represents covalently bonding at least one first type of polymer (hereinafter referred to as a “first block”) to at least one second type of polymer (hereinafter referred to as a “second block”). At least one of the first block or the second block has its glass transition temperature less than or equal to 20° C.,

Block 2102 represents allowing the first type of polymer (“first block”) to microphase separate from the second type of polymer (“second block”).

Block 2104 represents the end result, a composition of matter. The composition of matter can be embodied in many ways including, but not limited to, the following examples (referring also to the figures, including FIGS. 3, 5(a), 5(b), 6(a), 17, and 19).

1. A composition of matter 520, comprising:
a yield stress fluid 522 including self-assembled copolymers 500 each including at least one first type of polymer 504 covalently bonded to at least one second type of polymer 506, wherein:
the first type of polymer (e.g., “first block”) is microphase separated from the second type of polymer (e.g., “second block”),
at least one of the first type of polymer or the second type of polymer has its glass transition temperature less than or equal to 20° C., and
the yield stress fluid 522 has a yield stress behavior at room temperature or below room temperature (e.g., at a temperature 15° C.≤T≤30° C., −50° C.≤T≤50° C., or at a temperature as low as the lowest of the glass transition temperatures of the first and second type of polymers) without addition of a solvent for the first type of polymer or the second type of polymer.

In one or more examples, a yield stress fluid having a yield stress behavior and a critical yield stress at room temperature comprises a composition of matter that changes from a more solid-like arrangement of the self-assembled copolymers to a more liquid-like arrangement of the self-assembled copolymers when a pressure greater than a critical pressure or critical yield stress is applied. In other examples, yield stress behavior is defined as traversing the order-disorder (solid-liquid) transition^{32,33} in response to shear³⁴⁻³⁶.

In one or more examples, a yield stress fluid comprises self-assembled copolymers each including more than two types of covalently bonded polymers (blocks).

In one or more examples, a yield stress fluid comprises self-assembled copolymers including covalently bonded at least one first type of polymer (block), at least one second type of polymer (block), at least one third type of polymer (block), at least one fourth type of polymer (block), at least one fifth type of polymer (block), and so on.

The copolymers can be linear copolymers, block copolymers, alternating copolymers, periodic copolymers, statistical copolymers, stereoblock copolymers, gradient copolymers, branched copolymers, graft copolymers, brush copolymers, comb copolymers, star copolymers or any combination thereof.

In one or more examples, a diblock copolymer can be either a linear polymer or a bottlebrush polymer.

2. The composition of matter of example 1, wherein:
the self-assembled copolymers comprise a block copolymer 516 or a bottlebrush copolymer 512 including the at least one first type of polymer 504 covalently bonded to the at least one second type of polymer 506.

3. The composition of matter of example 2, wherein the bottlebrush copolymer comprising a plurality of the first type of polymers 504 covalently bonded via a backbone 514 to the plurality of the second type of polymers 506. In one or more examples, the bottlebrush copolymer comprising a bottlebrush block copolymer, a bottlebrush statistical copolymer, a bottlebrush random copolymer or any combination thereof.

4. The composition of matter of example 2, wherein the block copolymer comprises one or more linear diblocks 516 each comprising one of the first types of polymer 504 connected to one of the second types of polymers 506.

5. A composition of matter, comprising:
one or more statistical bottlebrush copolymers 513 each including a plurality of first side-chains 504 and a plurality of second side-chains 506, wherein at least one of the first side-chains 504 or the second side-chains 506 has their glass transition temperature less than or equal to 20° C.

6. The composition of matter of example 5, wherein the bottlebrush copolymers comprise self-assembled copolymers 500 and the first side chains and the second side chains are microphase separated.

7. The composition of matter of any of the examples 1-4 or 6, comprising a plurality of nanostructures 500 each including one or more of the self-assembled copolymers.

8. The composition of matter of any of the examples 1-4 or 6-7, comprising a yield stress fluid 522 having a critical yield stress wherein the self-assembled copolymers 500 are arranged in a more liquid like configuration with less order when the yield stress fluid 522 experiences a stress at or above the critical yield stress at room temperature or below room temperature (or a temperature of 20° C. or below, or at a temperature of 15° C.≤T≤30° C., −50° C.≤T≤50° C., or at a temperature as low as the lowest of the glass transition temperatures of the first and second type of polymers), as compared to an arrangement of the self-assembled copolymers below the critical yield stress.

9. The composition of matter of any of the examples 1-4 or 6-7, comprising a yield stress fluid 522 having a critical yield stress, wherein the nanostructures are arranged on a lattice 524 when the yield stress fluid 522 experiences no stress or a stress below the critical yield stress.

10. The composition of matter of example 9, wherein the nanostructures are arranged on the lattice 524 having a unit cell 526 selected from a hexagonal structure, a close-packed structure, body-centered cubic spheres, face-cubic centered cubic spheres, or any unit cell associated with a Frank-Kasper phase (e.g., a sigma phase, an A15 phase, a C14 phase, a C15 phase, or a Z phase). Moreover, it is surprising and unexpected that statistical bottlebrush 513 copolymers could self-assemble into these spherical shapes.

11. The composition of matter of any of the examples 7-10, wherein the nanostructures 500 each comprise a core 600, the core including an aggregation of the second blocks (the second type of polymers 506) or the second side chains.

12. The composition of matter of any of the examples 1-11, wherein an interface 502 between the first blocks (first type of polymers 504) and the second blocks (second type of polymers 506), or the interface between the first side-chains 504 and the second side-chains 506, defines a boundary having a convex side 508 and a concave side 510.

13. The composition of matter 520 of example 12, wherein the self-assembled copolymers comprise the bottlebrush copolymers 512 each having a backbone 514 and the interface 502 comprises the backbone 514.

14. The composition of matter of examples 10 or 11, wherein:
the first blocks or first type of polymers 504 extend outwards from the convex side 508 and the second blocks or second type of polymers 506 extend inwards from the concave side 510 as to form a cluster, or
the first side-chains 504 extend outwards from the convex side 508 and the second side-chains 506 extend inwards from the concave side 510.

15. The composition of matter of example 14, wherein the first blocks (or first side-chains or first type of polymers 504) are longer and/or comprise a larger volume fraction of the self-assembled copolymers 500 as compared to the second blocks (or second side-chains or second type of polymers 506).

16. The composition of matter of example 14 or 15, wherein the first blocks (or first side-chains or first type of polymers 504) have a glass transition temperature equal to or below 20° C.

17. The composition of matter of any of the examples 1-16, wherein the first blocks (or first side-chains or first type of polymers 504) and the second blocks (or second side-chains or second type of polymers 506) have different compositions and/or dielectric constants such that the first blocks (or first side-chains or first type of polymer 504) and the second blocks (or second side-chains or second type of polymer 506) are microphase separated.

18. The composition of matter of example 17, wherein the different compositions are such that the composition of matter has a Young's modulus in a range of 1-100 kPa. In one or more examples, the composition of matter has a Young's modulus in a range of 0.5-300 kPa. In one or more examples, (OSₘ)ₛₜₐₜ and (OSₛ)ₛₜₐₜ has a modulus larger than 100 kPa.

19. The composition of matter of any of the examples 1-18, wherein the first blocks (or first side-chains or first type of polymers 504) each comprise poly(dimethylsiloxane) and the second blocks (or second side-chains or the second type of polymers 506) each comprise poly(ethylene oxide), also known as poly(ethylene glycol).

20. The composition of matter of any of the examples 1-19, wherein the self-assembled copolymers 500 comprise a general structure of:

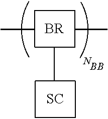

wherein BR is a backbone repeat unit, SC is a side chain covalently bonded to the backbone directly or through a linker (spacer) unit, and N_{BB} is the backbone degree of polymerization. The backbone can be a polymer selected from, but not limited to, a polynorbornene, a polyester, a polylactide, a polyether, a polysiloxane, a polyacrylate, a polymethacrylate, a polyamide, a polyacrylamide, a polyurea, a polycarbonate, a polyalkane, a polyethylene, a polypropylene, a polyisobutylene, a polyalkene, a polybutadiene, a polyisoprene, a polystyrene, or derivatives thereof, or combination thereof. The side chains each independently comprise at least one polymer selected from, but not limited to, a polyester, a polylactide, a polyether, a polysiloxane, a polyacrylate, a polymethacrylate, a polyamide, a polyacrylamide, a polyurea, a polycarbonate, a polyalkane, a polyethylene, a polypropylene, a polyisobutylene, a polyalkene, a polybutadiene, a polyisoprene, a polystyrene, or derivatives thereof, or combination thereof, or comprise the same type of polymer but with different functionality.

In one or more examples, the side chains covalently bond to the backbone to form a block copolymer, or a statistical copolymer or a random copolymer. In one or more examples, BR is a polynorbornene repeating unit.

In one or more examples, the side chain comprises a block copolymer, a statistical copolymer or a random copolymer. A specific example has a structure of.

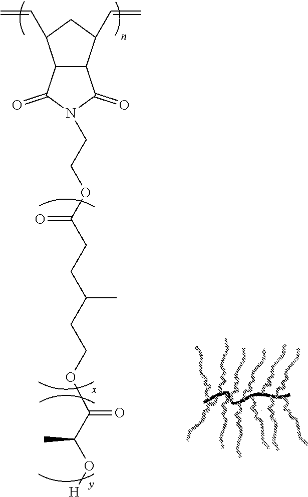

In one or more examples, the copolymer has a polydispersity in the range of 1-20, preferred in the range of 1-10, or 1-3, or 1-2, or 1-1.5.

In some examples, the self-assembled copolymers comprise a backbone having at least one structure selected from:

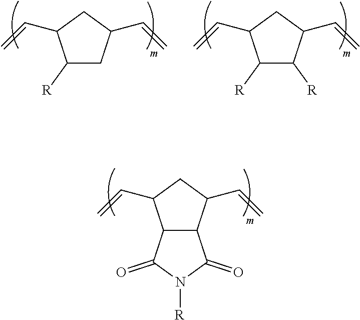

wherein m is an integer and R comprises at least one of the first block (first side-chain) or the second block (second side-chain). In one or more embodiments, the copolymers are bottlebrush copolymers and n is N_{bb}.

21. The composition of matter of any of the examples 1-20, wherein the first blocks (or first side-chains or first type of polymers 504) and the second blocks (or second side-chains or second type of polymers 506) each independently comprise at least one polymer selected from a polyester, a polylactide, a poly(ether), a poly(siloxane), a polyacrylate, a polymethacrylate, a polyamide, a polyacrylamide, a polyurea, a polycarbonate, a polyalkane, a polyethylene, a polypropylene, a polyisobutylene, a polyalkene, a polybutadiene, a polyisoprene, a polystyrene, or derivatives thereof, or wherein the first blocks (first side-chains or first type of polymers) and the second blocks (second side-chains or second type of polymers) comprise the same type of polymer but with different functionality. For example, the first blocks (second blocks) may comprise a poly(styrene) and the second blocks (first blocks) may comprise a poly(4-chlorostyrene)—these are both derivatives of poly(styrene) but they would microphase separate (self-assemble).

22. The composition of matter of any of the examples 1-19, wherein each of the first blocks (first side-chains or first type of polymers 504) have a degree of polymerization of at least 5 (but below a degree of polymerization that causes entanglement of the first type of polymers) and each of the second blocks (second side-chains or second type of polymers 506) have a degree of polymerization of at least 5 (but below a degree of polymerization that causes entanglement of the second type of polymer).

23. The composition of matter of any of the examples 2-19 or 21 wherein the bottlebrush copolymers 512 each have a general structure of:

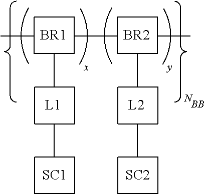

wherein BR1 and BR2 are backbone repeating units each independently selected from, but not limited to, a monomer of a norbornene, an ester, a lactide, an ether, a siloxane, an acrylate, a methacrylate, an amide, an acrylamide, a urea, a carbonate, an alkane, an ethylene, a propylene, an isobutylene, an alkene, a butadiene, an isoprene, a styrene, or derivatives thereof, or combination thereof. SC1 and SC2 are each a side chain covalently bonded to the backbone through a linker L1 or L2. The side chains SC1 and SC2 each independently comprise at least one polymer selected from, but not limited to, a polyester, a polylactide, a polyether, a polysiloxane, a polyacrylate, a polymethacrylate, a polyamide, a polyacrylamide, a polyurea, a polycarbonate, a polyalkane, a polyethylene, a polypropylene, a polyisobutylene, a polyalkene, a polybutadiene, a polyisoprene, a polystyrene, or derivatives thereof, or combination thereof, or comprise the same type of polymer but with different functionality. L1 and L2 are independently spacer or linker units which covalently bond each side chain to the backbone. L1 and L2 can be independently any chemical moiety, including but not limited to, alkanes, alkenes, amines, esters, amides, ethers, carbamates, carbonates, or nothing. N_{BB} is the backbone degree of polymerization. x and y are the number of BR1 and BR2 repeating units in each block, statistical or random sequence.

In one or more examples, either or both SC1 and SC2 comprise polymers with mixed degree of polymerization.

In one or more examples, BR1 and BR2 are norbornene repeating units, SC1 is a poly(dimethylsiloxane), and SC2 is a poly(ethylene oxide) or a poly(ethylene glycol), or a poly(lactide).

In one or more examples, the bottlebrush copolymers each have the general structure of:

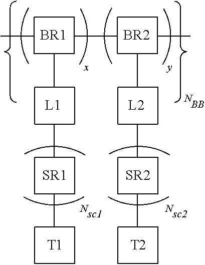

wherein BR1 and BR2 are backbone repeating units each independently selected from, but are not limited to, a monomer of a norbornene, an ester, a lactide, an ether, a siloxane, an acrylate, a methacrylate, an amide, an acrylamide, a urea, a carbonate, an alkane, an ethylene, a propylene, an isobutylene, an alkene, a butadiene, an isoprene, a styrene, or derivatives thereof, or combination thereof. SR1 and SR2 are side chain repeating units covalently bonded to the backbone through a linker L1 or L2. The side chain repeating units SR1 and SR2 can each be independently selected from, but not limited to, a monomer of a norbornene, an ester, a lactide, an ether, a siloxane, an acrylate, a methacrylate, an amide, an acrylamide, a urea, a carbonate, an alkane, an ethylene, a propylene, an isobutylene, an alkene, a butadiene, an isoprene, a styrene, or derivatives thereof, or combination thereof. L1 and L2 are independently spacer or linker units which covalently bond each side chain to the backbone. L1 and L2 can be independently any chemical moiety, including but not limited to, alkanes, alkenes, amines, esters, amides, ethers, carbamates, carbonates, or nothing. T1 and T2 are end groups to either terminate the polymer (side chain) or render additional functionality to the polymer (side chain). T1 and T2 can be independently any monovalent chemical moieties or nothing. N_{BB} is the backbone degree of polymerization. N_{sc1} and N_{sc2} are the side chain degree of polymerization, x and y are the number of BR1 and BR2 repeating units in each block, statistical or random sequence (the sequence can be block, statistical, or random). In one or more examples, the polymer backbone has end groups at either or both of its ends.

In one or more examples, BR1 and BR2 are norbornene repeating units, SR1 is a dimethylsiloxane repeating unit and SR2 is an ethylene oxide or a lactide repeating unit.

In one or more examples, the bottlebrush copolymers each have the structure:

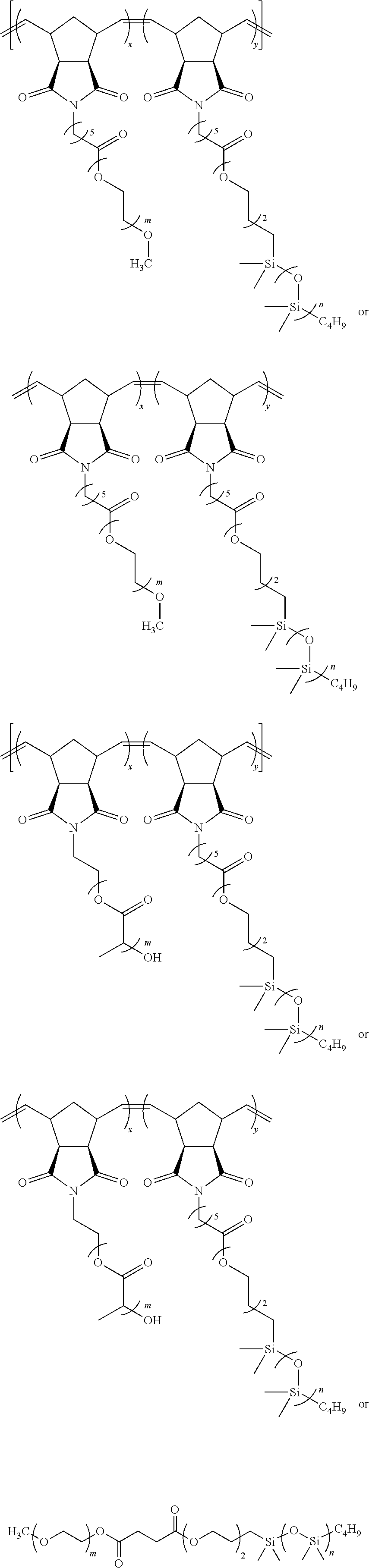

(N_{bb} is omitted in the statistical copolymer structures)

wherein the copolymers have a backbone degree of polymerization (N_{bb}) as short as 5, and as long as any positive integer number. In one or more examples, N_{bb} is in the range of 10-500, or 10 to 200, or 30-200, or 30-100, or 20 to 50. In one or more examples, N_{bb} is in the range of 10-500, preferred in a range of 10 to 200, more preferred in a range of 30-200, more preferred in a range of 20 to 50 or 30-100. m and n (also as N_{sc1}, N_{sc2}, or N_{A}, N_{B}) are the side chain degree of polymerization. m and n can be any positive integer. In one or more examples, m and n are at least 5 (but below a degree of polymerization that causes entanglement of the side chains. For example, the reported entanglement molecular weight for PEO is around 1.6 k g/mol (see ref. ⁵⁴), for PDMS is around 12 k g/mol (see ref. ⁵⁴) and for PLA (see ref. ⁵⁵) is around 10 k g/mol (or in a range of 5.7 k-14.4 k g/mol)). In one or more examples, m is in the range of 5-40 (molecular weight of 200-1600 g/mol) when the side chain is PEO. In one or more examples, m is in the range of 5-200 (molecular weight of 300-14400 g/mol) when the side chain is PLA. In one or more examples, n is in the range of 5-160 (molecular weight of 300-12000 g/mol) when the side chain is PDMS. In one or more examples, m is in the range of 10-20, and n is in the range of 50 to 150. In one or more examples, m is 10 or 17, n is 14, 68 or 136 as listed in table 1 and table 2. The spacer or linker units which covalently bond each side chain to the polymer backbone can be independently any chemical moiety, including but not limited to alkanes, alkenes, amines, esters, amides, ethers, carbamates, carbonates, or nothing. The end groups to either terminate or end-cap the polymer backbones or side chains can be independently any monovalent chemical moieties or nothing.

24. The composition of matter of any of the examples 2-23 wherein the one or more bottlebrush copolymers 512 each comprise a statistical (or random) copolymer, a block sequence of the side-chains, or a statistical sequence of the side-chains. In one or more examples the first block comprises a plurality of the first type of polymers covalently bonded via the backbone to the plurality of the second type of polymers.

25. The composition of matter of any of the examples 1-24, further comprising photocrosslinker molecules 300 or thermal crosslinker molecules. In one or more examples, the weight percentage (wt. %) of the crosslinker compounds in the composition of matter is in a range of 0.005-10 wt. %.

26. The composition of matter of any of the examples 7-25, wherein the self-assembled nanostructures 500 each have a unit cell 526 having a dimension 528 in a range of 1-1000 nm (e.g., in a range of 5-200 nm, or 4-80 nm, or less than 18 nm). In various examples, the dimension is sufficiently large to enable synthesis but not so large that the composition of matter cannot hold its shape or flows too easily.

27. The composition of matter of any of the examples 11-14, wherein the self-assembled nanostructures 500 each have a largest diameter (dimension 528) in a range of 1-1000 nm (e.g., in a range of 5-200 nm, or 4-80 nm or less than 18 nm). In various examples, the dimension is sufficiently large to enable synthesis but not so large that the composition of matter cannot hold its shape or flows too easily.

28. The composition of matter of examples 26 or 27, wherein a spacing 530 between the nanostructures is in a range of 1-1000 nm (e.g., less than 18 nm) and depends most strongly on the length of the first side-chain. In various examples, the dimension is sufficiently large to enable synthesis but not so large that the composition of matter cannot hold its shape or flows too easily.

29. The composition of matter of any of the examples 1-28, wherein the composition of matter is three dimensionally printable at room temperature, the composition of matter transforming from a more solid state into a more fluidic state in response to a pressure applied during three dimensional printing and the composition of matter transforming from the more fluidic state to the more solid state after the pressure is released.

30. The method or composition of matter of any of the examples 1-29, wherein the nanostructures or self-assembled copolymers 500 each have a spherical, spheroidal shape or non-spherical shape, or cylindrical shape or other shape that allows inter nanostructure interactions to obtain a more solid like arrangement. In other words, the nanostructures or self-assembled copolymers may comprise spheres, or cylinders, for example.

31. The composition of matter of any of the examples 1-30, wherein the composition of matter does not include a solvent for the first blocks, the first side-chains, the second blocks, or the second side-chains.

32. An ink or material 1700 (see e.g., FIG. 17) useful for additive manufacturing or 3D printing, or a three dimensionally printed part 1900 (see e.g., FIG. 19) comprising or consisting essentially of the composition of matter of any of the examples 1-31.

33. The composition of matter of wherein the self-assembled copolymers comprise a statistical bottlebrush copolymer 513 wherein the first block comprises a plurality of the first type of polymers 504 covalently bonded via the backbone to the plurality of the second type of polymers 506.

34. The composition of matter of any of the examples 1-33, wherein the composition of matter does not include a solvent for the first type of polymers, the first side-chains, the second type of polymers, or the second side-chains.

35. The composition of matter of any of the examples 1-34 wherein the shear modulus G of the yield stress fluid decreases upon increasing the pressure above the critical stress.

36. The composition of matter of any of the examples 1-35 wherein the shear modulus G of the yield stress fluid decreases by a factor of 1.01 to 10 upon increasing the pressure by a factor of 1.01 to 2 above the critical stress.

37. The composition of matter of any of the examples 1-36 wherein the shear modulus G of the yield stress fluid decreases by a factor of at least 10 upon increasing the pressure by at least a factor of 2 above the critical stress.

38. The composition of matter of any of the examples 34-37, wherein the critical stress is in a range of 10²-10⁵ Pascals. In one or more examples, the critical yield stress is in a range of 50-10⁴ Pascals. In one or more examples, the critical yield stress is in a range of 10³-10⁴ Pascals.

39. The composition of matter of any of the examples 1-38 wherein the copolymer has a backbone having a degree of polymerization in a range of 10-200, or 10-4000, or 20 to 100, or 20 to 50.

40. The composition of matter of any of the examples 1-39, further comprising a minor phase comprising the first type of polymers 504, the second type of polymers 506, the first side chains, or the second side chains; wherein a volume percent content of the minor phase in the composition of matter is in a range of 0.1% to 33%, 0.1%-50%, 2%-33%, 0.1% to 12%, 3%-10%, or in a range sufficiently high to achieve self-assembly of the copolymers but not so high that the copolymers form lamellae. In one or more examples, a volume percent content of the minor phase in the composition of matter is in a range of 0.1%-50%, 0.1% to 33%, 2%-33%, preferred in a range of 0.1% to 12%, more preferred in a range of 3%-10%, In one or more examples, the major phase has a polymer glass transition temperature less than or close to room temperature.

In one or more examples, both the minor phase and the major phase have a polymer glass transition temperature less than or close to room temperature.

In one or more examples, the bottlebrush polymer side chains in the major phase is longer (has a larger degree of polymerization N_{sc}) than the bottlebrush polymer side chains in the minor phase.

41. A composition of matter, comprising:
a yield stress fluid including self-assembled bottlebrush copolymers each including a plurality of first side-chains and a plurality of second side-chains, wherein the first side chains are microphase separated from the second side chains and the yield stress fluid has a yield stress behavior at room temperature or below room temperature without addition of a solvent for the first type of polymer or the second type of polymer.

42. The composition of matter of example 40, comprising any of the examples 6-39.

As used herein, examples of “block copolymer” include a linear block copolymer, a bottlebrush block copolymer, and other types of block copolymers). Examples of “Statistical copolymer” include linear statistical copolymers, bottlebrush statistical copolymers, and other types of statistical copolymers. “Block” and “Statistical” indicate how monomers are added to the polymer chain. “Linear” and “bottlebrush” indicate the polymer shape or how many chains in each polymer.

Method of Additive Manufacturing

FIG. 22 is a flowchart illustrating a method of three dimensionally printing or additive manufacturing.

Block 2200 represents three dimensionally printing a material (e.g., at room temperature or at a temperature T wherein 15° C.≤T≤30° C., or at a temperature below room temperature).

In one or more examples, the material comprises or consists essentially of a bottlebrush polymer. In one or more examples, the material further comprises a crosslinker. In one or more examples, the material doesn't comprise any solvent or additive. In one or more examples, the material is not a polymer blend or composite.

In one or more further examples, the step comprises printing the material comprising or consisting essentially of a self-assembled copolymer or the composition of matter of any of the example 1-41. In one or more examples, the printing is without addition of a solvent for the self-assembled copolymer.

In one or more examples, the printing comprises applying a pressure to the material so that the material becomes a fluid during the printing and solidifies after the printing. In one or more further examples, applying the pressure comprises extruding the material through a nozzle.

In yet further examples, the self-assembled copolymers form a yield stress fluid at or near room temperature (e.g., 15-30° C.) and the pressure is equal to or above a critical yield stress for the yield stress copolymer.

In yet further examples, the self-assembled copolymers form a yield stress fluid below room temperature (e.g., 15 to −50° C.) and the pressure is equal to or above a critical yield stress for the yield stress copolymer.

Block 2202 represents optionally crosslinking the self-assembled copolymers after the printing.

Crosslinking of the self-assembled copolymers is not limited to any specific method. For example, the crosslinking can be chemical crosslinking, physical crosslinking, photo crosslinking, thermal crosslinking, oxidative crosslinking etc.

Crosslinking density has a strong effect on the mechanical and thermal properties of the crosslinked polymers. The cross-linking density is dependent on the mole ratio of the cross-linker to the polymer. In some embodiments, the mole ratio of the cross-linker to the polymer is about 1:1000. In another embodiment, the ratio of the cross-linker to the polymer is about 1:500. In yet another embodiment, the ratio of the cross-linker to the polymer is about 1:100. In an even further embodiment, the ratio of the cross-linker to the polymer is about 1:10. In a still further embodiment, the ratio of the cross-linker to the polymer is about 1:5.

Block 2204 represents the end result, a 3D printed part comprising or consisting essentially of the composition of matter of any of the preceding examples. In one or more examples, the 3D printed part comprises or consists essentially of optionally crosslinked bottlebrush copolymers or block copolymers.

The optionally crosslinked bottlebrush polymers or block copolymers may have a modulus of less than 100 kPa or less than 50 kPa, for certain applications the modulus may be between 1 Pa and 100 kPa, or 100 Pa and 100 kPa. Or more preferably between 1 Pa and 50 kPa or more preferably between 10 Pa and 10 kPa, or more preferably between 100 Pa and 10 kPa for applications where super-soft materials would offer a benefit.

The optionally crosslinked bottlebrush polymers may have an elongation at break of over 50%, or over 100%, or over 200%, or over 500%, or over 1000%.

Advantages and Improvements

We have demonstrated a new class of DIW inks that can print super-soft elastomers at room temperature without solvent as demonstrated using statistical bottlebrush polymers comprising PDMS and short PEO side-chains. The underlying mechanism involves a fast and reversible shear-induced phase transition between BCC spheres of PEO (the minor phase) and disordered micelles. The modulus and yield stress are easy to tune by manipulating the PDMS side-chain length, which controls the characteristic domain spacing independent of PEO volume fraction and backbone degree of polymerization. The addition of telechelic PDMS with benzophenone end-groups enables simple photo-crosslinking after printing to achieve a low network modulus (<100 kPa) without sacrificing a high gel fraction. Cured elastomers display unusual mechanical performance with perfect recoverability well beyond the yield point which is attributed to the same microphase-mediated order-disorder transition that accounts for yielding in uncured samples. This work establishes a novel application of copolymer self-assembly and creates new paradigms related to the properties of materials that can be 3D printed.

### REFERENCES SECTIONS 1-3

The following references are incorporated by reference herein.
1. Verduzco, R., Li, X., Pesek, S. L. & Stein, G. E. Structure, function, self-assembly, and applications of bottlebrush copolymers. Chem. Soc. Rev. 44, 2405-2420 (2015).
2. Rzayev, J. Molecular Bottlebrushes: New Opportunities in Nanomaterials Fabrication. ACS Macro Lett. 1, 1146-1149 (2012).
3. Sheiko, S. S. & Dobrynin, A. V. Architectural Code for Rubber Elasticity: From Supersoft to Superfirm Materials. Macromolecules (2019) doi:10.1021/acs.macromol.9b01127.
4. Daniel, W. F. M. et al. Solvent-free, supersoft and superelastic bottlebrush melts and networks. Nat. Mater. 15, 183-189 (2016).
5. Vatankhah-Varnosfaderani, M. et al. Mimicking biological stress-strain behaviour with synthetic elastomers. Nature 549, 497-501 (2017).
6. Reynolds, V. et al. Super-Soft Solvent-Free Bottlebrush Elastomers for Touch Sensing. Mater. Horiz. (2019) doi:10.1039/C9MH00951E.
7. Chortos, A., Hajiesmaili, E., Morales, J., Clarke, D. R. & Lewis, J. A. 3D Printing of Interdigitated Dielectric Elastomer Actuators. Adv. Funct. Mater. 30, 1907375 (2020).
8. Murphy, S. V. & Atala, A. 3D bioprinting of tissues and organs. Nat. Biotechnol. 32, 773-785 (2014).
9. Prendergast, M. E. & Burdick, J. A. Recent Advances in Enabling Technologies in 3D Printing for Precision Medicine. Adv. Mater. 1902516 (2019) doi:10.1002/adma.201902516.
10. Valentine, A. D. et al. Hybrid 3D Printing of Soft Electronics. Adv. Mater. 29, 1703817 (2017).
11. Muth, J. T. et al. Embedded 3D Printing of Strain Sensors within Highly Stretchable Elastomers. Adv. Mater. 26, 6307-6312 (2014).
12. Walker, D. A., Hedrick, J. L. & Mirkin, C. A. Rapid, large-volume, thermally controlled 3D printing using a mobile liquid interface. Science 366, 360-364 (2019).
13. Kelly, B. E. et al. Volumetric additive manufacturing via tomographic reconstruction. Science 363, 1075-1079 (2019).
14. Poelma, J. & Rolland, J. Rethinking digital manufacturing with polymers. Science 358, 1384-1385 (2017).
15. Ligon, S. C., Liska, R., Stampfl, J., Gurr, M. & Mulhaupt, R. Polymers for 3D Printing and Customized Additive Manufacturing. Chem. Rev. 117, 10212-10290 (2017).
16. Lewis, J. A. Direct Ink Writing of 3D Functional Materials. Adv. Funct. Mater. 16, 2193-2204 (2006).
17. Compton, B. G. & Lewis, J. A. 3D-Printing of Lightweight Cellular Composites. Adv. Mater. 26, 5930-5935 (2014).
18. Fedynyshyn, T. H., Lis, M. T. & Lewis, J. A. Block copolymer ink formulation for 3d printing and method of making a 3d printed radiofrequency (rf) device. 45 (2017).
19. O'Bryan, C. S. et al. Self-assembled micro-organogels for 3D printing silicone structures. Sci. Adv. 3, e1602800 (2017).
20. Olsen, B. D., Kornfield, J. A. & Tirrell, D. A. Yielding Behavior in Injectable Hydrogels from Telechelic Proteins. Macromolecules 43, 9094-9099 (2010).
21. Yang, F., Tadepalli, V. & Wiley, B. J. 3D Printing of a Double Network Hydrogel with a Compression Strength and Elastic Modulus Greater than those of Cartilage. ACS Biomater. Sci. Eng. 3, 863-869 (2017).
22. Zhang, M. et al. Dual-Responsive Hydrogels for Direct-Write 3D Printing. Macromolecules 48, 6482-6488 (2015).
23. Karis, D. G. et al. Cross-linkable multi-stimuli responsive hydrogel inks for direct-write 3D printing. Polym. Chem. 8, 4199-4206 (2017).
24. Leibig, C. & Gilbert, D. Manufacture of three dimensional objects from thermosets. 29 (2019).
25. Bonn, D., Denn, M. M., Berthier, L., Divoux, T. & Manneville, S. Yield stress materials in soft condensed matter. Rev. Mod. Phys. 89, 035005 (2017).
26. Z. Nelson, A. & H. Ewoldt, R. Design of yield-stress fluids: a rheology-to-structure inverse problem. Soft Matter 13, 7578-7594 (2017).
27. Roh, S., Parekh, D. P., Bharti, B., Stoyanov, S. D. & Velev, 0. D. 3D Printing by Multiphase Silicone/Water Capillary Inks. Adv. Mater. 29, 1701554 (2017).
28. Appel, E. A. et al. Self-assembled hydrogels utilizing polymer-nanoparticle interactions, Nat. Commun. 6, 6295 (2015).
29. Lee, S. et al. Metal microparticle—Polymer composites as printable, bio/ecoresorbable conductive inks. Mater. Today 21, 207-215 (2018).
30. Jin, Y., Liu, C., Chai, W., Compaan, A. & Huang, Y. Self-Supporting Nanoclay as Internal Scaffold Material for Direct Printing of Soft Hydrogel Composite Structures in Air. ACS Appl. Mater. Interfaces 9, 17456-17465 (2017).
31. Rubinstein, M. & Colby, R. H. Polymer physics. (Oxford University Press, 2003).
32. Wang, X., Dormidontova, E. E. & Lodge, T. P. The Order-Disorder Transition and the Disordered Micelle Regime for Poly(ethylenepropylene-b-dimethylsiloxane) Spheres. Macromolecules 35, 9687-9697 (2002).
33. Wang, J., Wang, Z.-G. & Yang, Y. Nature of Disordered Micelles in Sphere-Forming Block Copolymer Melts. Macromolecules 38, 1979-1988 (2005).
34. Sebastian, J. M., Lai, C., Graessley, W. W. & Register, R. A. Steady-Shear Rheology of Block Copolymer Melts and Concentrated Solutions: Disordering Stress in Body-Centered-Cubic Systems. Macromolecules 35, 2707-2713 (2002).
35. Sebastian, J. M., Lai, C., Graessley, W. W., Register, R. A. & Marchand, G. R. Steady-Shear Rheology of Block Copolymer Melts: Zero-Shear Viscosity and Shear Disordering in Body-Centered-Cubic Systems. Macromolecules 35, 2700-2706 (2002).
36. Sebastian, J. M., Graessley, W. W. & Register, R. A. Steady-shear rheology of block copolymer melts and concentrated solutions: Defect-mediated flow at low stresses in body-centered-cubic systems. J. Rheol. 46, 863-879 (2002).
37. Fellin, C. R. et al. Tunable temperature- and shear-responsive hydrogels based on poly(alkyl glycidyl ether)s. Polym. Int. 68, 1238-1246 (2019).
38. Luo, Y. et al. Improved self-assembly of poly(dimethylsiloxane-b-ethylene oxide) using a hydrogen-bonding additive. J. Polym. Sci. Part Polym. Chem. 54, 2200-2208 (2016).
39. Fei, H.-F. et al. Ordered Nanoporous Carbons with Broadly Tunable Pore Size Using Bottlebrush Block Copolymer Templates. J Am. Chem. Soc. 141, 17006-17014 (2019).
40. Dalsin, S. J. et al. Bottlebrush Block Polymers: Quantitative Theory and Experiments. ACSNano 9, 12233-12245 (2015).
41. Mukherjee, S. et al. Universal Approach to Photo-Crosslink Bottlebrush Polymers. Macromolecules 53, 1090-1097 (2020).
42. Xia, Y., Olsen, B. D., Kornfield, J. A. & Grubbs, R. H. Efficient Synthesis of Narrowly Dispersed Brush Copolymers and Study of Their Assemblies: The Importance of Side Chain Arrangement. J. Am. Chem. Soc. 131, 18525-18532 (2009).
43. Chandross, M. & Argibay, N. Ultimate Strength of Metals. Phys. Rev. Lett. 124, 125501 (2020).
44. Colby, R. H. Block copolymer dynamics. Curr. Opin. ColloidInterface Sci. 1, 454-465 (1996).
45. Hoffmann, H. & Rauscher, A. Aggregating systems with a yield stress value. Colloid Polym. Sci. 271, 390-395 (1993).
46. Diani, J., Fayolle, B. & Gilormini, P. A review on the Mullins effect. Eur. Polym. J. 45, 601-612 (2009).
47. Nakajima, T. et al. Tough Double-Network Gels and Elastomers from the Nonprestretched First Network. ACS Macro Lett. 8, 1407-1412 (2019).
48. Sun, J.-Y. et al. Highly stretchable and tough hydrogels. Nature 489, 133-136 (2012).
49. U.S. Pat. No. 7,019,082B2, Matyjaszewski et al. Polymers, supersoft elastomers and methods for preparing the same.
50. US Patent Publication No. 20180201785A1. Sheiko et al. Solvent-Free Supersoft and Superelastic Materials,
51. Yang et al. 3D Printing of a Double Network Hydrogel with a Compression Strength and Elastic Modulus Greater than those of Cartilage ACS Biomater. Sci. Eng. 2017, 3, 863-869.
52. Room temperature 3D printing of super-soft and solvent-free elastomers Science Advances 13 Nov. 2020: Vol. 6, no. 46, eabc6900 DOI: 10.1126/sciadv.abc6900.
53. The priority application for this application, U.S. Provisional patent application Ser. No. 63/011,454, filed on Apr. 17, 2017, by Renxuan Xie, Sanjoy Mukherjee, Adam E. Levi, Veronica G. Reynolds, Michael L. Chabinyc, and Christopher M. Bates, entitled “ROOM TEMPERATURE THREE DIMENSIONAL PRINTING OF A SUPER-SOFT AND SOLVENT FREE ELASTOMER”, (30794.764-US-P1).
(54) The entanglement molecular weights for PEO and PDMS from Polymer Chemistry, 2nd Edition by Paul C. Hiemenz and Timothy P. Lodge, ISBN-13: 978-1574447798, ISBN-10: 1574447793.
(55) The entanglement molecular weight for PLA from polymerdatabase.com.

### REFERENCES: SECTIONS 4 AND 7

The following references are incorporated by reference herein.
(1) Sebastian, J. M.; Lai, C.; Graessley, W. W.; Register, R. A. Steady-Shear Rheology of Block Copolymer Melts and Concentrated Solutions: Disordering Stress in Body-Centered-Cubic Systems. Macromolecules 2002, 35 (7), 2707-2713. https://doi.org/10.1021/ma011523+.
(2) Sebastian, J. M.; Lai, C.; Graessley, W. W.; Register, R. A.; Marchand, G. R. Steady-Shear Rheology of Block Copolymer Melts: Zero-Shear Viscosity and Shear Disordering in Body-Centered-Cubic Systems. Macromolecules 2002, 35 (7), 2700-2706, https://doi.org/10.1021/ma011522h.
(3) Sebastian, J. M.; Graessley, W. W.; Register, R. A. Steady-Shear Rheology of Block Copolymer Melts and Concentrated Solutions: Defect-Mediated Flow at Low Stresses in Body-Centered-Cubic Systems. J. Rheol. 2002, 46 (4), 863-879. https://doi.org/10.1122/1.1475979.
(4) Buitenhuis, J.; Forster, S. Block Copolymer Micelles: Viscoelasticity and Interaction Potential of Soft Spheres. J. Chem. Phys. 1997, 107 (1), 262-272. https://doi.org/10.1063/1.474346.
(5) Bonn, D.; Denn, M. M.; Berthier, L.; Divoux, T.; Manneville, S. Yield Stress Materials in Soft Condensed Matter. Rev. Mod. Phys. 2017, 89 (3), 035005. https://doi.org/10.1103/RevModPhys.89.035005.
(6) Fernandes, R. R.; Andrade, D. E. V.; Franco, A. T.; Negrio, C. O. R. The Yielding and the Linear-to-Nonlinear Viscoelastic Transition of an Elastoviscoplastic Material. J. Rheol. 2017, 61(5), 893-903. https://doi.org/10.1122/1.4991803.
(7) Z. Nelson, A.; H. Ewoldt, R. Design of Yield-Stress Fluids: A Rheology-to-Structure Inverse Problem. Soft Matter 2017, 13 (41), 7578-7594. https://doi.org/10.1039/C7SM00758B.
(8) Sun, A.; Gunasekaran, S. Yield Stress in Foods: Measurements and Applications. Int. J. Food Prop. 2009, 12 (1), 70-101. https://doi.org/10.1080/10942910802308502.
(9) Nelson, A. Z.; Bras, R. E.; Liu, J.; Ewoldt, R. H. Extending Yield-Stress Fluid Paradigms. J. Rheol. 2018, 62 (1), 357-369. https://doi.org/10.1122/1.5003841.
(10) Olsen, B. D.; Kornfield, J. A.; Tirrell, D. A. Yielding Behavior in Injectable Hydrogels from Telechelic Proteins. Macromolecules 2010, 43 (21), 9094-9099. https://doi.org/10.1021/ma101434a.
(11) Xie, R.; Mukherjee, S.; Levi, A. E.; Reynolds, V. G.; Wang, H.; Chabinyc,
M. L.; Bates, C. M. Room Temperature 3D Printing of Super-Soft and Solvent-Free Elastomers. Sci. Adv. 2020, 6 (46), eabc6900. https://doi.org/10.1126/sciadv.abc6900.
(12) Miyake, G. M.; Weitekamp, R. A.; Piunova, V. A.; Grubbs, R. H.
Synthesis of Isocyanate-Based Brush Block Copolymers and Their Rapid Self-Assembly to Infrared-Reflecting Photonic Crystals. J. Am. Chem. Soc. 2012, 134 (34), 14249-14254. https://doi.org/10.1021/ja306430 k.
(13) Liberman-Martin, A. L.; Chu, C. K.; Grubbs, R. H. Application of Bottlebrush Block Copolymers as Photonic Crystals. Macromol. Rapid Commun. 2017, 38 (13), 1700058. https://doi.org/10.1002/marc.201700058.
(14) Adibnia, V.; Olszewski, M.; De Crescenzo, G.; Matyjaszewski, K.; Banquy, X. Superlubricity of Zwitterionic Bottlebrush Polymers in the Presence of Multivalent Ions. J. Am. Chem. Soc. 2020. https://doi.org/10.1021/jacs.0c07215.
(15) Miyagi, K.; Mei, H.; Terlier, T.; Stein, G. E.; Verduzco, R. Analysis of Surface Segregation of Bottlebrush Polymer Additives in Thin Film Blends with Attractive Intermolecular Interactions. Macromolecules 2020, 53 (15), 6720-6730. https://doi.org/10.1021/acs.macromol.0c00744.
(16) Patel, B. B.; Walsh, D. J.; Kim, D. H.; Kwok, J.; Lee, B.; Guironnet, D.; Diao, Y. Tunable Structural Color of Bottlebrush Block Copolymers through Direct-Write 3D Printing from Solution. Sci. Adv. 2020, 6 (24), eaaz7202. https://doi.org/10.1126/sciadv.aaz7202.
(17) Rzayev, J. Molecular Bottlebrushes: New Opportunities in Nanomaterials Fabrication. ACS Macro Lett. 2012, 1 (9), 1146-1149. https://doi.org/10.1021/mz300402x.
(18) G. Reynolds, V.; Mukherjee, S.; Xie, R.; E. Levi, A.; Atassi, A.; Uchiyama, T.; Wang, H.; L. Chabinyc, M.; M. Bates, C. Super-Soft Solvent-Free Bottlebrush Elastomers for Touch Sensing. Mater. Horiz. 2020, 7 (1), 181-187. https://doi.org/10.1039/C9MH00951E.
(19) Mukherjee, S.; Xie, R.; Reynolds, V. G.; Uchiyama, T.; Levi, A. E.;
Valois, E.; Wang, H.; Chabinyc, M. L.; Bates, C. M. Universal Approach to Photo-Crosslink Bottlebrush Polymers. Macromolecules 2020, 53 (3), 1090-1097. https://doi.org/10.1021/acs.macromol.9b02210.
(20) Levi, A. E.; Lequieu, J.; Horne, J. D.; Bates, M. W.; Ren, J. M.; Delaney, K. T.; Fredrickson, G. H.; Bates, C. M. Miktoarm Stars via Grafting-Through Copolymerization: Self-Assembly and the Star-to-Bottlebrush Transition. Macromolecules 2019, 52 (4), 1794-1802. https://doi.org/10.1021/acs.macromol.8b02321.
(21) Bates, M. W.; Barbon, S. M.; Levi, A. E.; Lewis, R. M.; Beech, H. K.; Vonk, K. M.; Zhang, C.; Fredrickson, G. H.; Hawker, C. J.; Bates, C. M. Synthesis and Self-Assembly of ABn Miktoarm Star Polymers. ACS Macro Lett. 2020, 9 (3), 396-403. https://doi.org/10.1021/acsmacrolett.0c00061.
(22) Li, Y.; Beck, R.; Huang, T.; Choi, M. C.; Divinagracia, M. Scatterless Hybrid Metal-Single-Crystal Slit for Small-Angle X-Ray Scattering and High-Resolution X-Ray Diffraction. J. Appl. Crystallogr. 2008, 41 (6), 1134-1139. https://doi.org/10.1107/S0021889808031129.
(23) Tassieri, M.; Laurati, M.; Curtis, D. J.; Auhl, D. W.; Coppola, S.; Scalfati, A.; Hawkins, K.; Williams, P. R.; Cooper, J. M. I-Rheo: Measuring the Materials' Linear Viscoelastic Properties “in a Step” ! J. Rheol. 2016, 60 (4), 649-660. https://doi.org/10.1122/1.4953443.
(24) Zhang, C.; Bates, M. W.; Geng, Z.; Levi, A. E.; Vigil, D.; Barbon, S. M.; Loman, T.; Delaney, K. T.; Fredrickson, G. H.; Bates, C. M.; Whittaker, A. K.; Hawker, C. J. Rapid Generation of Block Copolymer Libraries Using Automated Chromatographic Separation. J. Am. Chem. Soc. 2020, 142 (21), 9843-9849. https://doi.org/10.1021/jacs.0c04028.
(25) Love, J. A.; Morgan, J. P.; Trnka, T. M.; Grubbs, R. H. A Practical and Highly Active Ruthenium-Based Catalyst That Effects the Cross Metathesis of Acrylonitrile. Angew. Chem. Int. Ed. 2002, 41 (21), 4035-4037. https://doi.org/10.1002/1521-3773(20021104)41:21<4035::AID-ANIE4035>3.0.CO; 2-I.
(26) Fei, H.-F.; Yavitt, B. M.; Hu, X.; Kopanati, G.; Ribbe, A.; Watkins, J. J. Influence of Molecular Architecture and Chain Flexibility on the Phase Map of Polystyrene-Block-Poly(Dimethylsiloxane) Brush Block Copolymers. Macromolecules 2019, 52 (17), 6449-6457. https://doi.org/10.1021/acs.macromol.9b00843.
(27) Bolton, J.; Bailey, T. S.; Rzayev, J. Large Pore Size Nanoporous Materials from the Self-Assembly of Asymmetric Bottlebrush Block Copolymers. Nano Lett. 2011, 11(3), 998-1001. https://doi.org/10.1021/n1103747m.
(28) Dalsin, S. Bottlebrush Polymers: Synthesis, Rheology, and Self-Assembly, University of Minnesota, 2015.
(29) Ravalli, M. T.; Ryu, C. Y. Viscoelastic Relaxation of Block Copolymers. In Encyclopedia of Polymeric Nanomaterials; Kobayashi, S., Müllen, K., Eds.; Springer: Berlin, Heidelberg, 2021; pp 1-4. https://doi.org/10.1007/978-3-642-36199-9_82-1.
(30) Cloitre, M.; Vlassopoulos, D. Block Copolymers in External Fields: Rheology, Flow-Induced Phenomena, and Applications. In Applied Polymer Rheology; John Wiley & Sons, Ltd, 2011; pp 209-239. https://doi.org/10.1002/9781118140611.ch7.
(31) Gury, L.; Gauthier, M.; Cloitre, M.; Vlassopoulos, D. Colloidal Jamming in Multiarm Star Polymer Melts. Macromolecules 2019, 52 (12), 4617-4623. https://doi.org/10.1021/acs.macromol.9b00674.
(32) Alexandris, S.; Peponaki, K.; Petropoulou, P.; Sakellariou, G.;
Vlassopoulos, D. Linear Viscoelastic Response of Unentangled Polystyrene Bottlebrushes. Macromolecules 2020, 53 (10), 3923-3932. https://doi.org/10.1021/acs.macromol.0c00266.
(33) Chen, Q.; Uneyama, T. Linear Viscoelasticity of Unentangled Corona Blocks and Star Arms. Rheol. Acta 2014, 53 (9), 701-714. https://doi.org/10.1007/s00397-014-0790-2.
(34) Donley, G. J.; Singh, P. K.; Shetty, A.; Rogers, S. A. Elucidating the G″ Overshoot in Soft Materials with a Yield Transition via a Time-Resolved Experimental Strain Decomposition. Proc. Natl. Acad. Sci. 2020. https://doi.org/10.1073/pnas.2003869117.
(35) Caggioni, M.; Trappe, V.; Spicer, P. T. Variations of the Herschel-Bulkley Exponent Reflecting Contributions of the Viscous Continuous Phase to the Shear Rate-Dependent Stress of Soft Glassy Materials. J. Rheol. 2020, 64 (2), 413-422. https://doi.org/10.1122/1.5120633.
(36) Kossuth, M. B.; Morse, D. C.; Bates, F. S. Viscoelastic Behavior of Cubic Phases in Block Copolymer Melts. J. Rheol. 1998, 43 (1), 167-196. https://doi.org/10.1122/1.550981.
(37) Chandross, M.; Argibay, N. Ultimate Strength of Metals. Phys. Rev. Lett. 2020, 124 (12), 125501. https://doi.org/10.1103/PhysRevLett.124.125501.
(38) Torija, M. A.; Choi, S.-H.; Lodge, T. P.; Bates, F. S. Large Amplitude Oscillatory Shear of Block Copolymer Spheres on a Body-Centered Cubic Lattice: Are Micelles Like Metals? J. Phys. Chem. B 2011, 115 (19), 5840-5848. https://doi.org/10.1021/jp202468y.
(39) Witten, T. A.; Pincus, P. A. Colloid Stabilization by Long Grafted Polymers. Macromolecules 1986, 19 (10), 2509-2513. https://doi.org/10.1021/ma00164a009.
(40) Watanabe, H.; Kanaya, T.; Takahashi, Y. Equilibrium Elasticity of Diblock Copolymer Micellar Lattice. Macromolecules 2001, 34 (3), 662-665. https://doi.org/10.1021/ma000897 k.
(41) Qavi, S.; Foudazi, R. Rheological Characteristics of Mesophases of Block Copolymer Solutions. Rheol. Acta 2019, 58 (8), 483-498, https://doi.org/10.1007/s00397-019-01162-y.
(42) Qavi, S.; Firestone, M. A., Foudazi, R. Elasticity and Yielding of Mesophases of Block Copolymers in Water-Oil Mixtures. Soft Matter 2019, 15 (28), 5626-5637. https://doi.org/10.1039/C8SM02336K.
(43) Hashimoto, T.; Shibayama, M.; Kawai, H.; Watanabe, H.; Kotaka, T.
Ordered Structure in Block Polymer Solutions. 2. Its Effect on Rheological Behavior. Macromolecules 1983, 16 (3), 361-371. https://doi.org/10.1021/ma00237a005.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A composition of matter, comprising:
a yield stress fluid including self-assembled copolymers each including at least one first type of polymer covalently bonded to at least one second type of polymer, wherein:
the first type of polymer is microphase separated from the second type of polymer,
at least one of the first type of polymer or the second type of polymer has a glass transition temperature less than or equal to 20° C., and
the yield stress fluid has a yield stress behavior at room temperature or below room temperature without addition of a solvent for the first type of polymer or the second type of polymer.

2. The composition of matter of claim 1, wherein the self-assembled copolymers comprise:
one or more bottlebrush polymers each including a plurality of the first type of polymers covalently bonded via a backbone to the plurality of the second type of polymers, or
two or more linear blocks comprising at least one of the first type of polymers connected to at least one of the second type of polymers.

3. A composition of matter, comprising:
a yield stress fluid including self-assembled bottlebrush copolymers each including a plurality of first side-chains and a plurality of second side-chains, wherein the first side chains are microphase separated from the second side chains and the yield stress fluid has a yield stress behavior at room temperature or below room temperature without addition of a solvent for the first type of polymer or the second type of polymer.

4. A composition of matter, comprising:
one or more statistical bottlebrush copolymers each including a plurality of first side-chains and a plurality of second side-chains, wherein at least one of the first side-chains or the second side-chains has their glass transition temperature less than or equal to 20° C.

5. The composition of matter of claim 4, wherein the bottlebrush copolymers comprise self-assembled copolymers and the first side chains and the second side chains are microphase separated.

6. The composition of matter of any of the claims 1-3 or 5, comprising a plurality of nanostructures each including one or more of the self-assembled copolymers.

7. The composition of matter of any of the claims 1-3 or 5-6, comprising the yield stress fluid having a yield stress behavior wherein the self-assembled copolymers are arranged in a more liquid-like configuration with less order when the yield stress fluid experiences a stress at or above the critical yield stress at room temperature or at a temperature below room temperature, as compared to an arrangement of the self-assembled copolymers below the critical yield stress.

8. The composition of matter of any of the claims 1-3 or 6-7, comprising a yield stress fluid having a yield stress behavior, wherein the nanostructures are arranged on a lattice when the yield stress fluid experiences a stress below the critical yield stress.

9. The composition of matter of claim 7, wherein the nanostructures are arranged on the lattice having a unit cell selected from a body-centered cubic spheres, face-centered cubic spheres, or any unit cell associated with a Frank-Kasper phase.

10. The composition of matter of claim 7, wherein the nanostructures are arranged on the lattice having a unit cell comprising a hexagonal structure or a close packed structure.

11. The composition of matter of any of the claims 6-10, wherein the nanostructures each comprise a core, the core including an aggregation of the second blocks or the second side chains.

12. The composition of matter of any of the claims 1-11, wherein an interface between the first type of polymers and the second type of polymers, or the interface between the first side-chains and the second side-chains, defines a boundary having a convex side and a concave side.

13. The composition of matter of claim 12, wherein the self-assembled copolymers comprise the bottlebrush copolymers each having a backbone and the interface comprises the backbone.

14. The composition of matter of claims 12 or 13, wherein:
the first type of polymers extend outwards from the convex side and the second type of polymers extend inwards from the concave side as to form a cluster, or
the first side-chains extend outwards from the convex side and the second side-chains extend inwards from the concave side.

15. The composition of matter of claim 14, wherein the first type of polymers (or first side-chains) are longer and/or comprise a larger fraction of the self-assembled copolymers as compared to the second type of polymers (or second side-chains).

16. The composition of matter of claims 14 or 15, wherein the first type of polymers (or first side-chains) have a glass transition temperature below 20° C.

17. The composition of matter of any of the claims 1-16, wherein the first type of polymers (or first side-chains) and the second type of polymers (or second side-chains) have different compositions and/or dielectric constants such that the first type of polymers (or first side-chains) and the second type of polymers (or second side-chains) are microphase separated.

18. The composition of matter of claim 17, wherein the different compositions are such that the composition of matter has a Young's modulus in a range of 1-100 kPa.

19. The composition of matter of any of the claims 1-18, wherein the first type of polymers (or first side-chains) each comprise poly(dimethylsiloxane) and the second type of polymers (or second side-chains) each comprise poly(ethylene oxide), also known as poly(ethylene glycol).

20. The composition of matter of any of the claims 1-19, wherein the self-assembled copolymers comprise a backbone having at least one structure selected from: 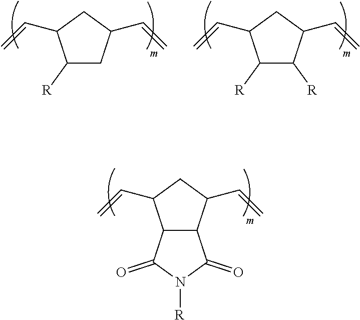
wherein m is an integer and R comprises the first type of polymers (first side-chain) or the second type of polymers (second side-chain).

21. The composition of matter of any of the claims 1-20, wherein the first type of polymers (or first side-chains) and the second type of polymers (or second side-chains) each independently comprise at least one polymer selected from a polyester, poly(ether), a poly(siloxane), a polyacrylate, a polymethacrylate, polyamide, polyacrylamide, polyurea, polycarbonate, polyalkane, polyethylene, polypropylene, polyisobutylene, polyalkene, polybutadiene, polyisoprene, a polystyrene, or derivatives thereof, or wherein the first type of polymers (first side-chains) and the second type of polymers (second side-chains) comprise the same type of polymer but with different functionality.

22. The composition of matter of any of the claims 1-21, wherein each of the first type of polymers (first side-chains) have a degree of polymerization of at least 5 and each of the second type of polymers (second side-chains) have a degree of polymerization of at least 5.

23. The composition of matter of any of the claims 3-20 wherein the bottlebrush copolymers each have the structure: 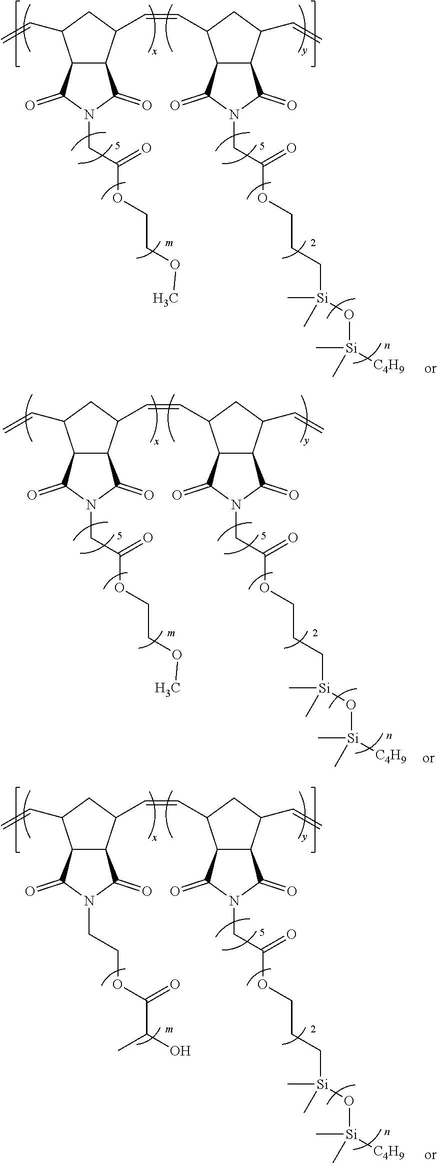 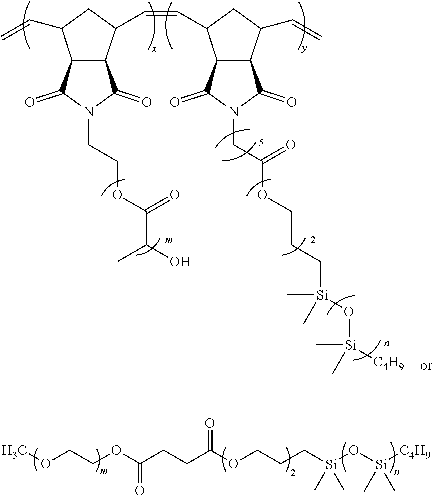
wherein x, y, m and n are in a range of 5-1000.

24. The composition of matter of any of the claims 3-21, wherein the first sidechains have a length shorter than the second sidechains.

25. The composition of matter of any of the claims 1-22, further comprising a minor phase comprising the first type of polymers, the second type of polymers, the first side chains, or the second side chains; wherein a volume percent content of the minor phase in the composition of matter is in a range of 0.1% to 33%.

26. The composition of matter of any of the claims 2-25 wherein the one or more bottlebrush copolymers each comprise a statistical sequence of the side-chains.

27. The composition of matter of any of the claims 1-26, further comprising photocrosslinker molecules.

28. The composition of matter of any of the claims 6-27, wherein the self-assembled nanostructures each have a unit cell having a dimension less than 18 nm.

29. The composition of matter of any of the claims 6-14, wherein the self-assembled nanostructures each have a largest diameter less than 18 nm.

30. The composition of matter of claim 28 or 29, wherein a spacing between the nanostructures is less than 18 nm and depends most strongly on the length of the first side-chain.

31. The composition of matter of any of the claims 1-30, wherein the composition of matter is three dimensionally printable at room temperature, the composition of matter transforming from a more solid state into a more fluidic state in response to a pressure applied during three-dimensional printing and the composition of matter transforming from the more fluidic state to the more solid state after the pressure is released.

32. The composition of matter of any of the claims 2-31, wherein the self-assembled copolymers comprises the structure: 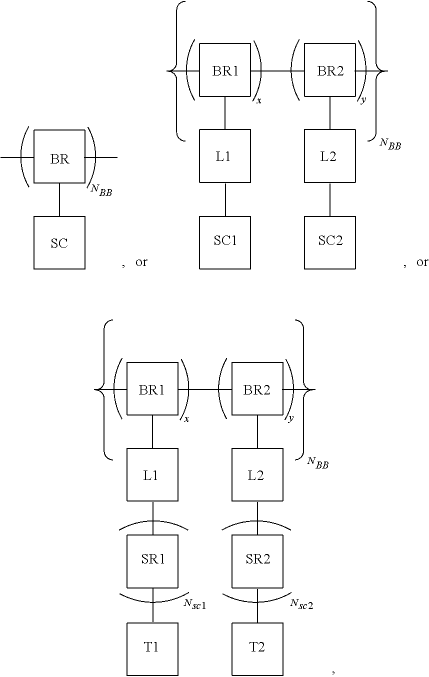
the backbone comprises at least one of BR, BR1, or BR2
the first side-chains, the second side-chains, the first type of polymer, and the second type of polymer each comprise:
SC,
L1 and SC1,
L2 and SC2,
L1 and SR1 and T1, or
L2 and SR2 and T2.

33. A three dimensionally printed part comprising or consisting essentially of the composition of matter of any of the claims 1-32.

34. A three dimensionally printed part comprising or consisting essentially of a bottlebrush copolymer.

35. An ink or material useful for additive manufacturing or 3D printing comprising the composition of matter of any of the claims 1-33.

36. The composition of matter of any of the claims 1-34, wherein the composition of matter does not include a solvent for the first type of polymers, the first side-chains, the second type of polymers, or the second side-chains.

38. A method of three dimensionally printing or additive manufacturing, comprising:
three dimensionally printing a material at room temperature, wherein the material comprises or consists essentially of a self-assembled copolymer or the composition of matter of any of the claims 1-36 and the printing is without addition of a solvent for the self-assembled copolymer.

39. The method of claim 36, further comprising crosslinking the self-assembled copolymers after the printing.

40. The method of any of the claims 38-39, wherein the printing comprises applying a pressure to the material so that the material becomes a fluid during the printing and solidifies after the printing and after removal of the pressure.

41. The method of claim 40, wherein applying the pressure comprises extruding the material through a nozzle.

42. The method of any of the claims 38-41, wherein the self-assembled copolymers form a yield stress fluid at or near room temperature and the pressure is equal to or above a yield stress for the yield stress copolymer.

43. A method of three dimensionally printing or additive manufacturing, comprising:
three dimensionally printing a material comprising or consisting essentially of a bottlebrush polymer.

44. The method or composition of matter of any of the claims 43-44, wherein the nanostructures or self-assembled copolymers each have a spherical or spheroidal shape.
